(19) United States
(12) Patent Application Publication
(10) Pub. No.: US 2015/0339627 A1
(43) Pub. Date: Nov. 26, 2015

(54) SYSTEM FOR STRUCTURED COMMUNICATION BETWEEN PARTIES

(71) Applicant: MODULEQ, INC., San Francisco, CA (US)

(72) Inventor: David James Brunner, Los Altos Hills, CA (US)

(73) Assignee: MODULEQ, INC., San Francisco, CA (US)

(21) Appl. No.: 14/563,704

(22) Filed: Dec. 8, 2014

Related U.S. Application Data
(63) Continuation of application No. 14/255,351, filed on Apr. 17, 2014, now abandoned.
Application No. 14/255,351 is a continuation-in-part of application No. 13/491,320, filed on Jun. 7, 2012, now abandoned.
(60) Provisional application No. 61/495,821, filed on Jun. 10, 2011.

(51) Int. Cl. G06Q 10/10

(52) U.S. Cl. CPC G06Q 10/10

(57) ABSTRACT

A system may comprise a remotely-accessible controller configured to present a user interface to one or more of the parties; and a state information repository to be updated throughout a transaction, wherein changes in the state information are constrained at least in part based upon a transaction type determined from a predetermined set of transaction types; wherein the controller is configured to initiate an electronically mediated interaction pertinent to a communication transaction between the parties, attempt to establish an initial context for the transaction based upon previous electronically-mediated interactions that include the initiating party, establish a defined role for each of the parties, each role defining bounds upon the activity of each party within the transaction, and, upon advancement of the state information from a first state to a second state, engage associated parties through the user interface.

### RELATED APPLICATION DATA

This is a continuation patent application of U.S. continuation-in-part patent application Ser. No. 14/255,351, filed on Apr. 17, 2014, which claims priority to U.S. patent application Ser. No. 13/491,230, filed on Jun. 7, 2012, which claims the benefit under 35 U.S.C. §119 to U.S. provisional patent application No. 61/495,821, filed Jun. 10, 2011. The foregoing applications are hereby incorporated by reference into the present application in their entirety.

### FIELD OF THE INVENTION

The present innovation relates generally to computer software and computer network applications. More specifically, it relates to configurations for generating and managing electronic records that facilitate transactional interactions between two or more parties.

### BACKGROUND

A “transaction” may be defined as a communication pattern occurring in the conduct of business and personal affairs between parties. A beginning of a transaction may be defined as the point when an initiating party makes a request to one or more specifically identified counterparties. One or more of these counterparties may respond to the request, and the requesting party may evaluate the response and decide whether to accept or reject the response outright, or to issue a counter-response that suggests modifications to the response. A transaction may incorporate an unlimited number of modified responses and counter-responses. The transaction may terminate when the initiating party accepts or rejects the response, when the initiating party cancels the transaction, or when one or both parties withdraw from or abandon the transaction. Although some transactions, notably transactions in highly regulated financial markets, are standardized as to their structure and content, many transactions require that the parties adjust flexibly to the specific circumstances of the transacting parties and the particular transaction.

Present software-based systems for handling transactions can be classified in three broad categories: workflow or business process management systems, task management systems, and general-purpose communication tools. Systems in all three categories exhibit significant shortcomings with respect to transaction management because they are not designed to handle transactions with the structure described above.

Systems with workflow or business process management capabilities such as those available under the tradenames Documentum®, Microsoft SharePoint®, and Lotus Notes® are designed to perform a sequence of partially automated transactions using predefined templates. When a given workflow has been triggered, such a system initiates a sequence of predefined transactions with a set of pre-assigned counterparties. The system acts as the initiating party, issuing requests and processing responses. The structure, content and sequencing of the transactions is determined by a set of predefined rules. Although this approach may work well for handling certain high-frequency, low-variability transactions, it is poorly suited to relatively less frequent, higher-variability transactions for two reasons.

First, creating a workflow pattern for the software to follow requires a significant investment of time, effort, and technical expertise, because the associated transactions must be classified, standardized, captured in a set of templates, and rules must be developed to determine how the transactions are carried out under any particular circumstances. For many transactions that occur in the course of business and personal affairs, these investments are not cost-effective, generally ruling out the use of workflow or business process management tools.

Second, as stated above, many transactions that occur in the course of business and personal affairs cannot be fully standardized, because they involve adjustment by the parties to particular circumstances at hand. These adjustments are often handled through counter-responses and modified requests that follow the initial request-response interaction. Since workflow and business process management tools automate the initiation and handling of transactions using predefined templates and rules, they are not well-suited to adjust flexibly to particular circumstances. Transactions that do not fit the templates and rules in the system must be handled outside the system, or the system must be modified.

As a result of these limitations, use of workflow or business process management systems is generally limited to transactions that are relatively frequent and that exhibit relatively low variability. Also, these systems are often used in conjunction with more flexible communication tools that can be used to handle transactions that cannot be easily standardized. For example, a workflow system may be used to collect formal approvals in a business environment after a decision has been made, but transactions associated with the actual decision-making process may be handled outside the system.

Task management systems allow users to create tasks and assign them to other people. In some cases, such a system may notify the task creator when the assignee has completed the task. Characterized in transactional terms, these systems allow a request to be issued in the form of a task, and for a response to be provided in the form of a notification that the task has been completed. However, as described above, issuing a request and receiving a response does not necessarily complete a transaction. Much of the difficulty in managing transactions is associated with the need to handle a series of counter-responses and modified requests.

Since task management systems are not designed to handle the entire sequence of transactional interactions, they generally are suitable for only very simple transactions, or for initiating and tracking the completion of transactions that are conducted using other communication tools. For example, when an assignee receives a task, the assignee might use a series of emails or telephone calls with the task creator to perform the transaction, and then mark the task complete in the task management system.

The clearest evidence of the limitations of existing workflow/business process management and task management systems is the very large volume of transactions that are conducted using the third category of transaction-handling system: email, telephone, and other general-purpose communication tools. These tools permit the transmission of messages among the parties to a transaction, but they generally do not have any transaction management functionality. Specifically, these systems typically do not track when a transaction has been initiated, whether a response has been received from the counterparty, how the content of the response maps to the structure of the request, what counter-responses or modified responses have been issued, or whether the transaction has completed and, if so, with what outcome.

As a result, general-purpose communication tools are an inferior technology for handling transactions. It generally is not possible to track or monitor ongoing transactions or analyze completed transactions, and managers in an organization generally cannot identify problematic transactions or evaluate transaction-processing performance by individuals or groups. Further, it generally is not possible to aggregate similar transactions for monitoring or analytical purposes, or to store the structure of completed transactions for reuse in the future, so transactions are recreated from scratch every time, requiring extra effort.

These limitations have significant practical implications, especially for organizations such as businesses. When general-purpose communication tools are used to handle transactions, it is difficult or impossible for managers to obtain, at a reasonable cost and in a timely fashion, information about much of the transactional activity that is occurring or has occurred within the organization. This impedes the detection of problems, hinders the objective and accurate evaluation of staff performance, and reduces the ability of managers to make timely and well-informed business decisions.

None of these existing systems can be easily modified to effectively overcome their limitations with respect to transaction handling. Workflow and business process management tools are designed to automate business processes by automatically initiating sequences of transactions and processing responses, so they are not structured to facilitate ad hoc transactions between human actors. General purpose communication tools do not have the necessary structure to enable transaction management functionality; Google's Gmail® and other email clients can group related messages by subject which may help somewhat, but there is no way to determine the status of a transaction reliably from the information in an email message. Finally, task management systems are designed to enable assigning tasks and tracking whether tasks have been completed, so they cannot accommodate a sequence of interlocking, structured interactions that may be of arbitrary length and complexity.

What is presented in one embodiment is a worldwide web based, or cloud-based, solution for modeling electronic communication transactions, or communication “handshakes”, comprising a web service, client applications, and additional interface components integrated with other end user applications such as email, calendar, contact manager, social media, or other enterprise IT. The solution may also be deployed using private cloud and on-premises configurations.

The client applications may be configured to enable users to access the web service and perform the various activities. Clients may comprise HTML websites, javascript applications running in a web browser, applications for personal computers running operating systems such as Microsoft Windows® or Mac OS®, or apps for mobile devices running operating systems such as Apple iOS® or Google Android®.

Other embodiments are directed toward systems and methods for associating action items with content in message threads. In the conduct of complex business transactions (e.g., corporate mergers, lawsuits, securities issues, etc.), parties to the transaction exchange large numbers of electronic messages. Many of these messages contain content requiring action by one or more people. The actions required in response to a given message are referred to below as the Action Items associated with the message. In existing technologies, Action Items may be implicit or explicit in the human-readable content of them message; however, existing messaging technologies do not provide any way to explicitly indicate Action Items in a computer-readable manner. The absence of such a capability limits the ability of computer software to assist in the tracking, prioritization, visualization, and analysis of the work associated with the transaction.

Action Items may be explicitly described in the text of a message (e.g., “Mary, please process the attached form”), or they may be communicated in one or more subsequent replies to the message by the author or another person who reads the message (e.g., “John, could you please update the draft per Phil's feedback below?).

Action Items may pertain to one or more particular parts of a message (words, phrases, paragraphs, or sections). For example, a message to a lawyer from a client may contain three distinct requests, stated in three paragraphs. In this case, there may be three Action Items, one corresponding to each paragraph.

At present, the dominant technology used for transmitting and storing electronic messages is email, although sometimes instant message technologies or enterprise social media may be used as well. Neither email nor other messaging technologies provide a way to explicitly indicate the content in messages that require action in a computer-readable manner. Hence, it generally is not possible for a conventional software system to communicate the Action Item(s) to the person or people who need to complete the action. Nor can the status of the Action Item(s) be displayed for people viewing the message.

As a result of the deficiencies of existing technologies, workers performing complex business transactions resort to inefficient and error-prone methods for identifying and tracking Action Items. For example, workers mark messages for follow-up using flagging or tagging functionality provided by email clients. This approach does not indicate who needs to complete the action, it does not indicate the specific part of the message requiring action, and it does not make the status of the action apparent to others viewing the message. The lack of clarity regarding the content of the Action Item, the person accountable for the Action Item, and the completion status of the Action Item results in costly errors. For example, in an asset management firm, a financial advisor may use email to coordinate the activities required to open a new client account. If a particular Action Item, such as obtaining an image of the client's identifying documents, is overlooked due to a failure to track the associated Action Item through completion, the opening of the client account may be delayed for several weeks, costing the firm thousands of dollars in lost interest or fees.

Some email client plugins such as Taskforce can be used to mark messages as requiring action in a manner that communicates the required action to the person who needs to complete the action, but the system neither indicates the specific part of the message requiring action, nor makes the Action Item and its status apparent to other people who view the message.

Some workers use task-tracking software such as Asana, Basecamp, the to-do list functionality embedded in Microsoft Outlook, and task tracking apps on iOS, Android or Blackberry devices to track action items. However, in fast-based business transactions, messages often describe changes in the state of Action Items. For example, a message may indicate that an Action Item has been completed, modified, handed off, or withdrawn. Reflecting these changes in the task-tracking software is a manual process that is both time-consuming and error prone.

Embodiments of the invention described below enable a person viewing a message to indicate that action is required with regard to a particular part of the message content. The invention enables all parties who view the message to see the associated Action Items, the parts of the message to which they pertain, and their statuses. This makes possible more efficient and reliable coordination, since less time and effort is required to identify and track the actions that must be completed. Further, configurations are described for allowing users to incorporate changes in the state of one or more Action Items into reply messages, and for automatically updating a task list to reflect these changes.

### SUMMARY

One embodiment is directed to a system for structured communication between specified parties, comprising a remotely-accessible controller configured to present a communication user interface to one or more of the parties; and a state information repository comprising state information to be updated throughout a transaction, wherein changes in the state information are constrained at least in part based upon a transaction type determined from a predetermined set of transaction types; wherein the controller is configured to initiate an electronically mediated interaction pertinent to a communication transaction between the parties, attempt to establish an initial context for the transaction based upon previous electronically-mediated interactions that include the initiating party, establish a defined role for each of the parties, each role defining bounds upon the activity of each party within the transaction, and, upon advancement of the state information from a first state to a second state, engage associated parties through the user interface. The system further may comprise one or more computing platforms through which the communication interface is presented to the one or more parties. The one or more computing platforms may be configured to operate a web browser to operate the communication interface. At least one of the one or more computing platforms may be selected from the group consisting of: a mobile phone, a PDA, tablet computer, a laptop computer, and a desktop computer. The controller may be configured to initiate an electronically mediated interaction pertinent to a communication transaction between the parties by sending an email. The controller may be configured to initiate an electronically mediated interaction pertinent to a communication transaction between the parties by operating an application configured to function as a plug-in to an email client. The email client may be based upon an application platform selected from the group consisting of: local computer application, online application, and a mobile application. The controller may be configured to initiate an electronically mediated interaction pertinent to a communication transaction between the parties by connecting directly with an email server. The controller may be configured to initiate an electronically mediated interaction by detecting events from an electronic calendaring system. The controller may be configured to initiate an electronically mediated interaction pertinent to a communication transaction between the parties by selecting a previously-existing transaction. The predetermined transaction types may include one or more transaction types that are based at least in part upon previously initiated transactions. The controller may be configured to initiate an electronically mediated interaction pertinent to a communication transaction between the parties by establishing dates that trigger actions by the controller. The controller may be configured to attempt to establish an initial context for the transaction by detecting transactions currently selected by the initiating party/originator in the user interface. The controller may be configured to attempt to establish an initial context for the transaction by detecting transactions currently visible to the initiating party through the user interface. The controller may be configured to attempt to establish an initial context for the transaction by detecting transaction elements currently selected by the initiating party in the user interface. The predetermined set of transaction types may be selected based at least in part upon the initial context. The transaction type may be determined at least in part based upon the initial context. The predetermined transaction types may comprise a transaction type that may be acknowledged but does not require acknowledgement. The predetermined transaction types may comprise a transaction type that requires an acknowledgement. The predetermined transaction types may comprise a transaction type that requests a response. The predetermined transaction types may comprise a transaction type that requests approval of specified items. The predetermined transaction types may comprise a transaction type that modifies the set of parties to the transaction. The predetermined transaction types may comprise a transaction type that modifies the roles of parties to the transaction. The predetermined transaction types may comprise a transaction type that requests parties to the transaction to propose meeting times. The predetermined transaction types may comprise a transaction type that requests parties to the transaction to approve proposed meeting times. The controller may be configured to initiate an electronically mediated interaction pertinent to a communication transaction between the parties by receiving triggering information from a calendar system. The predetermined transaction types may comprise a transaction type configured such that a first party introduces a second party and a third party to each other. The controller may be configured to establish a defined role by presenting information to the party in a manner contingent upon the defined role. The controller may be configured to establish a defined role by receiving information from the party in a manner contingent upon the defined role. The controller may be configured to establish a defined role by limiting the actions available to each party through the user interface. The state information may comprise a state selected from the group consisting of: a sent state, a viewed state, a waiting-for-response state, a waiting-for-acknowledgement state, a cancelled state, and an abandoned state. The controller may be configured to monitor a time elapsed after a response was requested, and to issue a reminder to one or more parties to the transaction. The controller may be configured to allow parties to the transaction to associate information with the transaction. The controller may be configured to track time associated with changes to the transaction state. The controller may be configured to establish relationships between two or more parties. The controller may be configured to characterize membership of a particular party in one or more groups. The controller may be further configured to establish a set of tags. The controller may be further configured to specify a delegate for one or more of the parties. The controller may be further configured to modify the parties to a transaction under a specified circumstance. The controller may be further configured to request information from a party to a transaction after the transaction reaches a terminal state. The controller may be further configured to specify at least one of the one or more parties from a group of predetermined candidates. The controller may be configured to display summary information regarding the communication transaction through a graphical user interface. The controller may be further configured to display information to a user generated at least in part upon one or more transactions to which the user was not a party. The controller may be further configured to automatically suggest values for one or more input fields in a current transaction.

Other embodiments are directed to systems and/or methods wherein: specific parts of a message may be indicated as requiring action in a computer-readable manner; wherein the computer-readable indication comprises at least one identifier indicating a person whose action is required; wherein the computer-readable indications are displayed or otherwise presented (e.g., by text to speech) to people who view the message; wherein the computer-readable indication further comprises information about the action required such as the type of action, the degree of completion of the action, the deadline for completion of the action, possible or actual states of the action, possible or actual state transitions of the action; wherein the user who views a message may create one or more Action Items, each of which comprises (i) a reference to a part of the message requiring action, (ii) one or more people whose action is required, and/or (iii) state information comprising whether the required action has been completed; wherein when a user views a message referenced by one or more Action Items, the user can view information about the Action Items comprising, for each Action Item, the part of the message referenced by the Action Item, the person or people whose action is required (referred to below as recipients), and the state of the action item, including whether the action has been completed; wherein state information comprises: a date by which the action should be completed, the person who created the item, flags indicating high or low priority, a flag indicating whether the creator of the Action Item will be prompted to confirm completion of the Action Item when it is marked done by the recipient, references to other messages, references to documents, tags, comment(s) providing additional detail about the action, flags indicating whether parameters of the Action Item can be modified; wherein creation of an Action Item generates a message notifying the Action Item recipient(s); wherein creating an Action Item that references part of a first message thread comprises creating a second message thread that references the first message thread (i.e., the notion of “nested threads”); wherein the message notifying the Action Item recipient(s) can be customized by the creator of the Action Item; wherein the modification of an Action Item generates a notification to the people with access to the message; wherein the user is offered one or more possible notification messages customized based on the characteristics of the Action Item; wherein each Action Item is associated with a group of related messages containing the referenced message; wherein the groups of related messages automatically include all notifications associated with the creation or modification of Action Items; wherein creating an Action Item for a person who does not have access to the message automatically grants that person access to the message; wherein creating an Action Item for a person who does not have access to the group of messages automatically grants that person access to the group of messages; wherein the user is presented with a list of people who can be specified as recipients, wherein the list may include: people who currently have access to the message, people whom the user often specifies as recipients of action items, people who have specified relationships with the user (e.g., assistant, supervisor, direct report, etc.), people selected based on text entered by the user, people selected based on information in the specified part of the message (e.g., if the message part contains the name of a person, that person might be included in the list); wherein the state of Action Items associated with a message is used to determine how a particular message is presented to a user (for example, the message might be displayed in an Action Required area if it has an incomplete Action Item for which the user is a recipient, in a Waiting For area if it has an incomplete Action Item created by the user, and in a FYI area if it has no such Action Items); wherein the state of Action Items associated with a message group is used to determine how a particular message group is presented to a user (for example, the message group might be displayed in an Action Required area if it has an incomplete Action Item for which the user is a recipient, in a Waiting For area if it has an incomplete Action Item created by the user, and in a FYI area if it has no such Action Items); wherein the recipient of an Action Item may be able to defer the Action Item for a specified period of time, during which the associated message is presented differently; wherein the recipient of an Action Item may be able to defer the Action Item for a specified period of time, during which the associated message group is presented differently; wherein the creation of an Action Item automatically creates a corresponding task or to-do item in the responder's task list or to-do list in another application such as Gmail®, Asana®, Basecamp®, Microsoft Project® or Microsoft Outlook®, or an app on an iOS®, Android®, Microsoft Windows®, or BlackBerry® device; wherein the task automatically created in response to the creation of a given Action Item includes contextual information such as the subject of the message or message group associated with Action Item, an excerpt of the message text referenced by the Action Item, or tags (keywords or phrases) associated with the message or message group associated with the Action Item; wherein the modification of an Action Item automatically updates the corresponding task in the responder's task list or to-do list in another application such as Gmail®, Asana®, Basecamp®, Microsoft Project® or Microsoft Outlook® or an app on an iOS®, Android®, Microsoft Windows®, or BlackBerry® device; wherein modifying a task associated with an Action Item in a task list or to-do list in another application such as Gmail®, Asana®, Basecamp®, Microsoft Project® or Microsoft Outlook® or an app on an iOS®, Android®, Microsoft Windows®, or BlackBerry® device automatically updates the Action Item; wherein the Action Item can be associated with one or more files attached to the message; wherein the Action Item is associated with signing one or more files attached to the message using an electronic signature technology such as Docusign®; wherein the Action Item is associated with approving one or more files attached to the message; wherein the Action Item is associated with completing a form comprising one or more input fields; wherein the Action Items are created in a messaging application such as Microsoft Outlook®, Apple Mail®, or Microsoft Lync®; and/or wherein the Action Items are created based on content received in a messaging application such as Microsoft Outlook®, Apple Mail®, or Microsoft Lync®.

### BRIEF DESCRIPTION OF THE DRAWINGS

FIG. 1 illustrates a conventional communication configuration utilizing an online bulletin board or “wiki” web service.

FIG. 2 illustrates a conventional communication configuration utilizing an online email service that features a threading organization of related emails.

FIGS. 3A-3C illustrate embodiments of the present invention wherein a controller is utilized in the context of a web service to manage various aspects of one or more communication transactions between parties.

FIGS. 4A to 4Z-13 illustrate various aspects of an exemplary paradigm wherein several members of a law firm are working together to address tasks and communication transactions using various aspects of the inventive systems and methods.

FIG. 5 illustrates aspects of a computing infrastructure suitable for engaging in communication transactions in accordance with the present invention.

FIGS. 6-25 illustrate various aspects of exemplary user interface views pertinent to systems and methods for associating action items with content in message threads.

### DETAILED DESCRIPTION

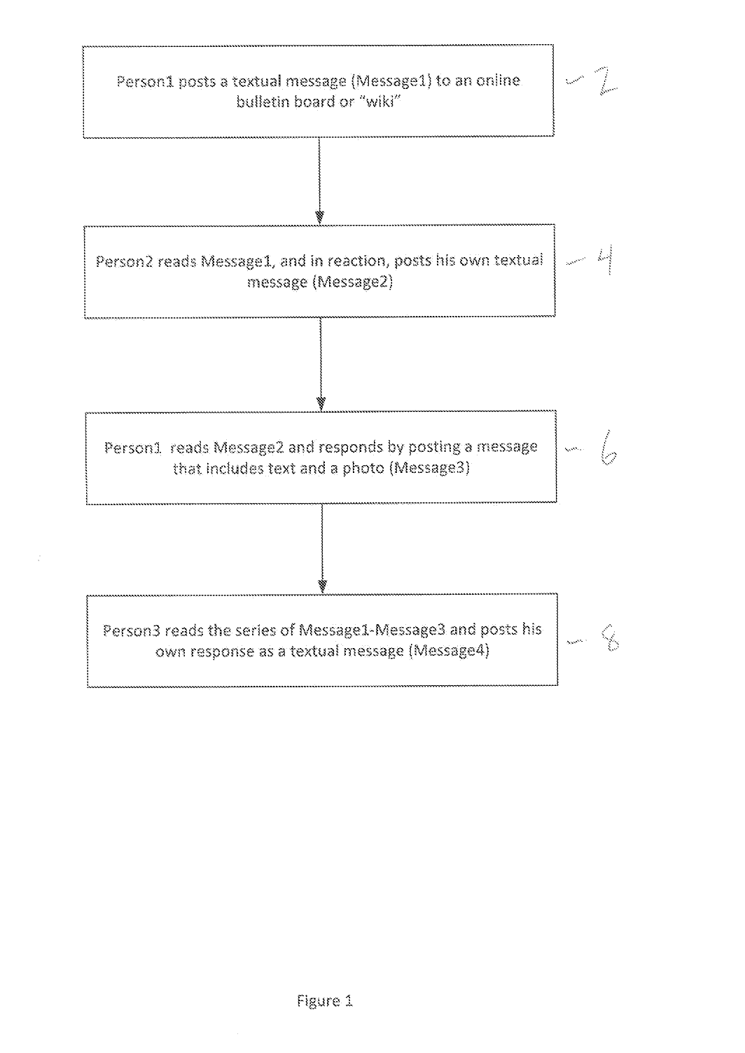

Referring to FIG. 1, a conventional online bulletin board or “wiki” configuration is illustrated wherein a first person posts a first message to an online posting site (2). In response to this first posting, another person may post his own textual message (4). Subsequently, the first person may read the response and post an additional response, that may, for example, contain a photo, audio clip, video clip, and/or textual message (6). Finally, subsequent to the third message (Message3), a third person may post a fourth message (8). While such a configuration may be utilized to facilitate communications between two or more parties, there is very little order or efficiency in the communication pathway, and such shortcomings are often observed in blog or comment postings all over the internet. For example, in response to a typical New York Times article, one or more parties may attempt to have a conversation regarding a particular aspect of the associated article, while others often intervene with positions or arguments that are tangential to the original conversation, a distraction, or worse, and eventually the blog posting site may degenerate into a completely unorganized mosaic of generally unrelated messages.

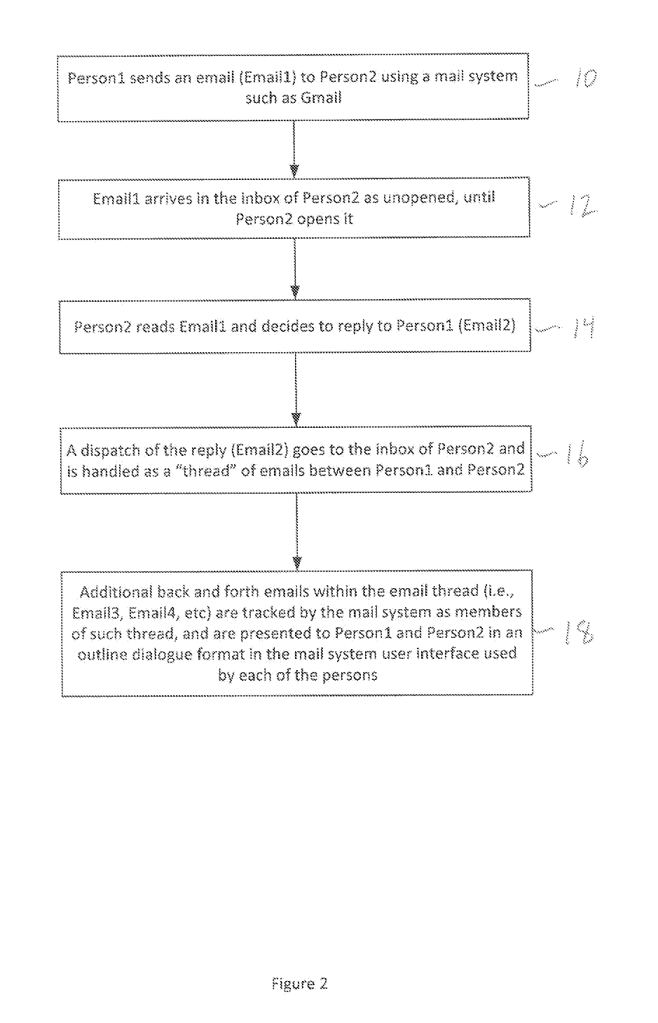

Referring to FIG. 2, a typical mail service does provide some additional order and efficiency. For example, a first person may send an email to a second person using a mail service such as Gmail®(10), after which the mail message is dispatched and arrives in the inbox of the targeted person, remaining there unopened until the targeted person opens it (12). The targeted second person may open the email message and decide to dispatch a reply (14), after which the reply is sent to the first person and may be organized in relation to the original message in as a message “thread”, or grouping of emails between the same two parties (16). An online dialogue may be accomplished between the parties using the thread organization (18). While this type of online dialogue, familiar to many, provides a means of communicating, there is little order or efficiency due to the fact that the only significant organizational features of the interaction are that the communicating parties remain consistent and the group of communications may be treated as a thread. The transactions are not bounded and stateful, there are no defined roles, defined transaction types, or defined state paths (other than the tracking by the mail server that a particular message has been read or not, and this may be controlled by the operator's use of functions such as “mark as read”, which may confuse the actual state of the communication transaction). The thread, or the associated controller, does not know, for example, when the messaging interaction is “done”, which party must respond next in order to advance the state of the interaction, who the initiator of a task is, whether a sub-thread has developed about a related but distinct task or topic, or whether a task has been handed off to someone else. As a result, the email inboxes of many knowledge workers trying to complete tasks through collaborative communication become cluttered and inefficient, notwithstanding the threading features available with services such as Gmail®.

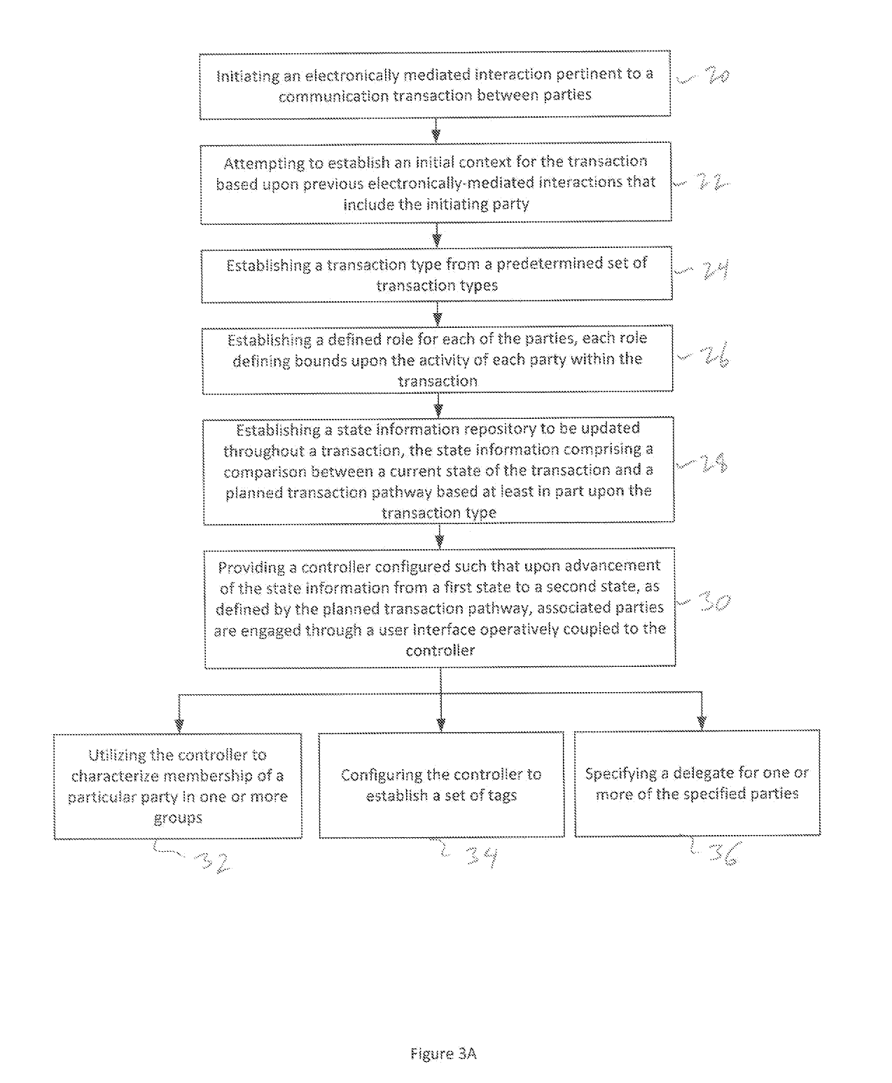

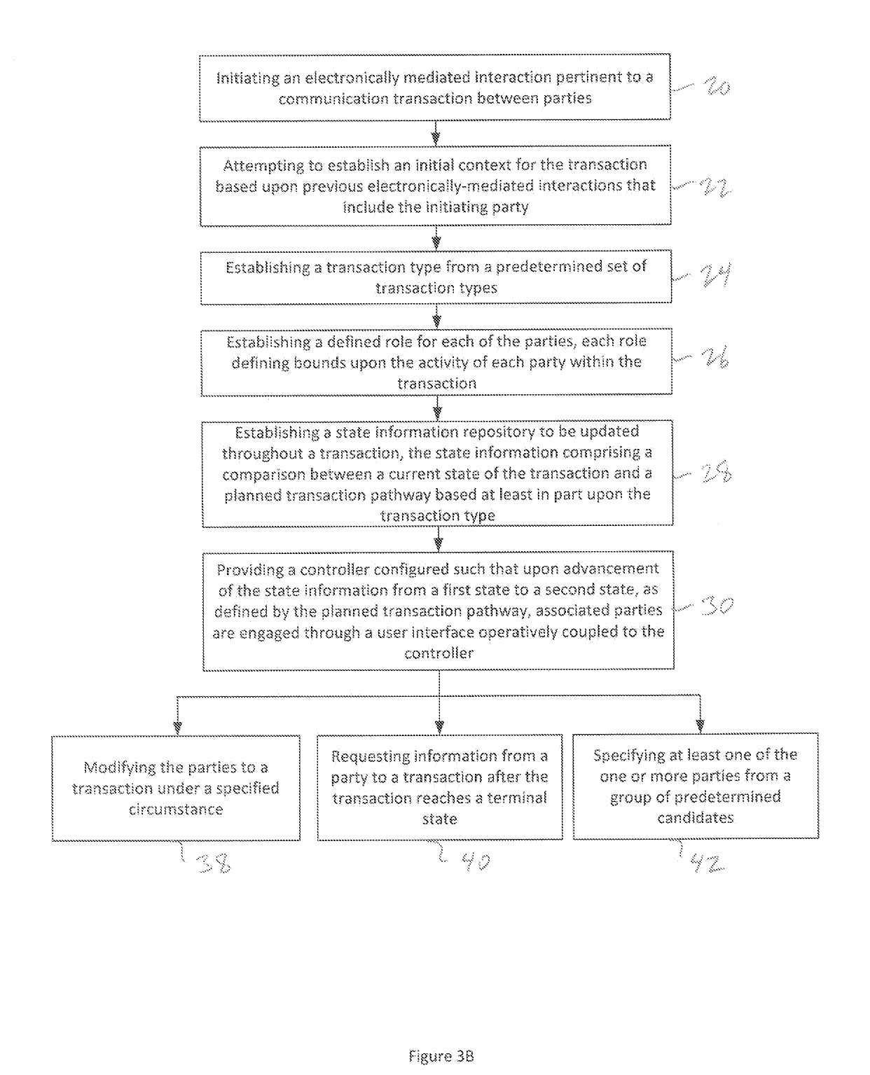

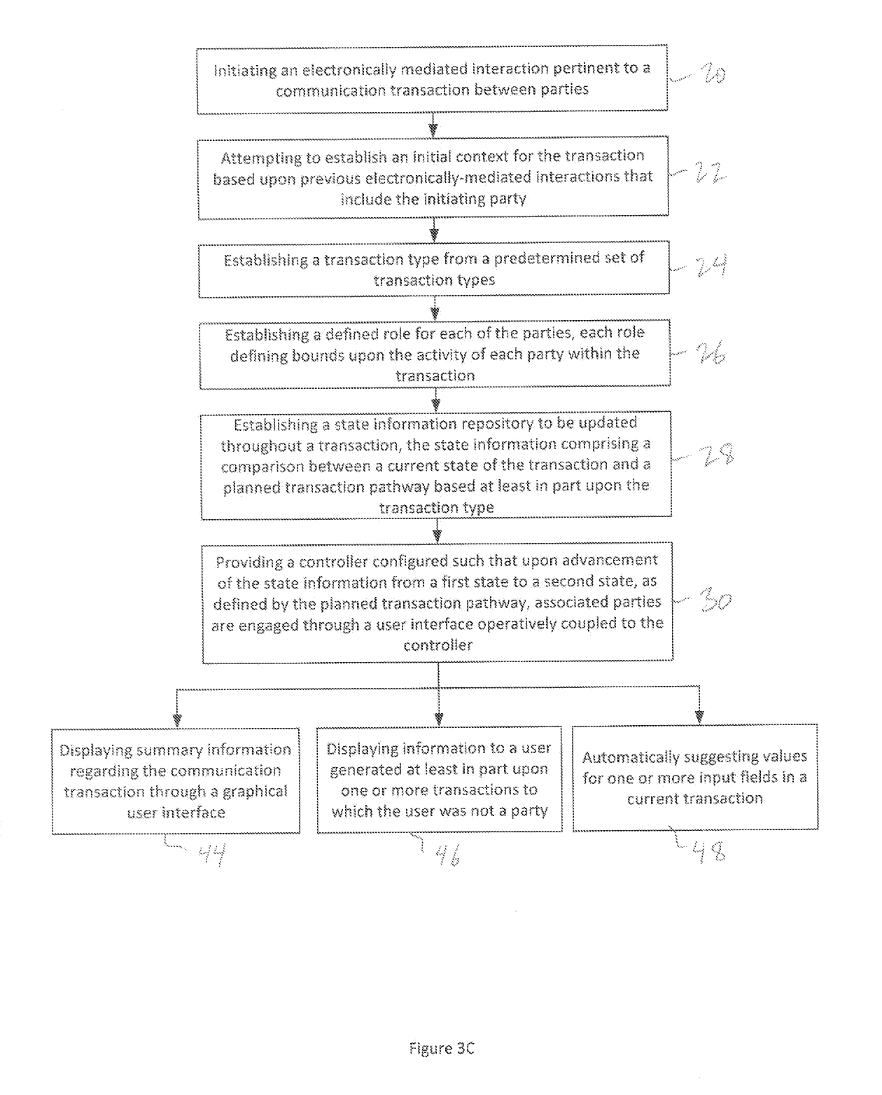

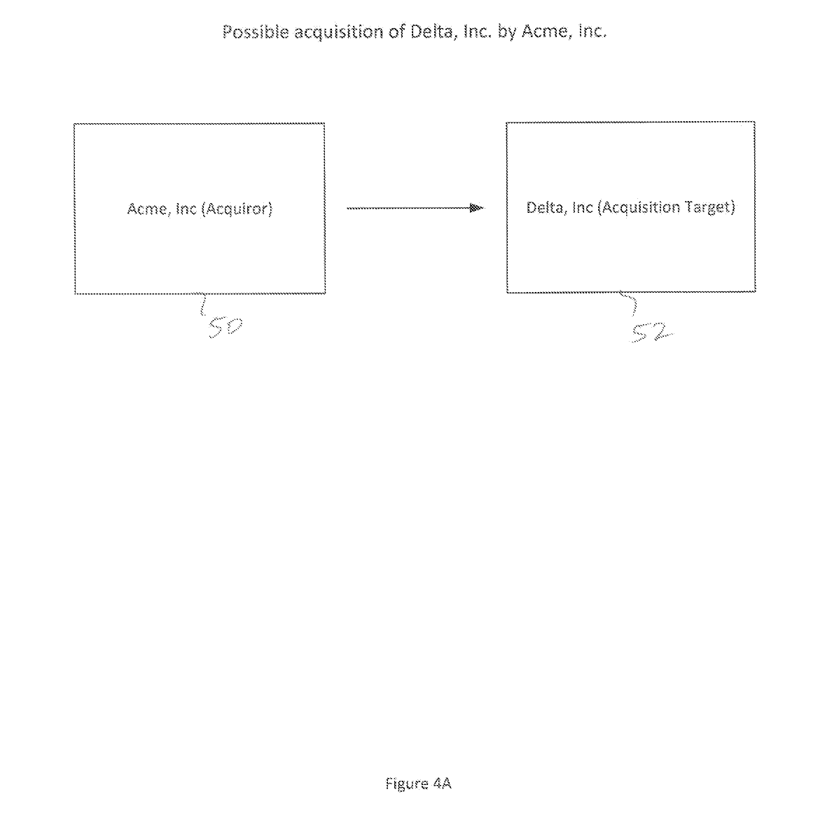

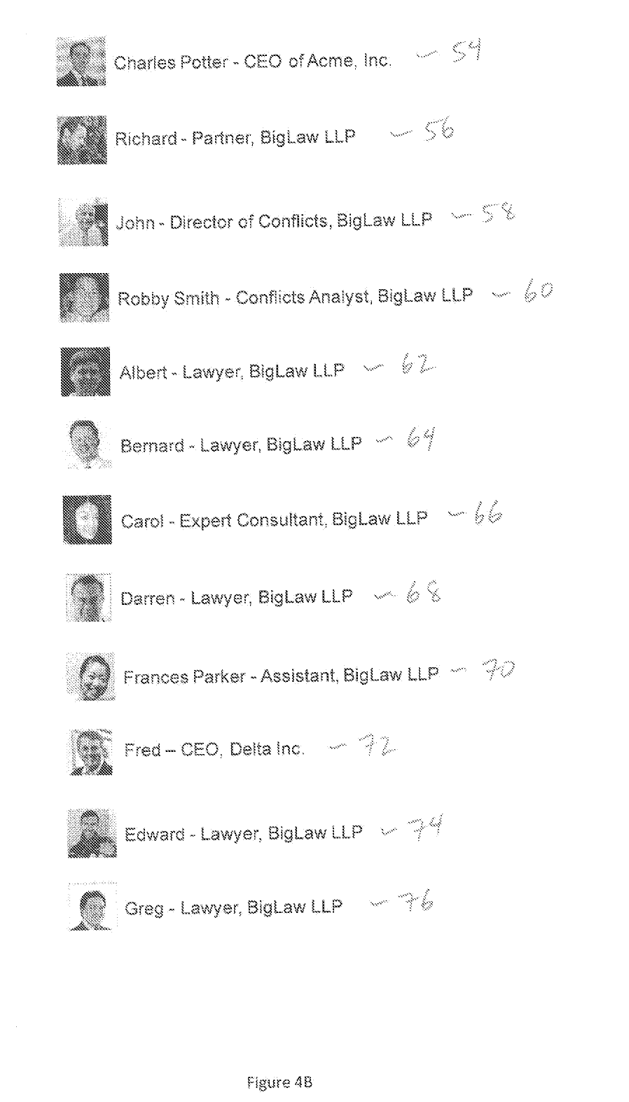

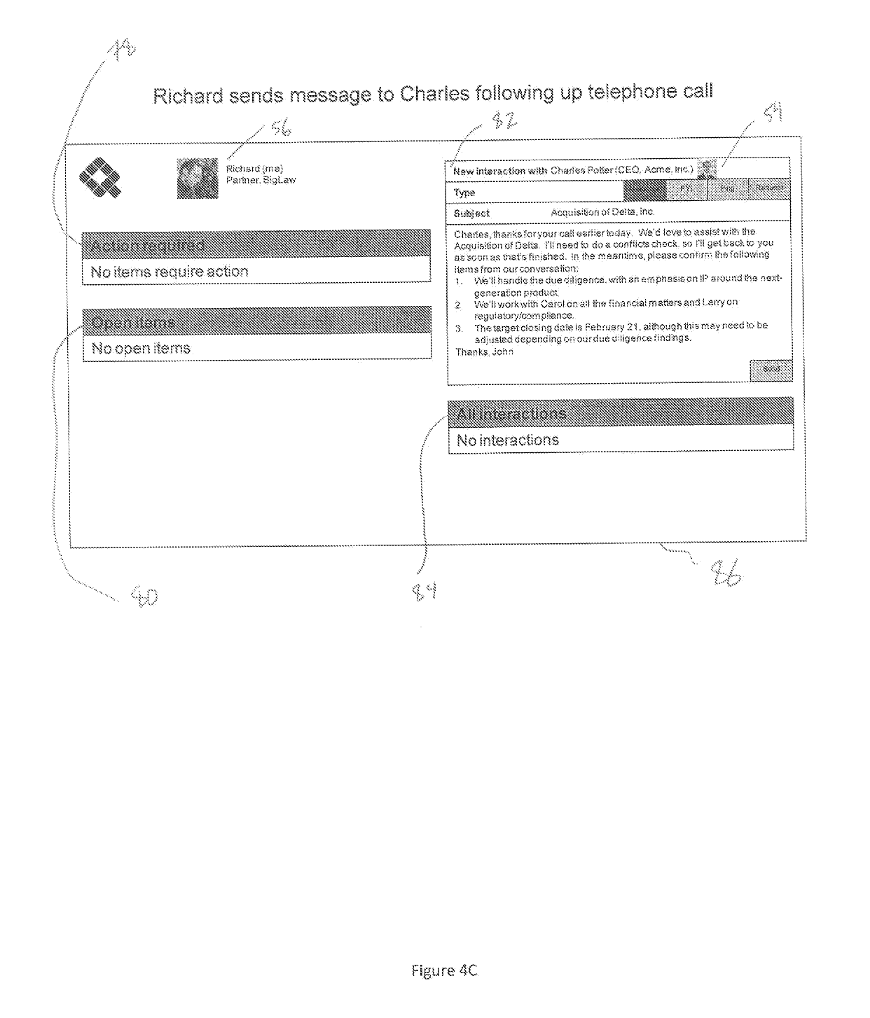

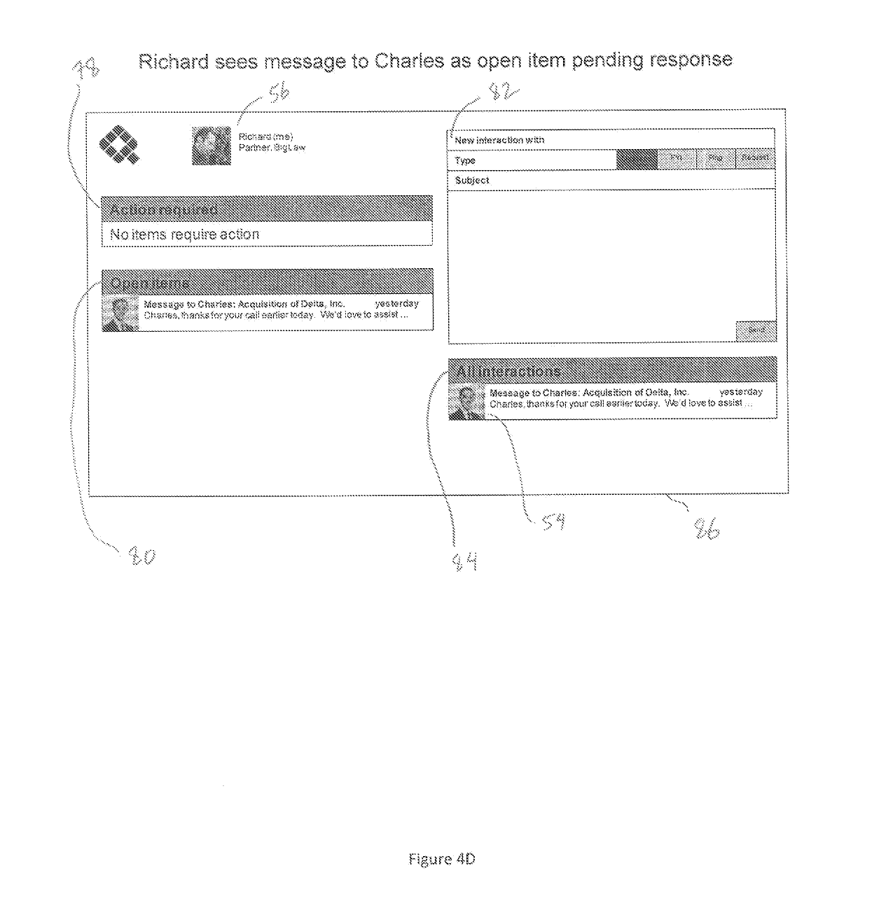

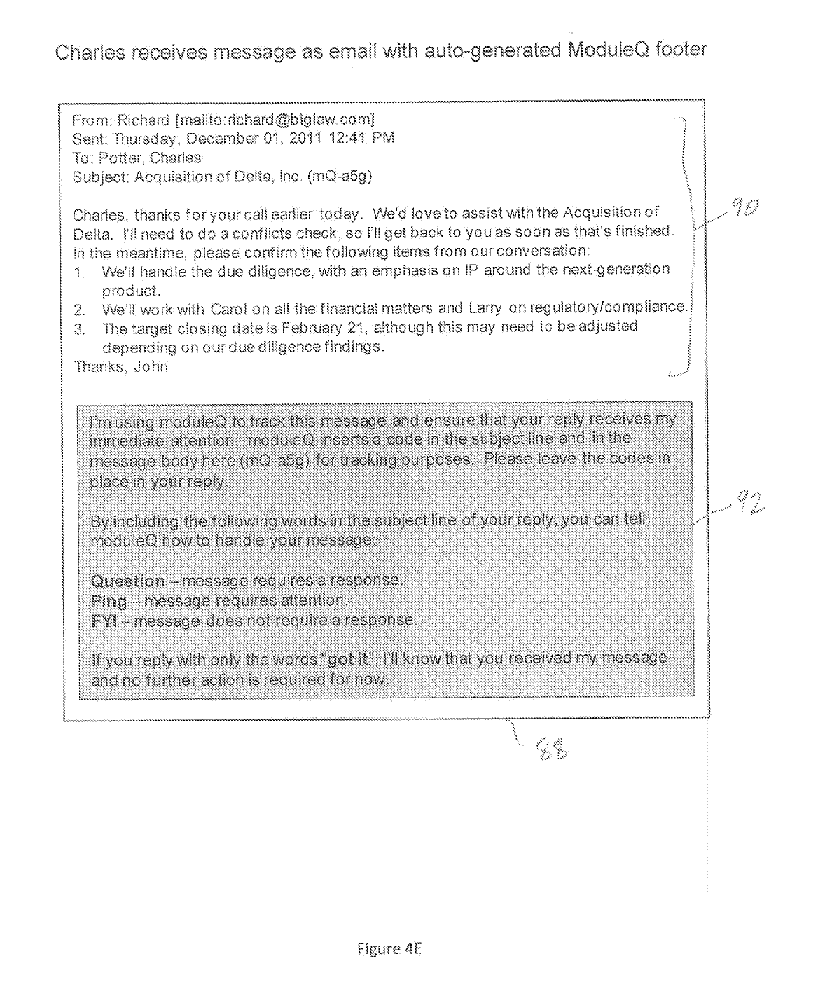

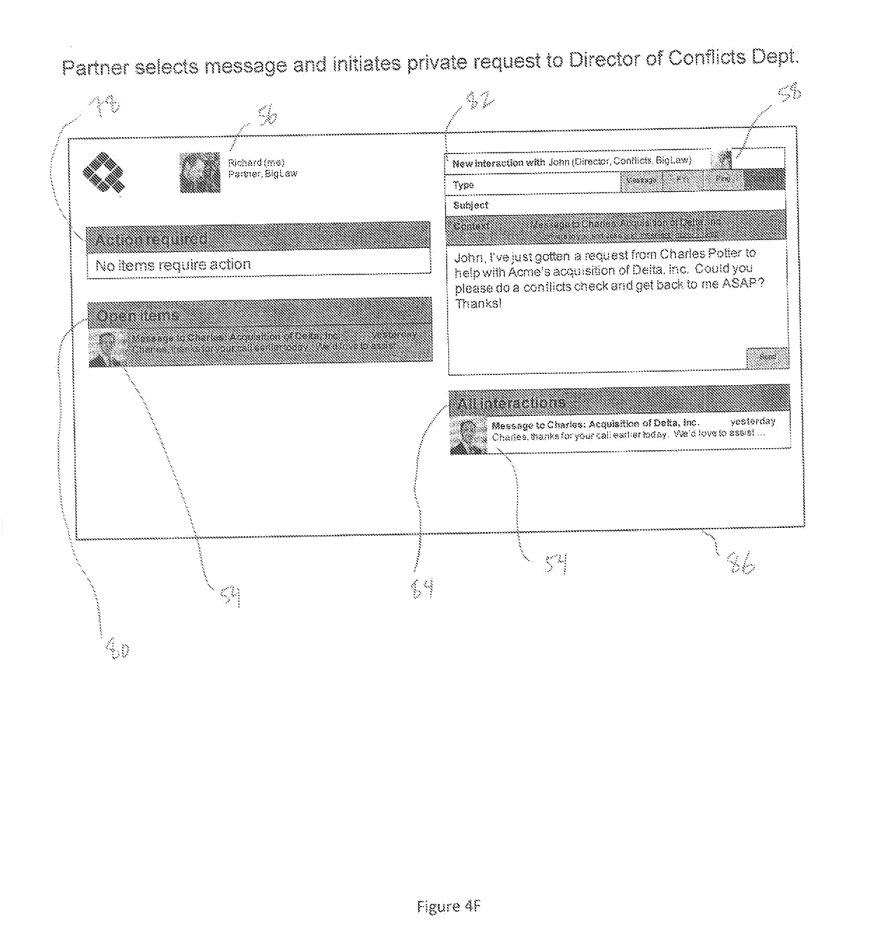

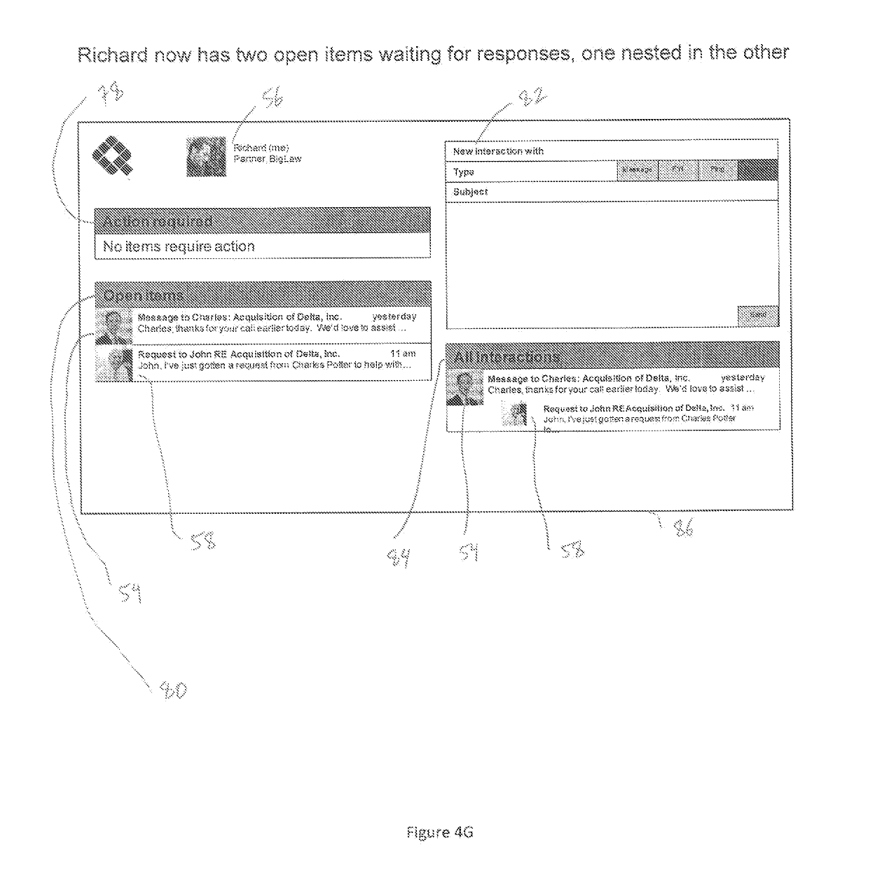

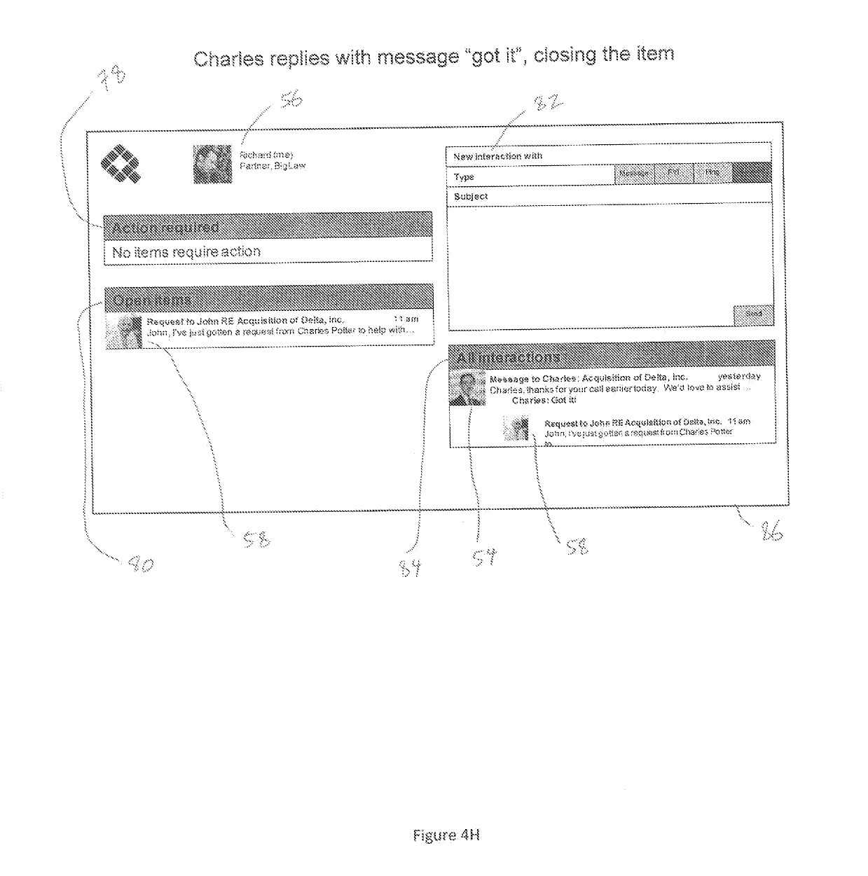

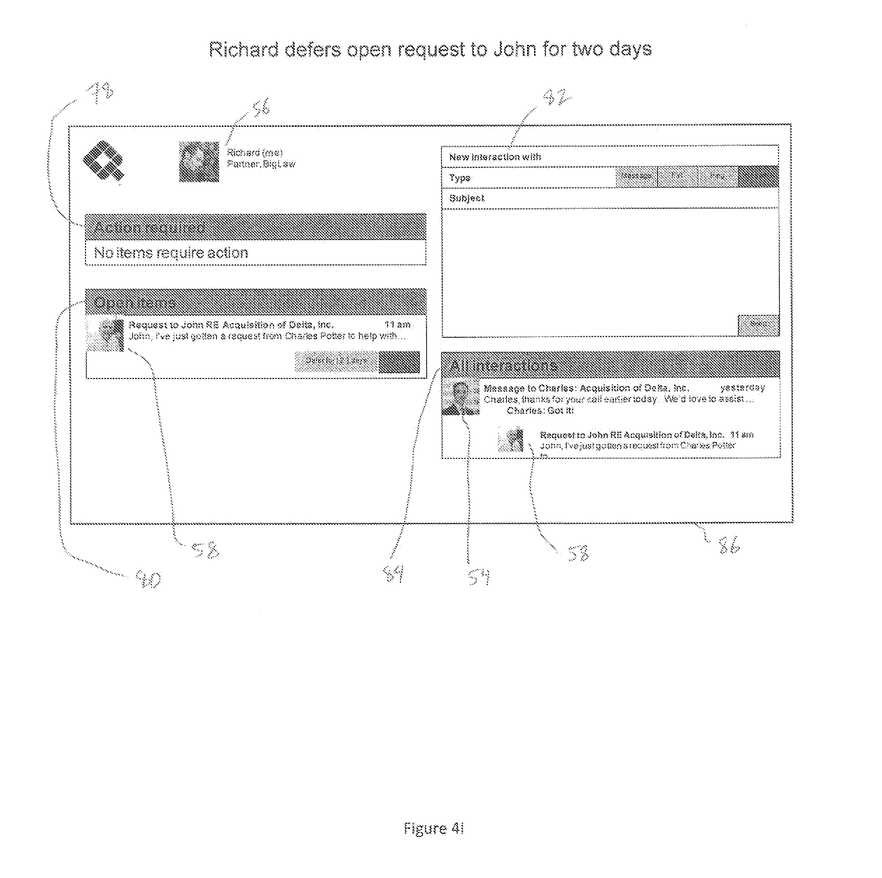

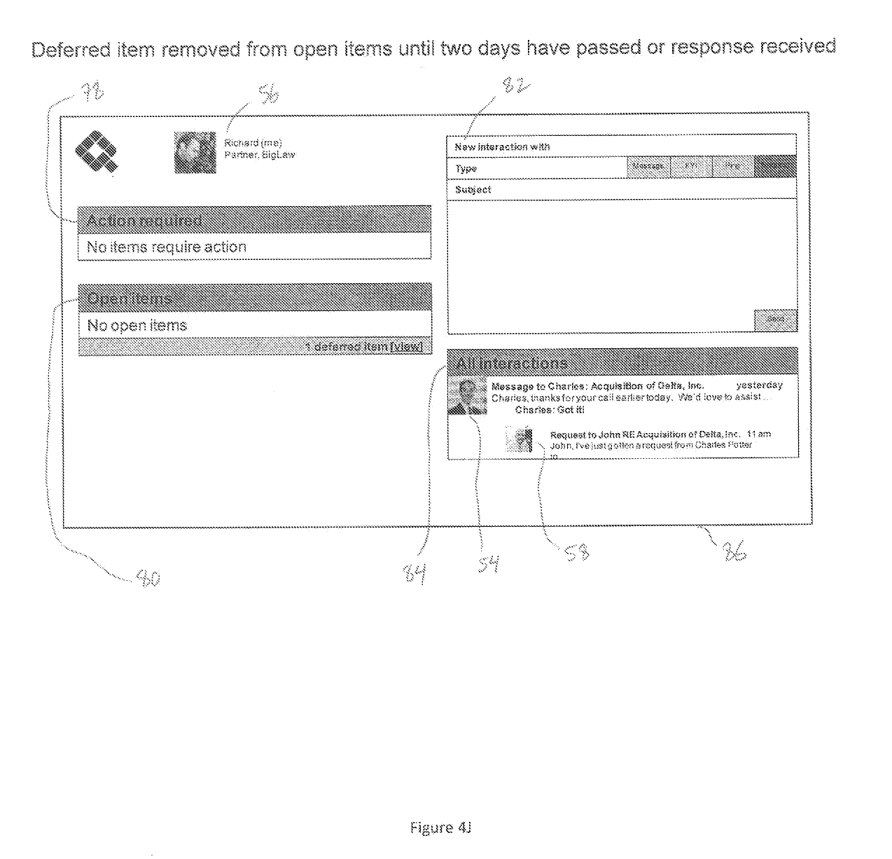

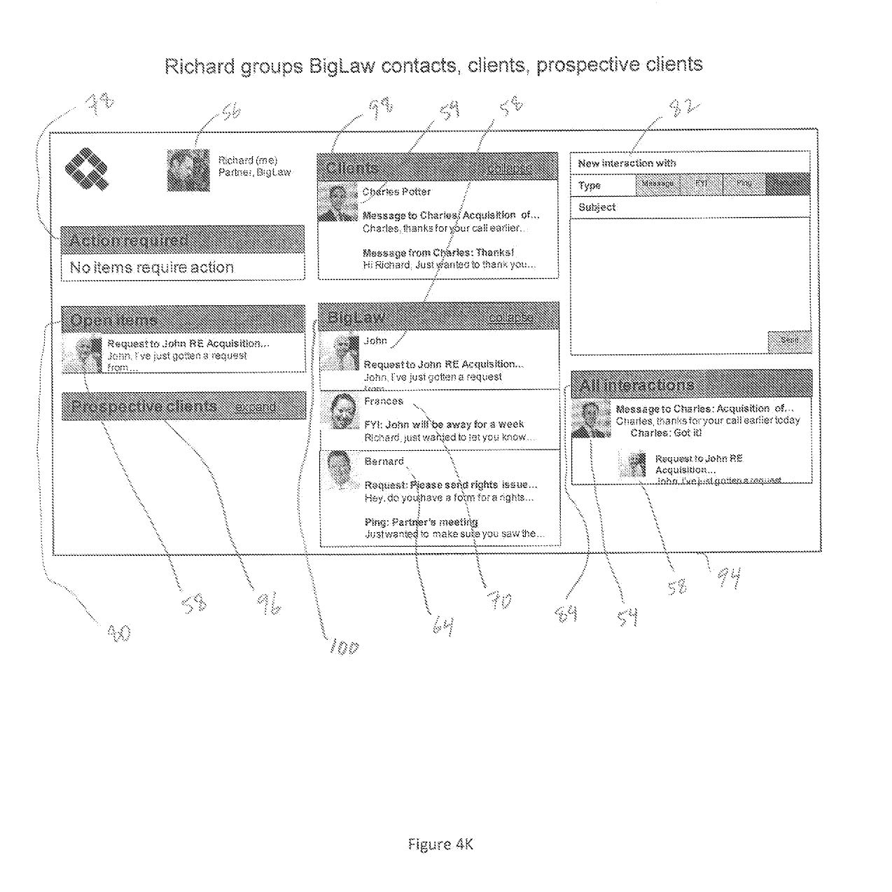

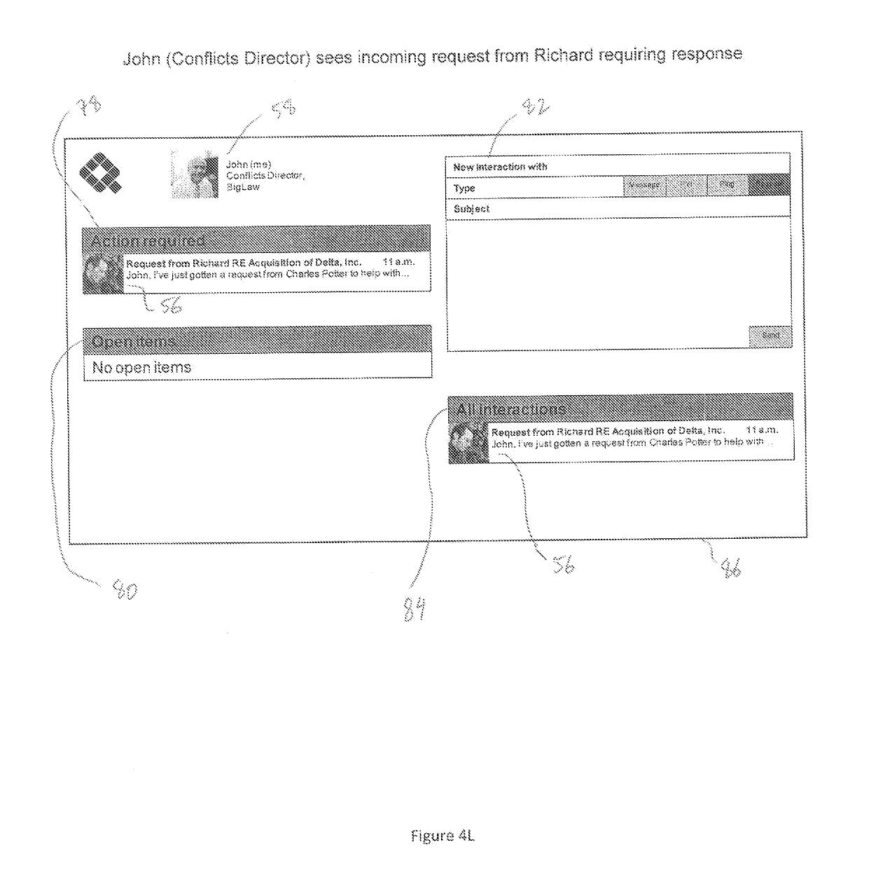

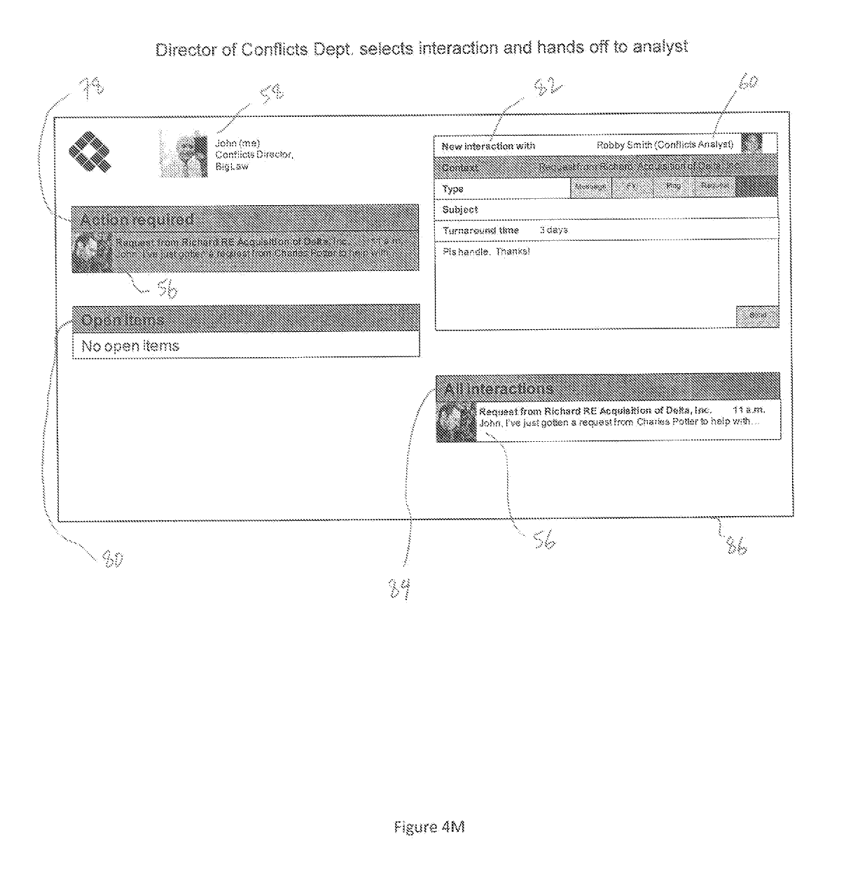

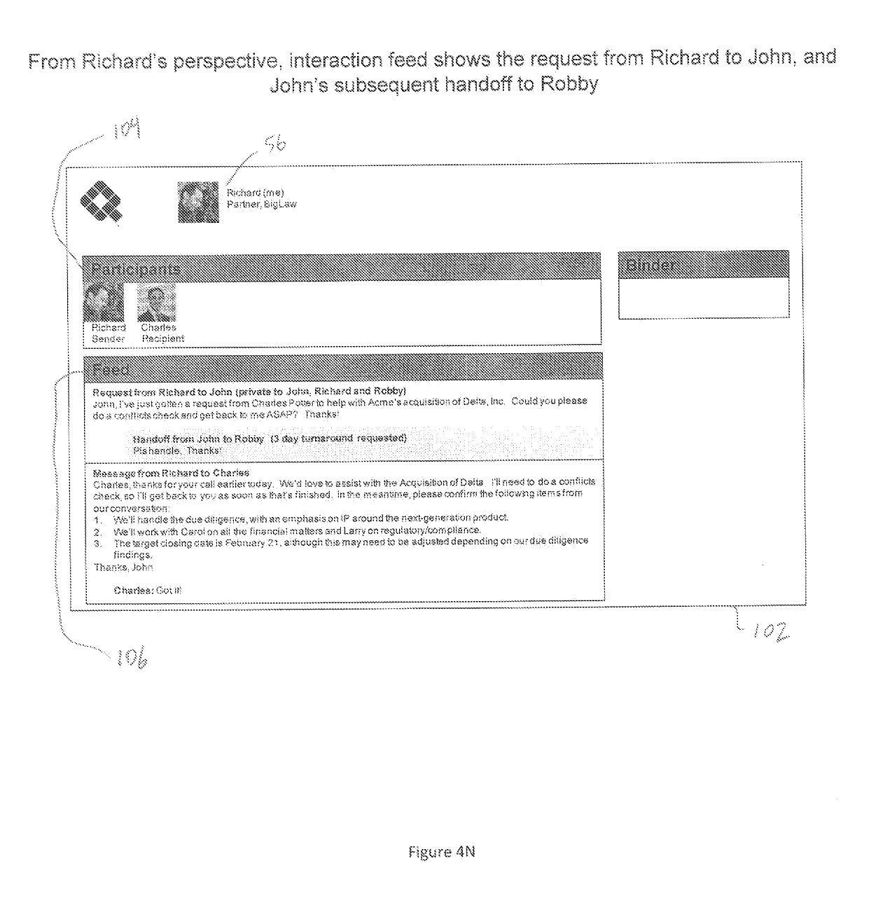

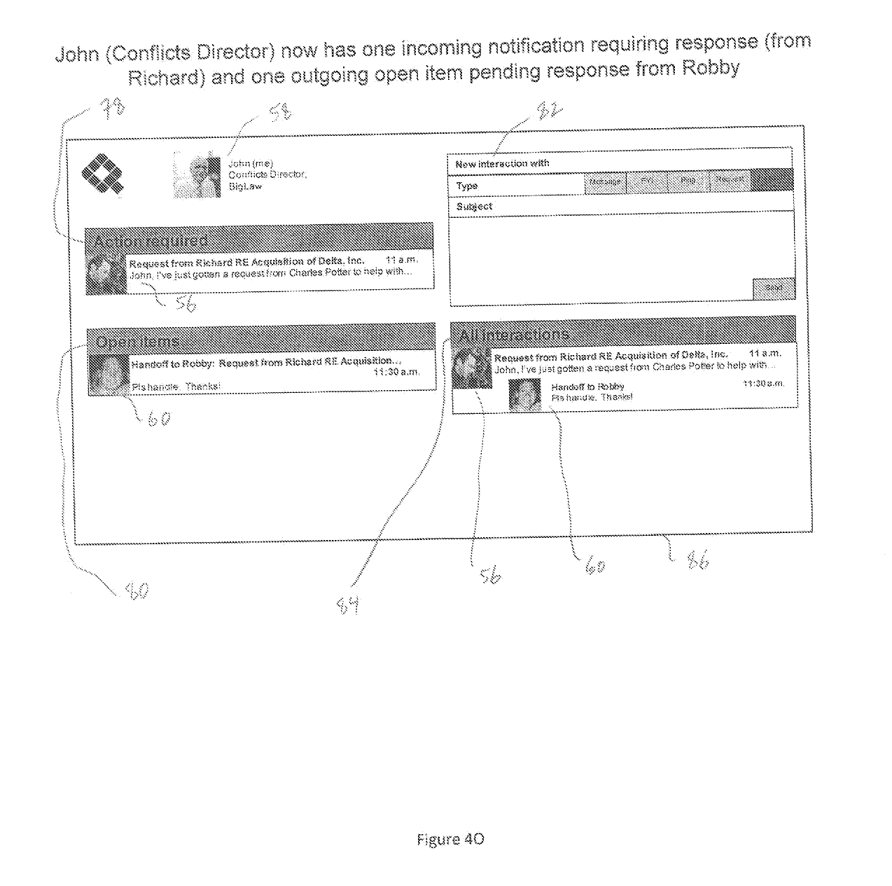

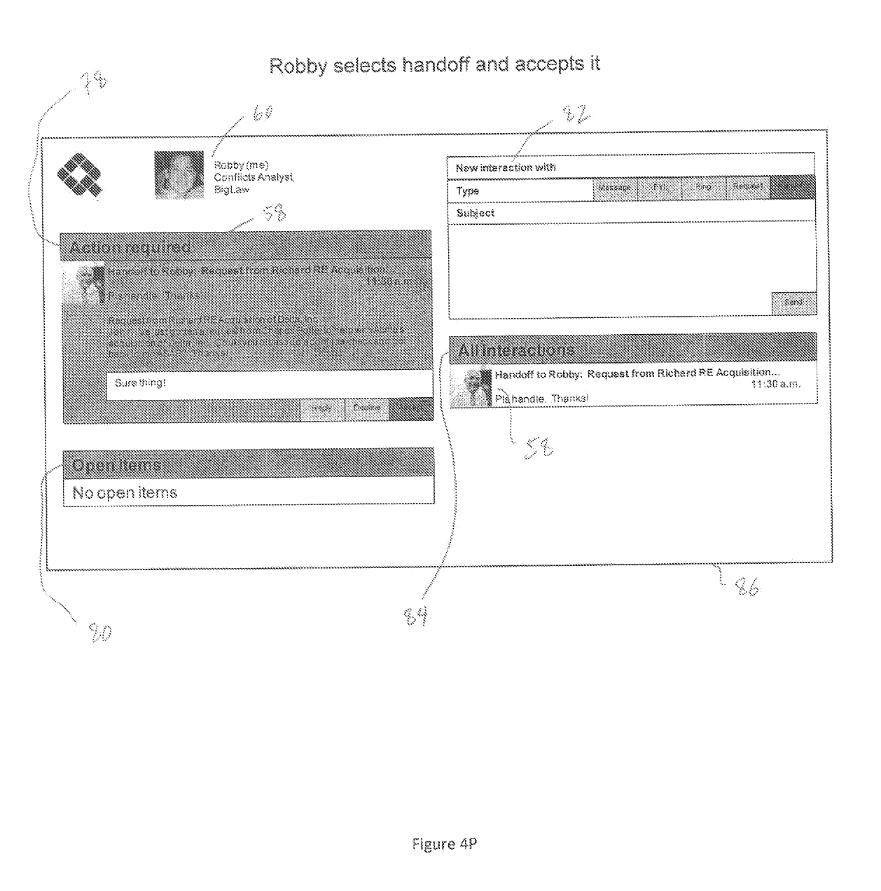

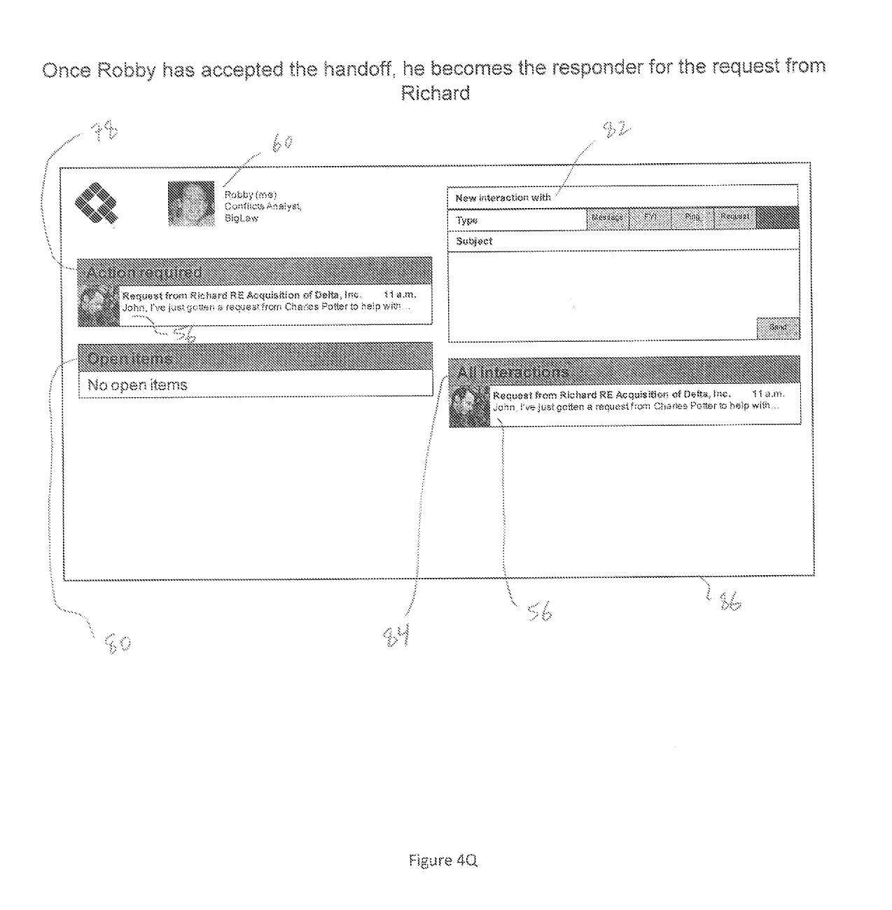

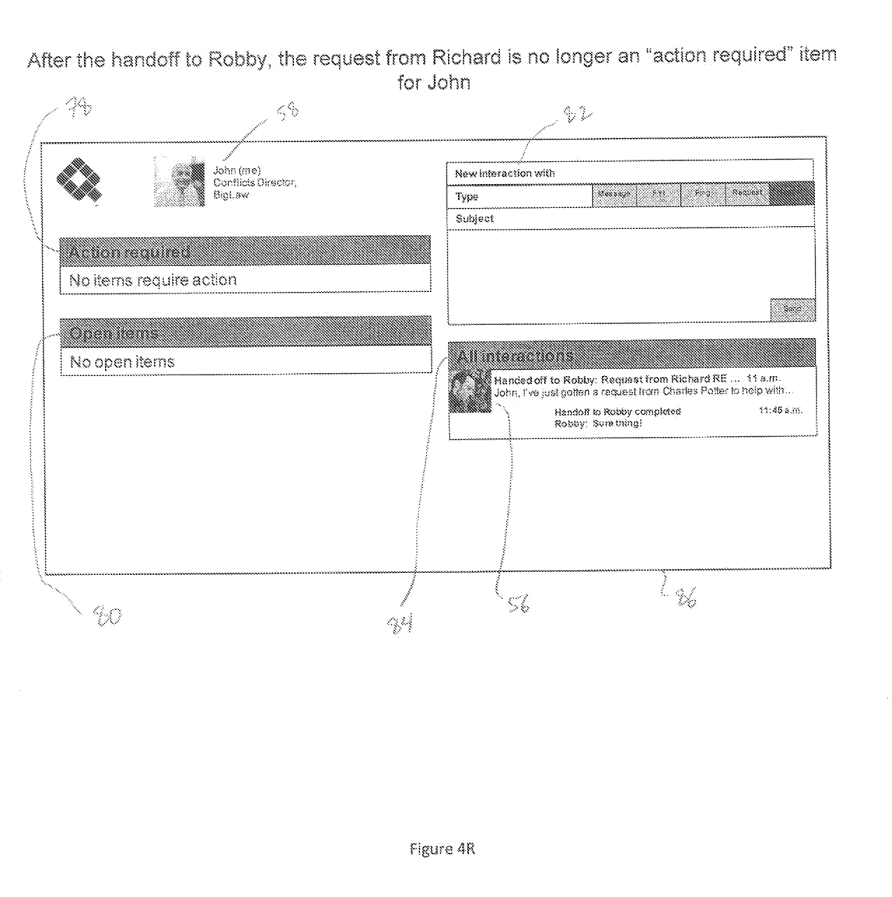

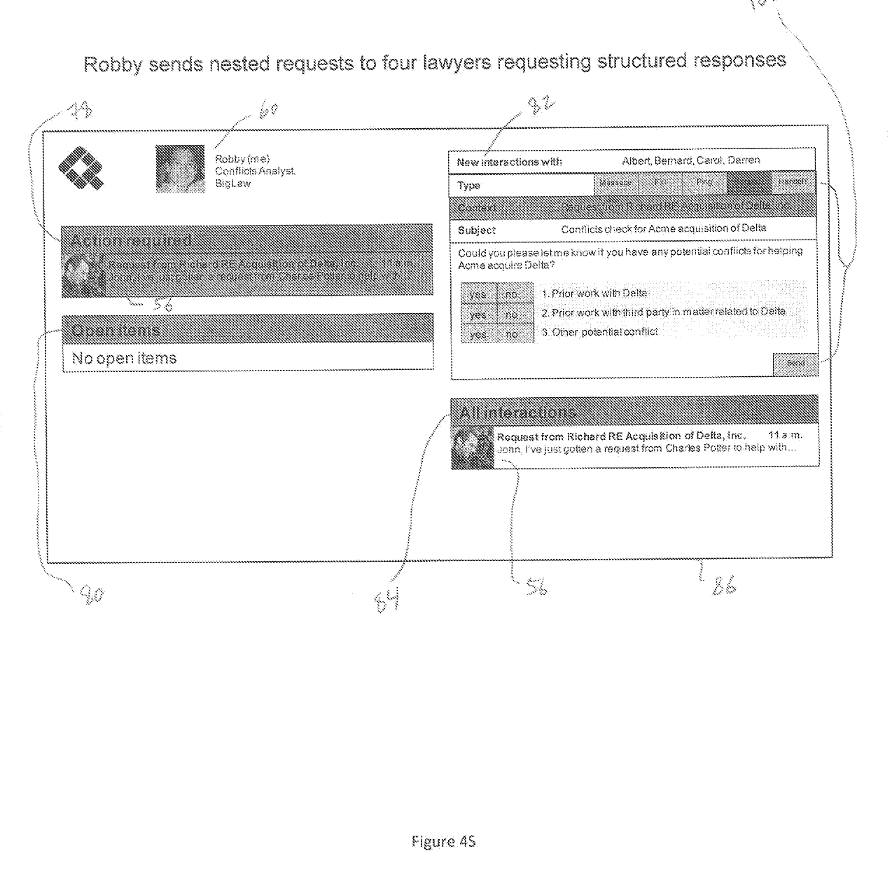

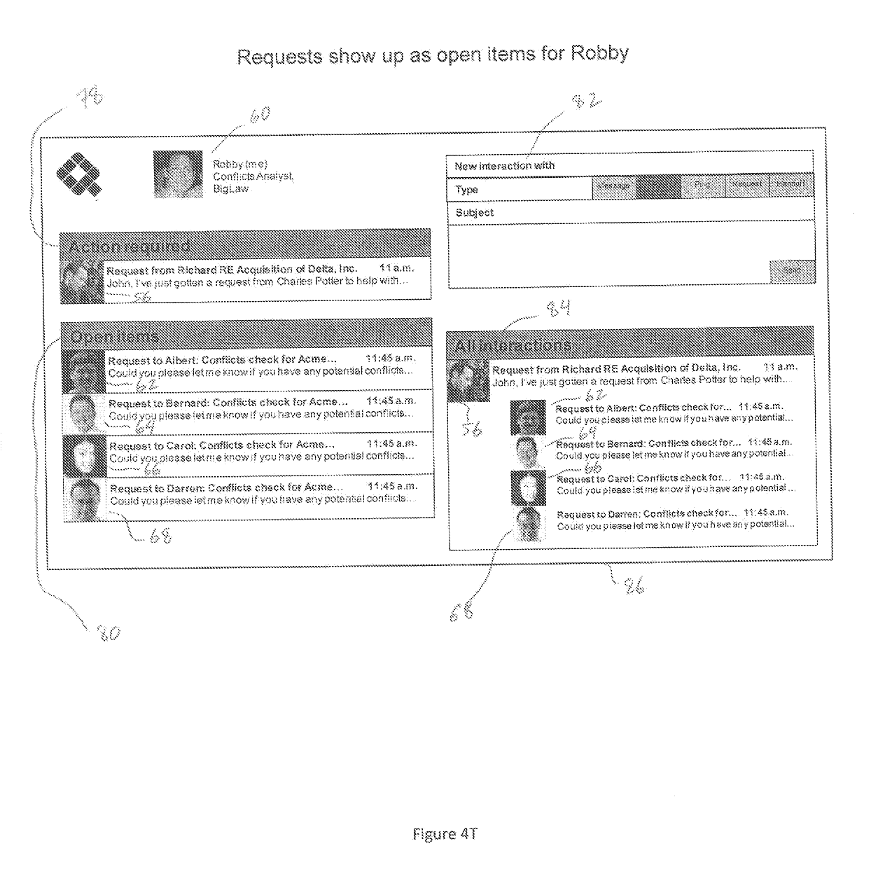

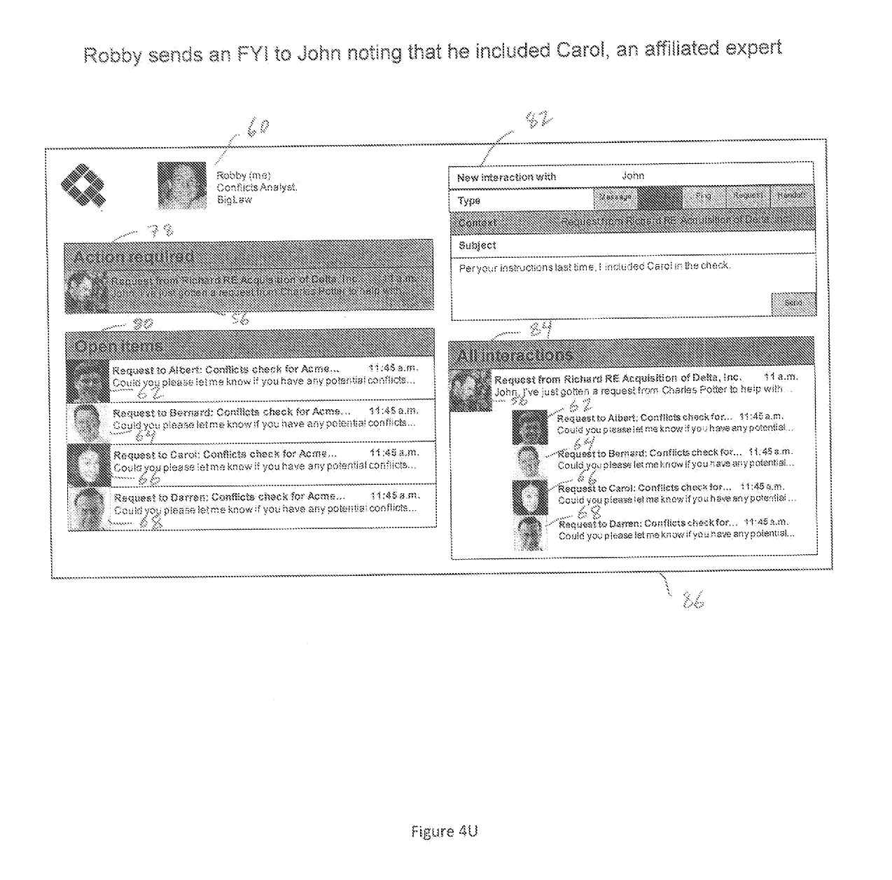

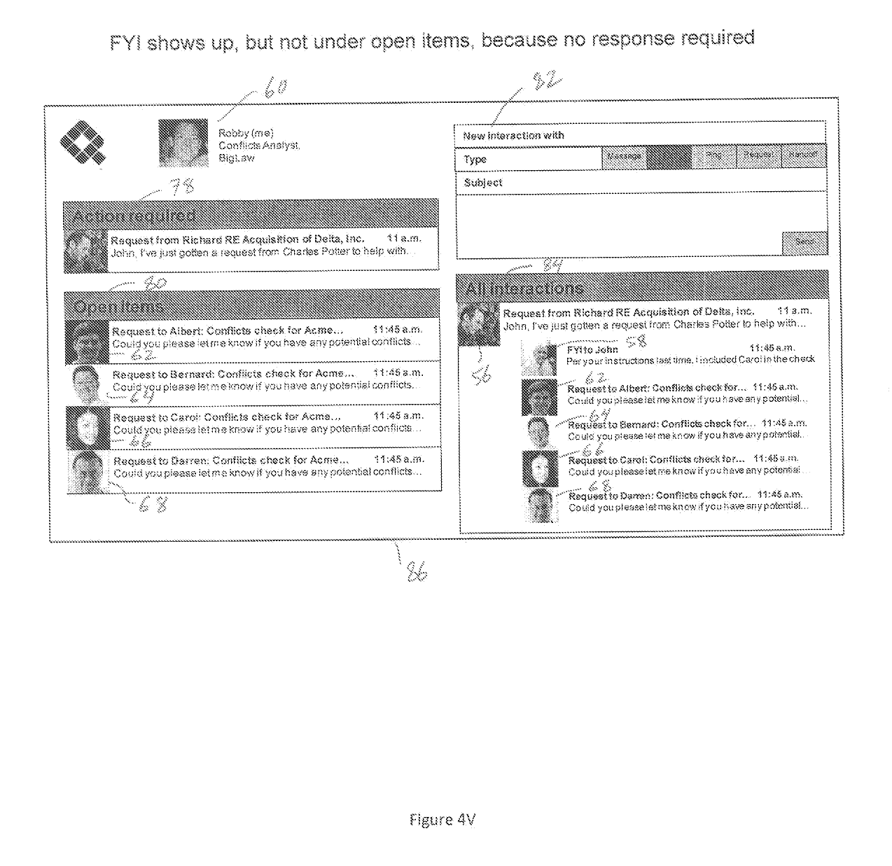

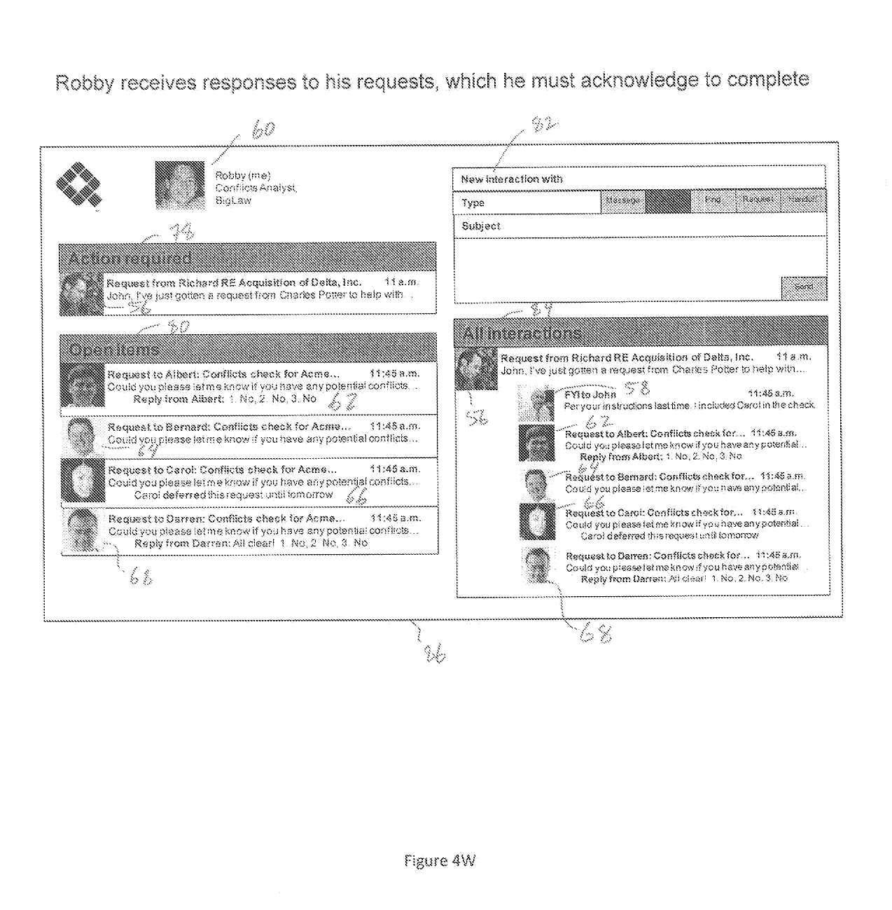

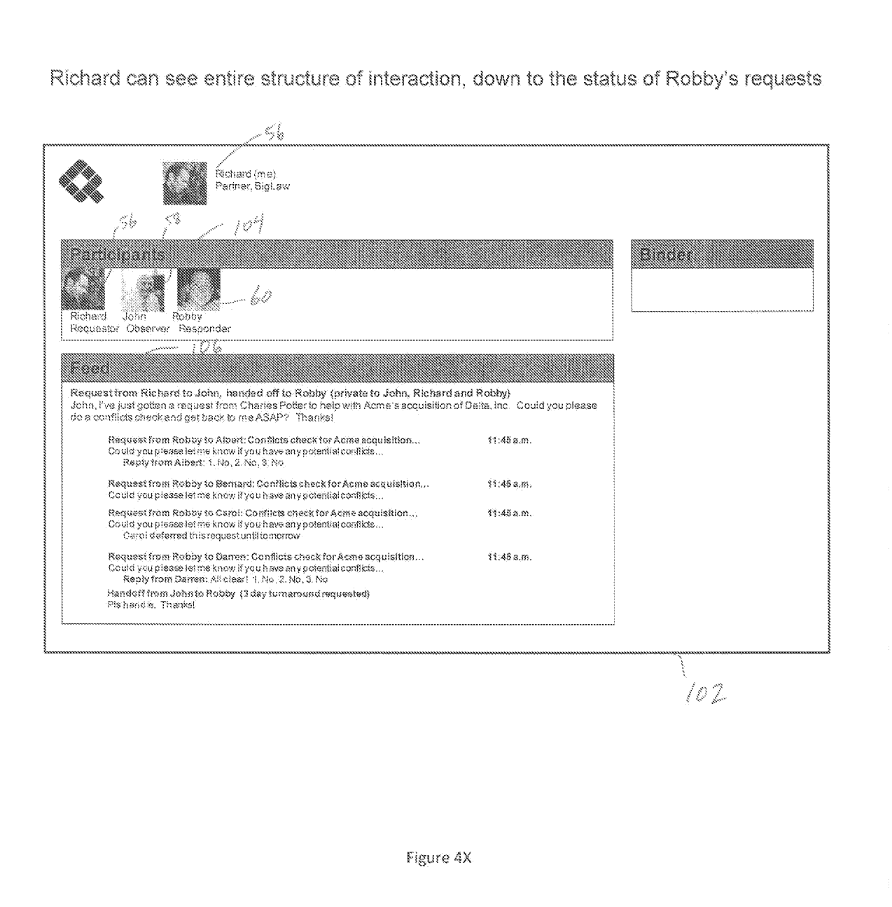

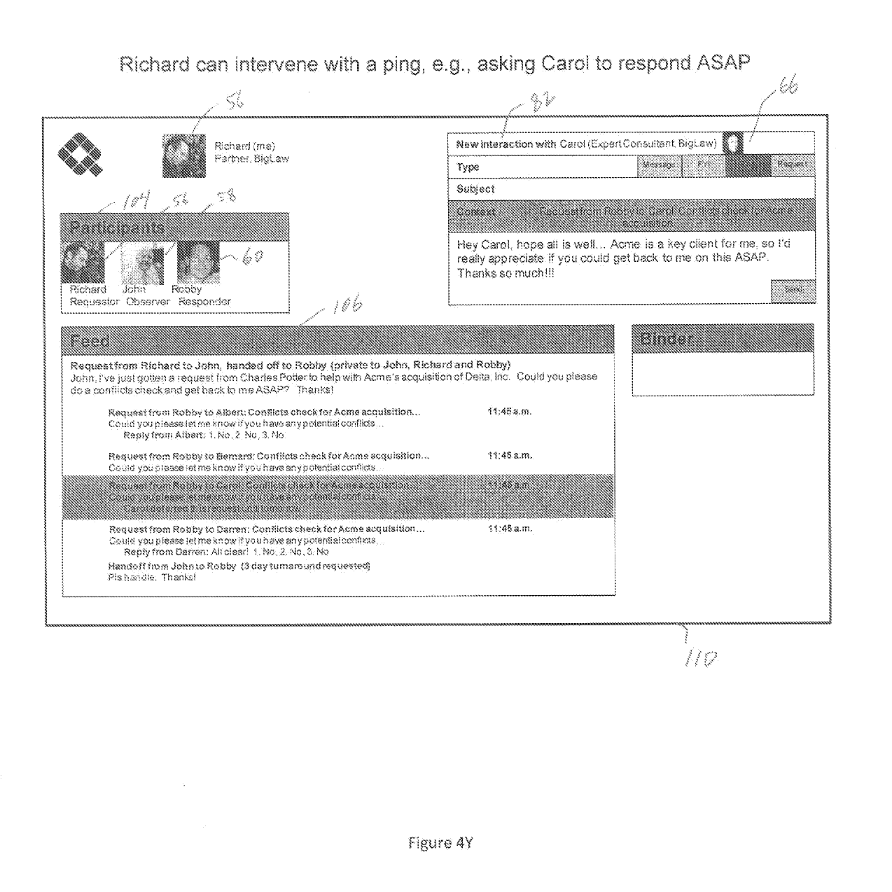

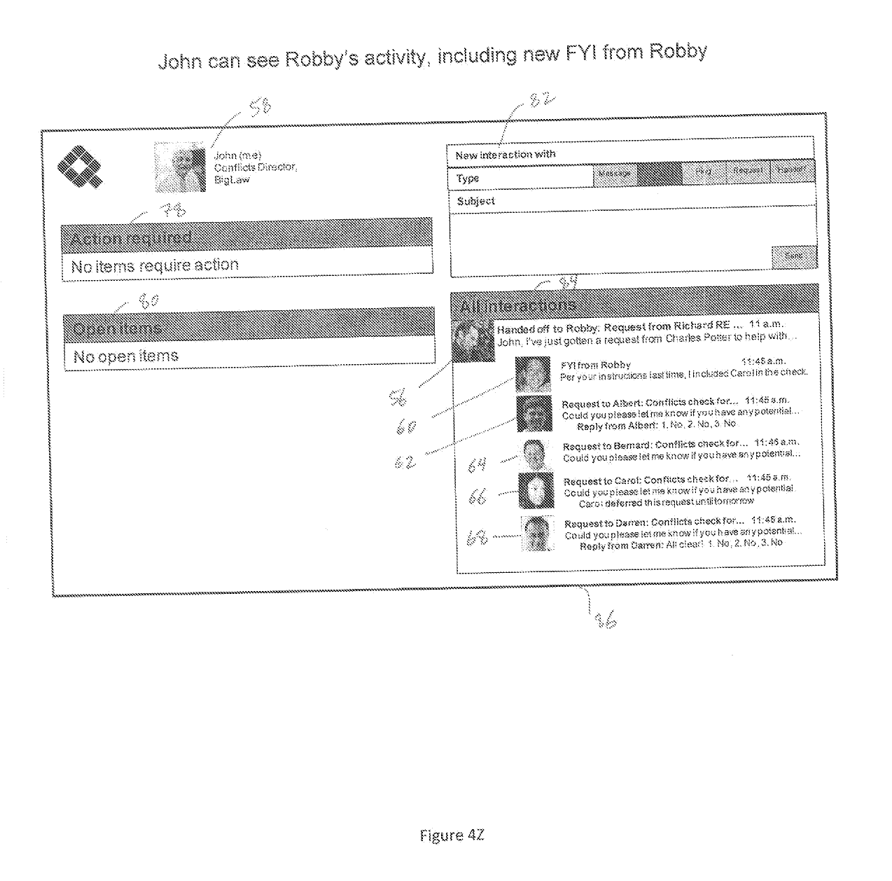

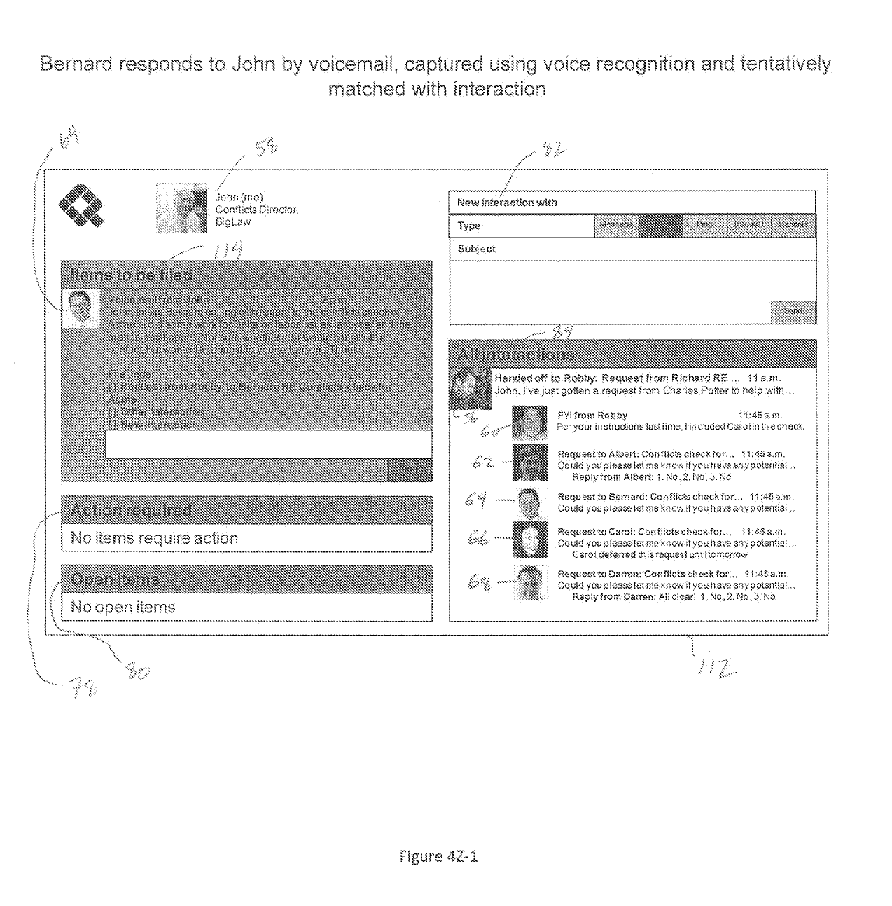

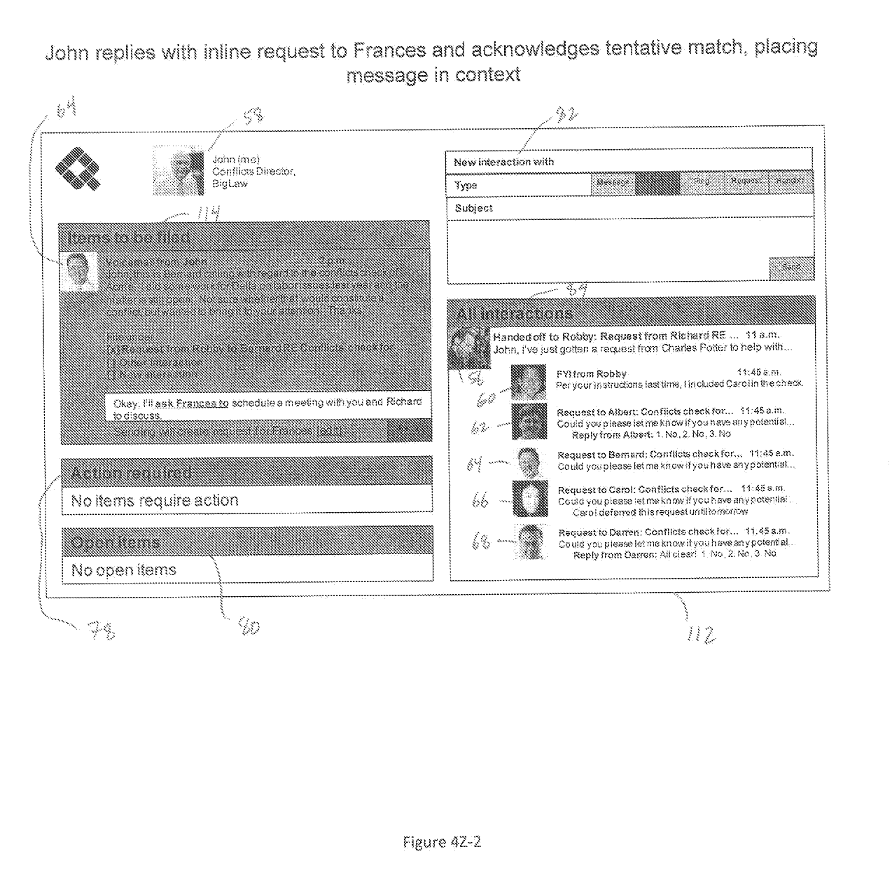

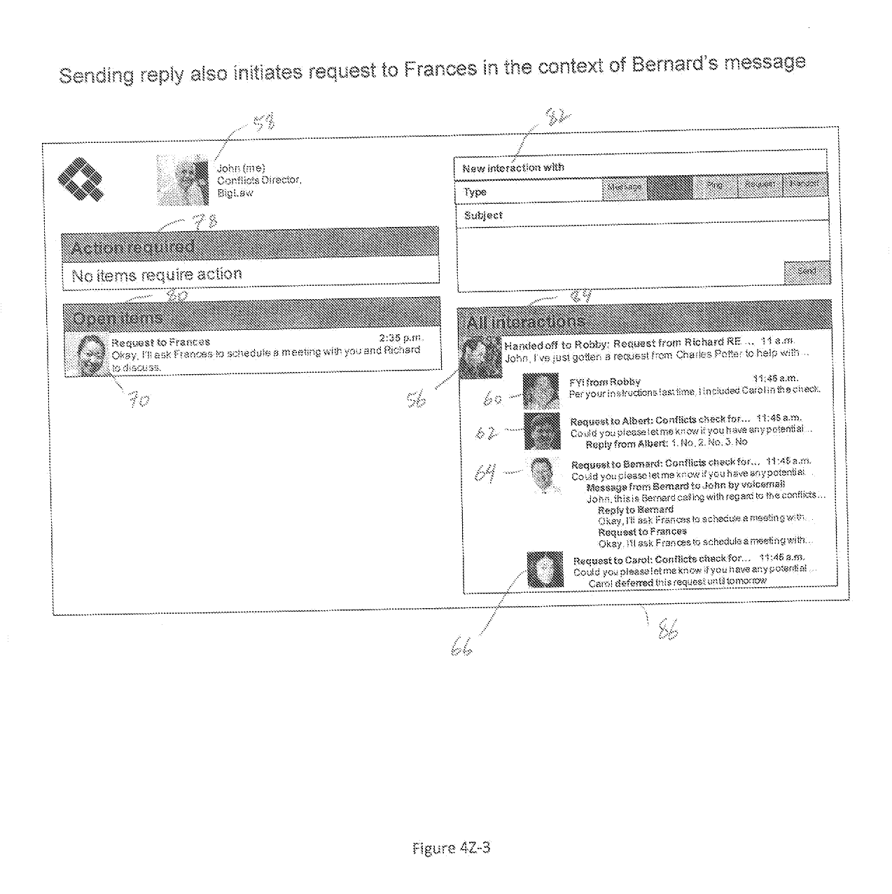

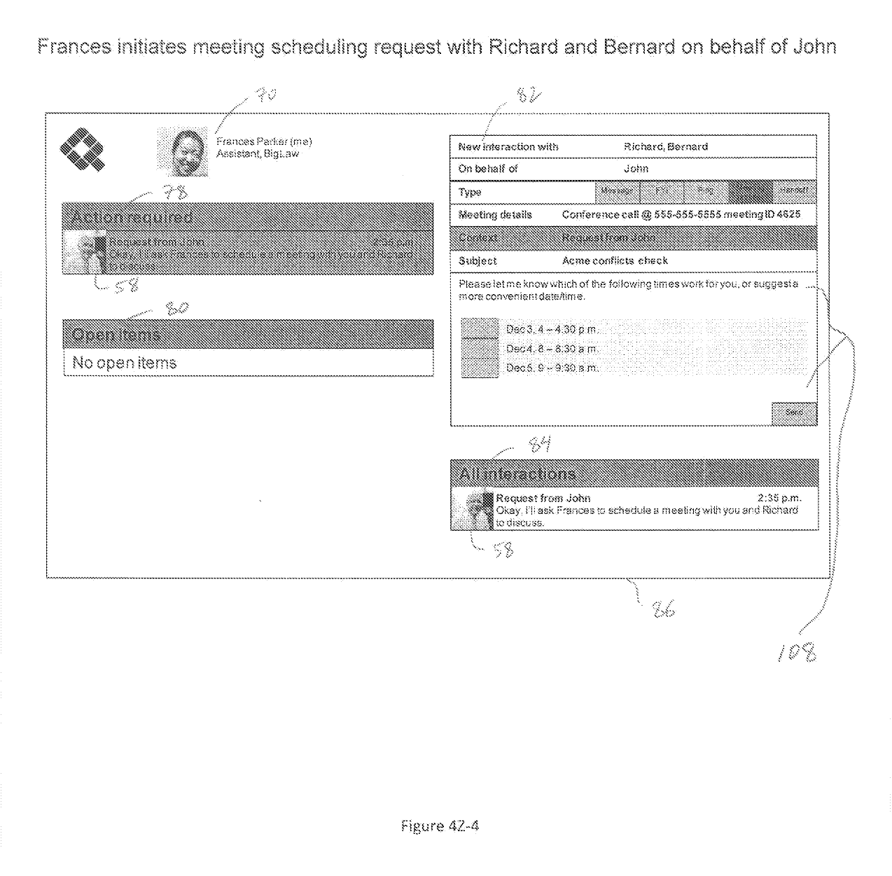

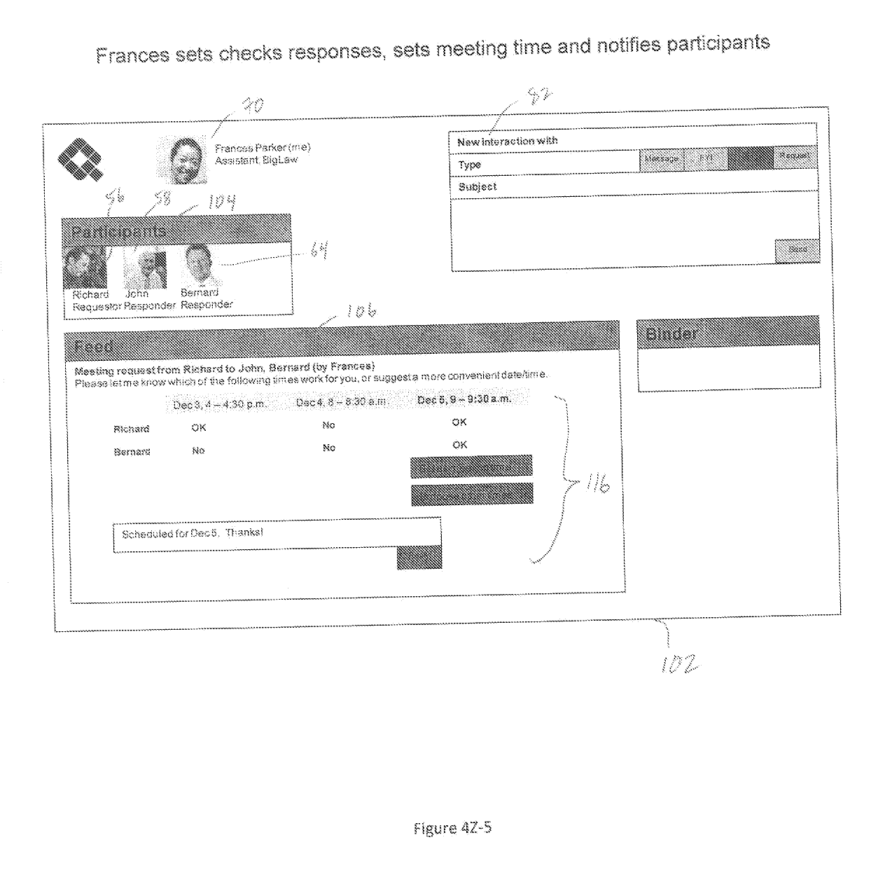

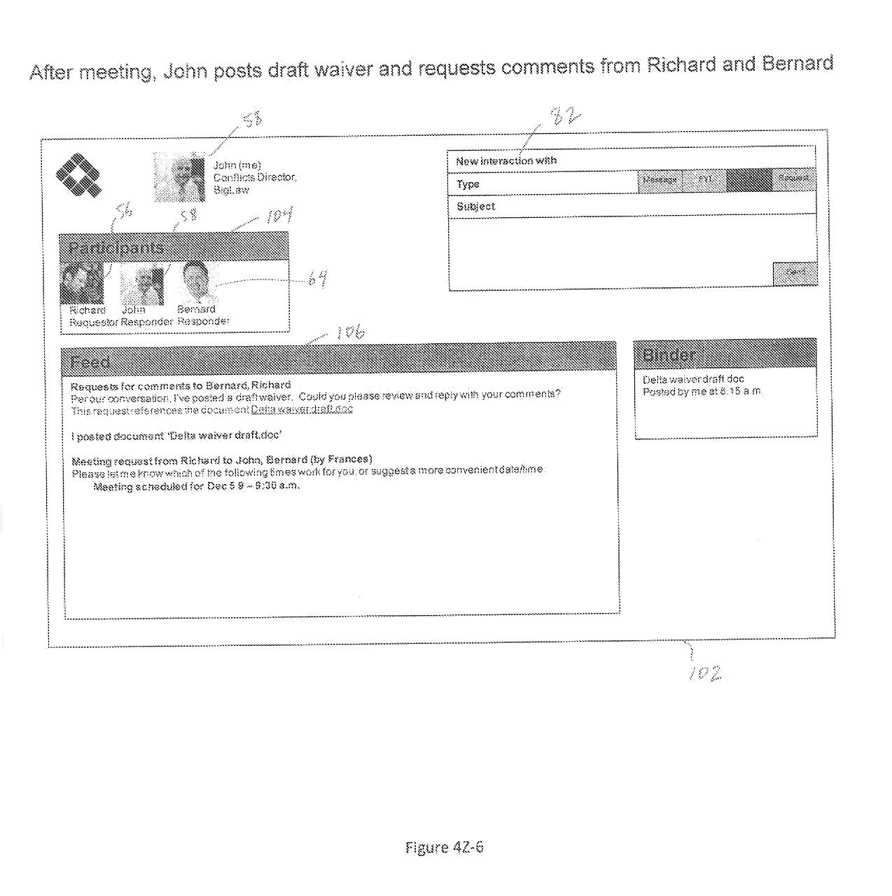

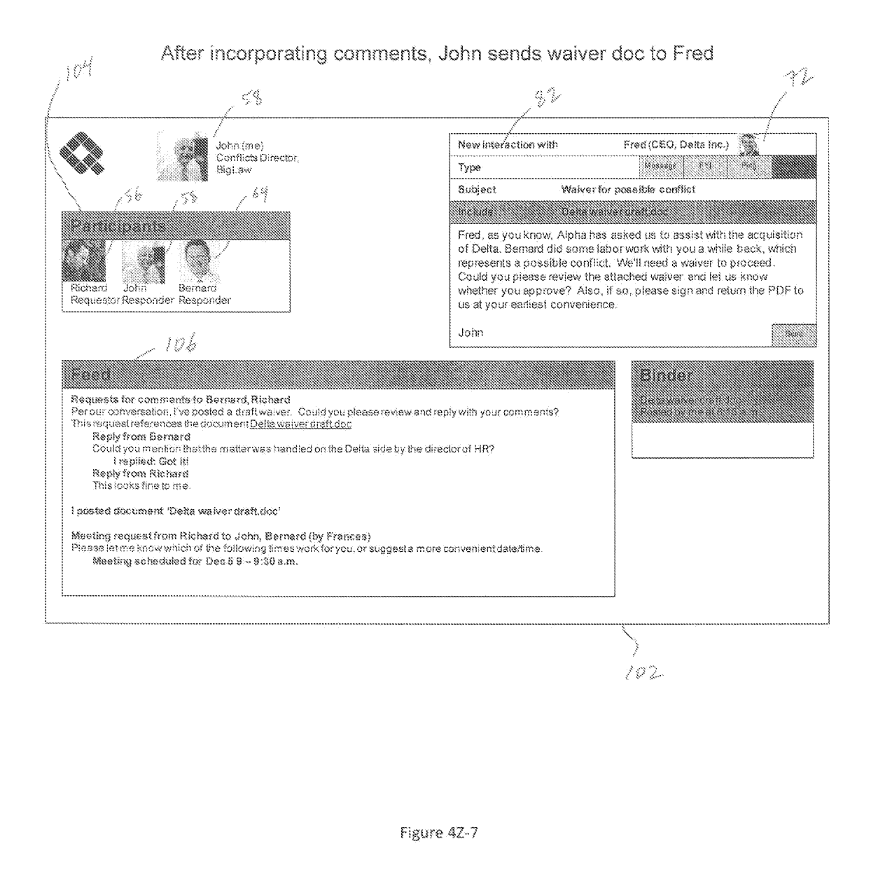

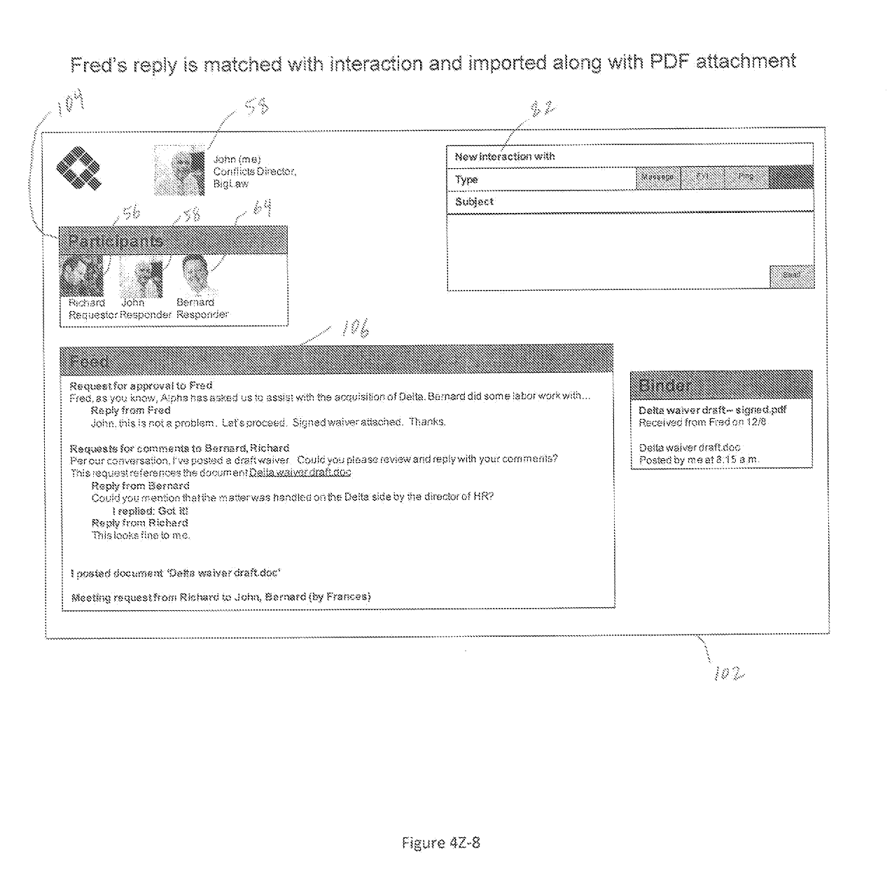

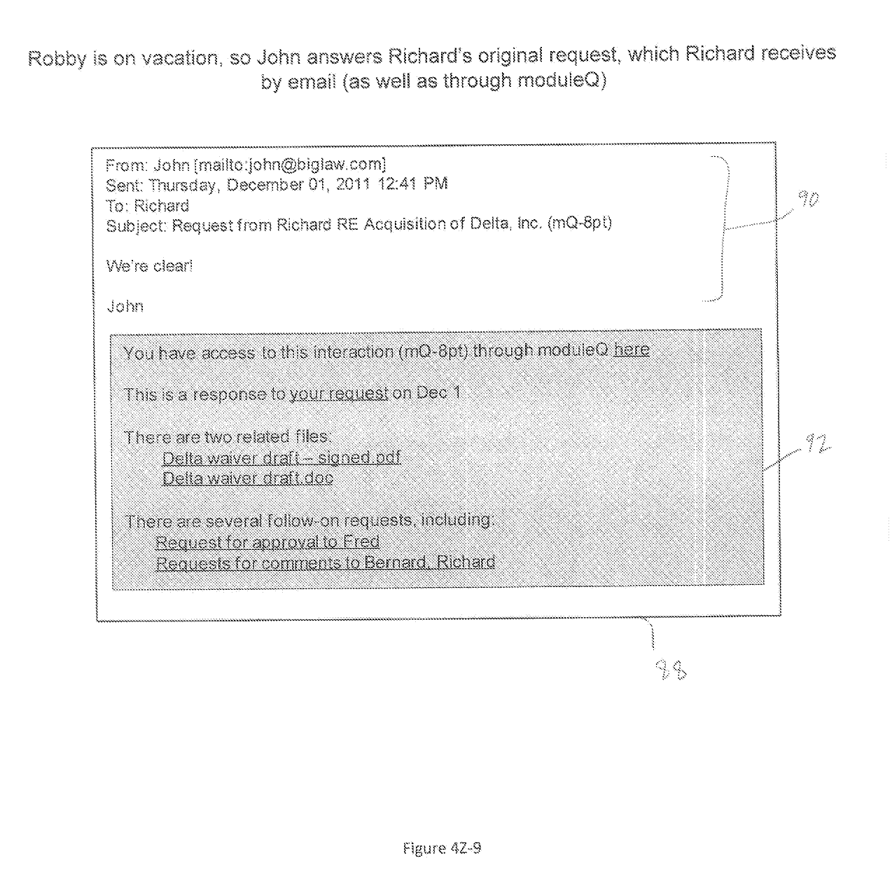

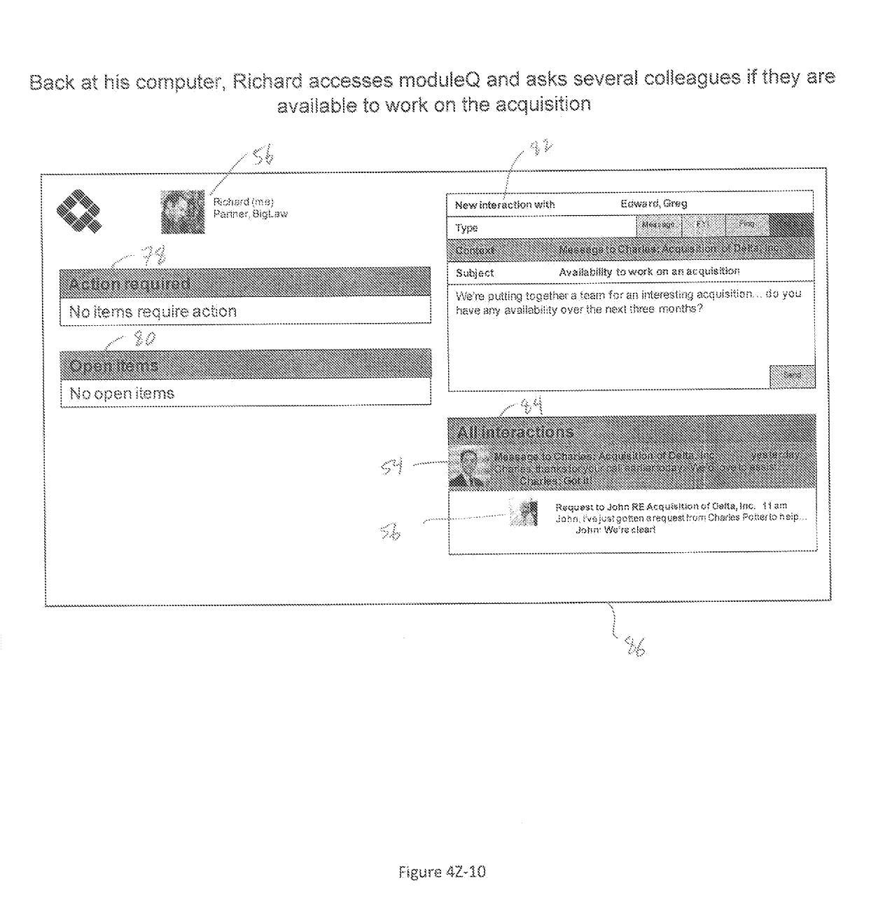

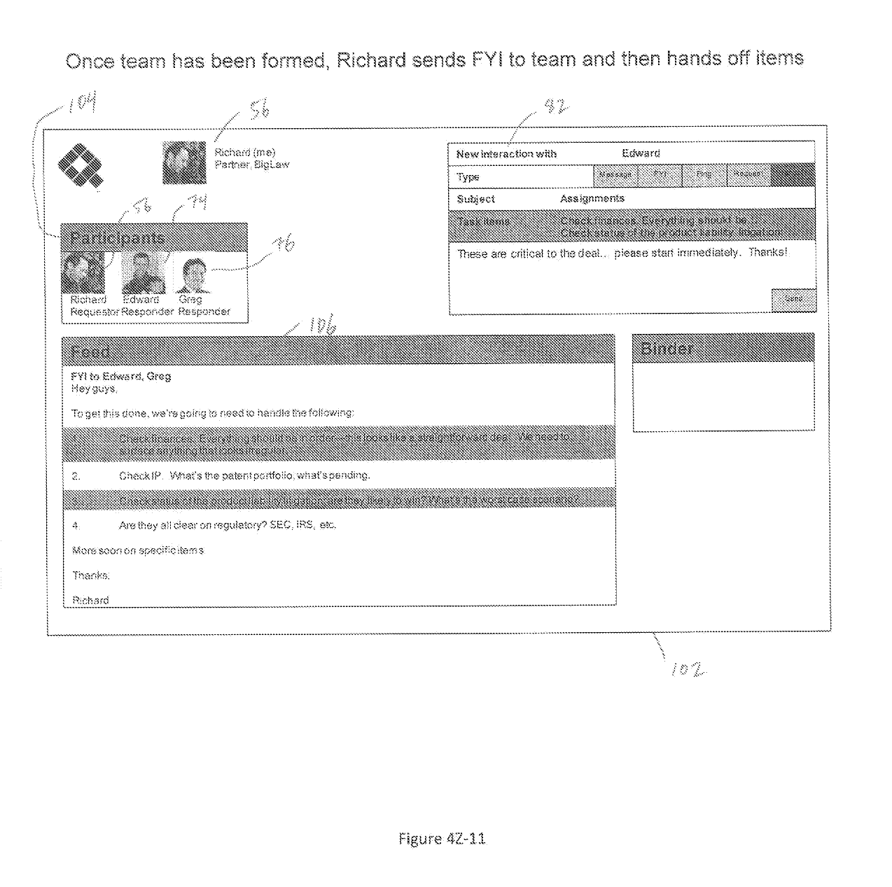

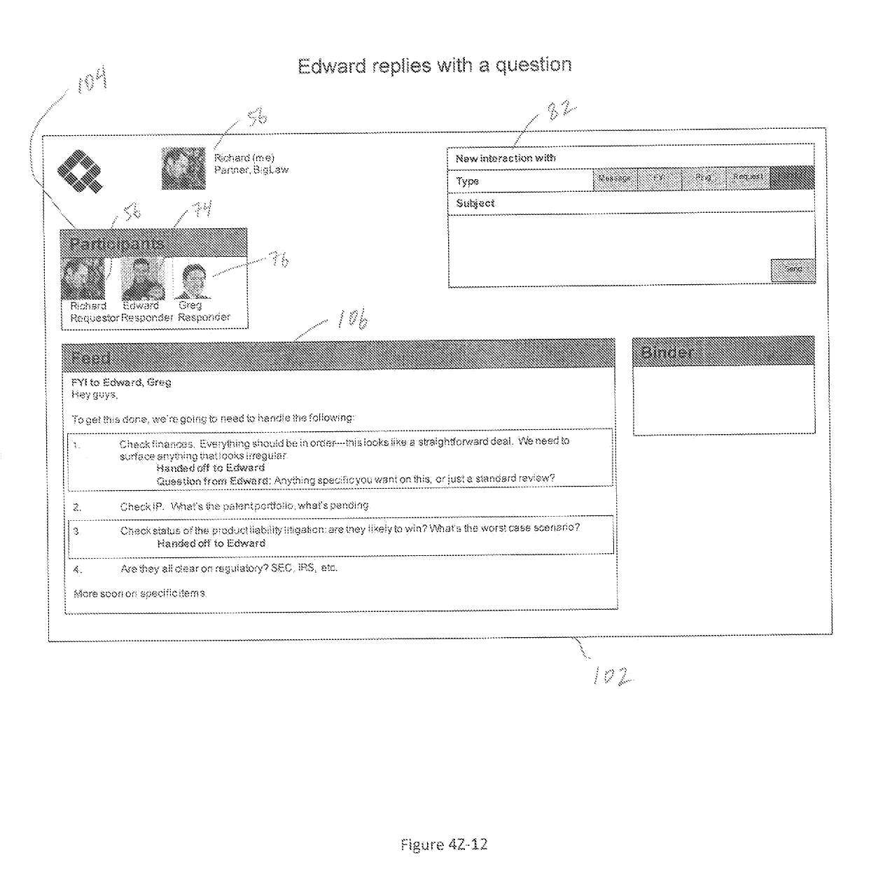

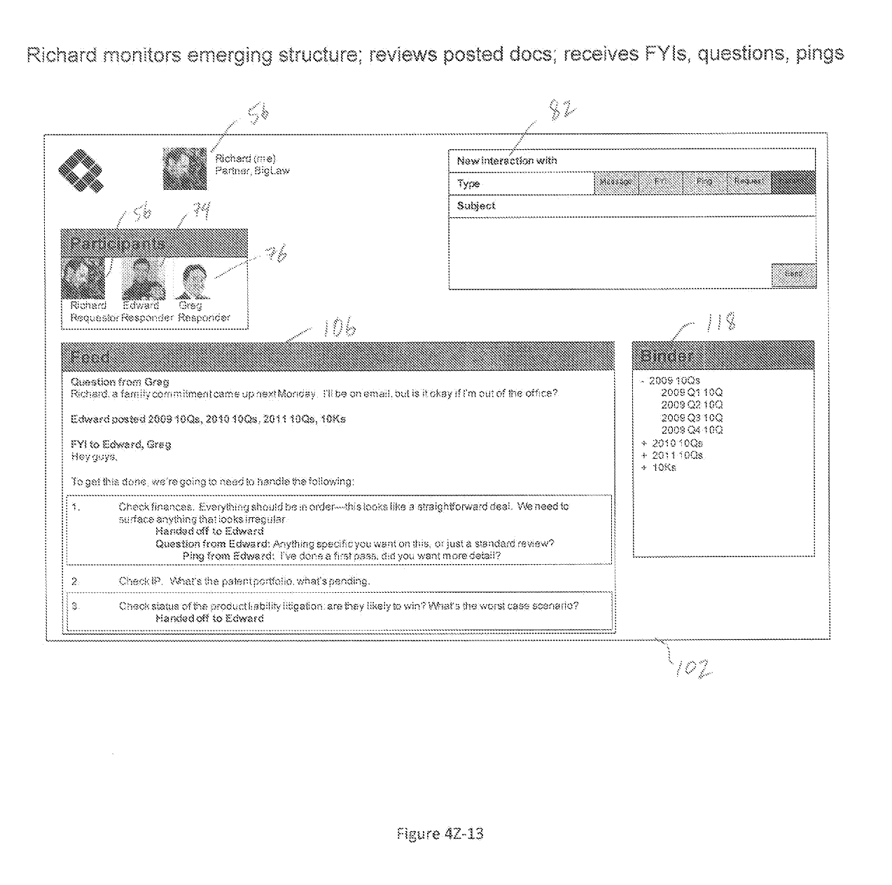

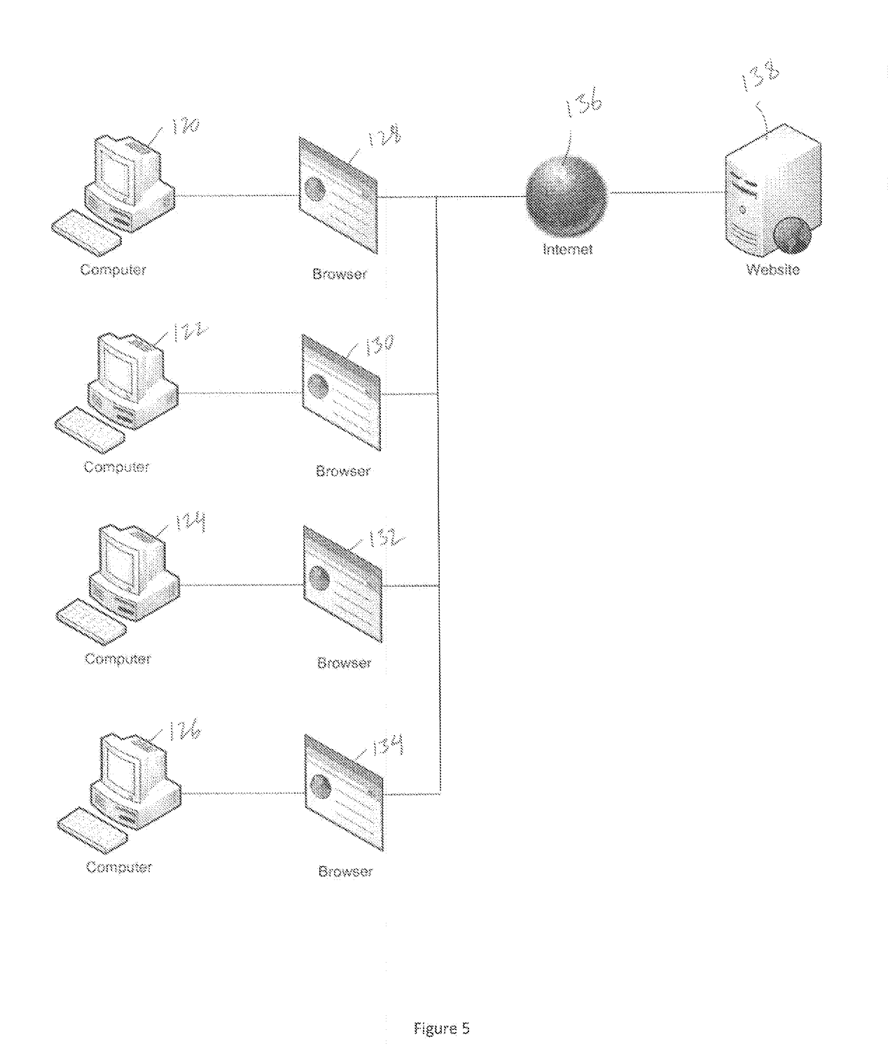

Referring to FIGS. 3A-3C, various embodiments are depicted wherein various shortcomings of conventional communication transaction systems are addressed in a generic form; specific examples are illustrated in reference to FIGS. 4A to 4Z-13. As shown in FIG. 3A, an online application or web service may be configured to allow an electronically mediated interaction pertinent to a communication transaction between two or more parties to be initiated (20). In one embodiment, the system may be configured to attempt to establish an initial context for the communication transaction based upon factors such as previous electronically-mediated interactions between one or more of the involved parties (22). For the purposes of the subject invention, establishing an initial context refers to establishing the full or partial specification of a set of variables that can, but do not necessarily, influence the parameters of a newly initiated interaction. A transaction type may be selected or established from a predetermined set of transaction types (24), and a defined role may be established for each of the parties, each role defining bounds upon the communication activity of each party within the transaction (26). A state information repository, such as a database operatively coupled to the browser sessions of the pertinent involved parties, as described below in reference to FIG. 5, may be established and updated throughout a given transaction or group of transactions, the state information comprising a comparison between a current state of the transaction at a given time and a planned transaction pathway that is based at least in part upon the transaction type (28). In other words, given a planned transaction pathway (the way the transaction should flow), a comparison may be made with where the transaction actually is at a given time. All of this may be coordinated by a controller configured such that upon advancement of the state information from a first state to a second state, as defined by the planned transaction pathway, associated parties may be engaged through computerized user interfaces operatively coupled to the controller, such as by a web browser session (30).

Given such infrastructure, other elements may also be added. For example, referring again to FIG. 3A, the controller may be configured to characterize membership of a particular party as a member or one or more particular groups (32). The controller may also be configured to establish a set of tags (34). Further, the controller may be configured to specify, or allow an operator to specify, a delegate for one or more of the parties to the transaction (36).

Referring to FIGS. 3B and 3C, elements 20, 22, 24, 26, 28, and 30 are similar to those featured in FIG. 3A. As shown in FIG. 3B, the controller may be further configured to modify the parties to a transaction under a specified circumstance (38), to request information from a party to a transaction after the transaction reaches a state, such as a terminal state (40), or to specify at least one of the parties from a group of predetermined candidates (42). As shown in FIG. 3C, the controller may be further configured to display summary information regarding the communication transaction through a graphical user interface (44), to display information to a user generated at least in part based upon one or more transactions to which the user was not a party (46), or to automatically suggest values for one or more input fields in a current transaction (48).

To further illustrate such attributes of various embodiments of the inventive application, aspects of a typical business scenario are featured in FIGS. 4A to 4Z-13 as addressed with embodiments of the application. In this hypothetical but realistic scenario, a law firm is contacted and asked to represent one company in a possible acquisition of another company. The related seemingly simple set of communications is actually relatively complex, and with a conventional communications platform such as an email service, many emails will be generated in many inboxes of users, with little tracking of tasks and order that are necessary for the efficiency of the process and individuals involved therein.

Referring to FIG. 4A, a simple diagram illustrates that in this example scenario, Acme, Inc, an intended acquiring company (50), is interested in acquiring target company Delta, Inc. (52). Referring to FIG. 4B, a list of players in the business communication scenario is listed, including Charles Potter, the CEO of Acme (54); Richard (56), a partner at the law firm (BigLaw LLP) contacted by Acme to potentially handle the acquisition with Delta; John (58), the director of conflicts at the law firm; Robby Smith (60), a conflicts analyst at the law firm; Albert (62), a lawyer within the law firm; Bernard (64), another lawyer within the law firm; Carol (66), an expert consultant to the law firm; Darren (68), another lawyer within the law firm; Frances Parker (70), an assistant with the law firm; Fred (72), the CEO of the target company, Delta, Inc.; Edward (74), another lawyer within the law firm; and Greg (76), an additional lawyer within the law firm.

Referring to FIG. 4C, the exchange of communications between knowledge workers begins with Richard (56) sending a message to Charles (54) as a follow up to a telephone call, wherein Charles called Richard's firm and left a message asking if the firm could represent Charles and his company, Acme, in a possible acquisition of Delta. In a conventional scenario, Richard might go to a simple mail interface and send Charles an email, which could lead to many other associated but uncategorized and untracked messages regarding the process of determining whether the firm can represent Charles' company in this particular matter. In the depicted scenario, Richard accesses a main user interface view (86) generated using one embodiment of the subject system, wherein four main fields are depicted: an “action required” field (78), configured to display for a user tasks that are required of him personally that remain incomplete; an “open items” field (80), configured to display for the user tasks that are required of others that remain incomplete; a “new interaction” field (82), configured to allow the user to create a new communication interaction with another user; and an “all interactions” field (84), configured to display for the user information regarding all current interactions involving the user. Referring again to FIG. 4C, using the new interaction field (82), Richard has selected a button to send a new “Message” from a selection of predetermined communication types that may include a new “FYI”, a new “Ping”, or a new “Request”, and has typed in a new message to Charles regarding the possible engagement. The system may be configured to treat each of the selectable communication types as different (for example, in one embodiment, the Request type may be configured to require a response of the targeted receiver, while an FYI type may not; a Ping message type may be configured to require attention but no response; a Message may be configured to require attention and/or a response).

Referring to FIG. 4D, subsequent to dispatching the Message of FIG. 4C, the user interface (86) may be configured to display for Richard (56) that he now has an item in the Open Items field (80)—the message that he sent out to Charles—as well as an item in his All Interactions field (84)—the same message to Charles.

Referring to FIG. 4E, in the depicted embodiment, Charles receives the message from Richard and views it using a conventional email client interface, such as Microsoft Outlook®, due to Charles' lack of access to a system-connected interface such as that depicted in FIG. 4D for Richard's interaction (86). The mail client viewing interface (88) shows the text (90) of Richard's message, and in the depicted embodiment, also contains a field (92) featuring information regarding the communication system utilized by Richard (which may be named the “moduleQ” system) to generate the message and manage his communications and those of others in his law firm. In the depicted embodiment, certain key words and/or phrases are described in the field (92) to facilitate processing of the response from Charles as it is processed inbound back to Richard using the subject communication system. The content of the message from Richard says that the firm needs to do a conflicts check, and that Richard will get back to Charles as soon as this is finished.

Referring to FIG. 4F, before receiving a response to his outgoing message to Charles (54), Richard (56) utilizes the user interface (86) to create a new interaction (this time a Request requiring a response) with John (58), the conflicts director within the law firm, because Richard is going to need John's department to clear any conflict issues before Richard can engage Charles' company for the potential acquisition legal matter. Referring to FIG. 4G, after completing and sending the outbound request message to John, Richard's (56) user interface (86) may be updated to show that he has two items in the Open Items field (80)—one message out to Charles (54), one request out to John (58); these items are also displayed in the All Interactions field (84).

Referring to FIG. 4H, with a reply from Charles featuring the aforementioned key phrase “got it”, the system may be configured to close the previously “open” item from the Open Items field (80) in the user interface (86) as viewed by Richard (56), while continuing to display the item in the All Interactions field (84).

Referring to FIG. 4I, the system may be configured to allow Richard (56) to “Defer” the request to John (58) for a selected period of time, such as two days. This may allow Richard and/or John to conduct other research, attend to other matters, etc., and by selecting the deferral in the user interface, the previously “open” item from Richard's Open Items list (80) disappears, to return in two days. It does remain as an element of his All Interactions field (84) which may be easily accessed by clicking the item.

Referring to FIG. 4K, a different user interface view (94) for Richard (56) shows contacts of Richard's, which may be viewed in various groupings controllable by Richard. For example, in the depicted variation, Richard has configured the system to have a field grouping for Prospective Clients (96), Clients (98), and members of his law firm (100), and for the system to display these fields in his main user interface view (94) along with the Action Required field (78), the Open Items field (80), the New Interaction field (82), and the All Interactions field (84).

Referring to FIG. 4L, as a member of the firm, John (58) is utilizing the subject system and sees his main interface view (86) containing the Action Required (78) item from Richard (56), which also may be configured to show up in his All Interactions field (84). As the Director of the Conflicts Department, John (58) may decide to hand off or delegate the action to another person. Referring to FIG. 4M, John (58) may utilize the system to electronically manage a “hand off” of the conflicts analysis action from Richard to Robby Smith (60), a conflicts analyst in the firm, by creating a new communication interaction (82) and including a turnaround time requirement, such as 3 days turnaround, in the message content.

Referring to FIG. 4N, with the handoff communication dispatched by John, Richard may view an interaction feed view (106) of the user interface (102) to see that the action required of John has been handed off to Robby; this view also shows Richard's other messages in this interaction that are related to the two people shown in the Participants field (104). Such a configuration may be utilized to easily check the status of an ongoing interaction between a set of participants; further, such a configuration may be utilized to easily check the state of all ongoing interactions to which the user has access or in which the user is involved.

Referring to FIG. 4O, subsequent to the handoff using the system, John's (58) main view (86) shows that he still has the Action Required (78) from Richard (56), and that he has an Open Item (80) required of Robby (60)—the handed off conflicts analysis task. Each of the interactions is shown in the All Interactions field (84).

Referring to FIG. 4P, the main interface view (86) of Robby (60) is shown having one Action Required (78), the action handed off from John (58). As shown in FIG. 4P, Robby may select “Accept” and type in a quick message, such as “Sure thing”, to allow the system to monitor the process, and to provide John (58) with assurance that Robby is on the task and that there are no apparent problems.

Referring to FIG. 4Q, as soon as Robby (60) sends the “Accept” dispatch for the handoff from John (58) (i.e., as soon as Robby officially accepts responsibility from the perspective of the communications system), he becomes the designated responder for the request or action originated by Richard—and thus in his user interface view (86), he now has an Action Required (78) item directly connecting him to Richard (56); this is also shown in Robby's All Interactions field (84).

Referring to FIG. 4R, the acceptance of the handoff by Robby (60) clears the item from the Actions Required field (78) of John (58) in his user interface view (86); in this embodiment, the system is configured to still present the action in John's All Interactions field (84) where it may easily be accessed.

Referring to FIG. 4S, in this embodiment, the system is showing a user interface view of Robby's (60) main page, with the Action Required (78) from Richard (56), and a New Interaction “request” that Robby is creating to be sent that has three yes or no questions for his recipients (108). Referring to FIG. 4T, Robby dispatches the new request from FIG. 4S to four lawyers within the law firm (Albert 62, Bernard 64, Carol 66, Darren 68), asking each to reply with the answers regarding the conflicts analysis for the possible handling of the acquisition of Delta by Acme. Each of these new items shows up as a new Open Item (80) owed to Robby; they are also shown in Robby's (60) All Interactions field (84).

Referring to FIG. 4U, in the depicted embodiment, Robby (60) is sending another New Interaction message, this time an “FYI” not requiring a response, to John noting that he included Carol in the conflicts analysis dispatch, per the explicit request of John. Referring to FIG. 4V, subsequent to dispatch (i.e., by pressing the “send” software button in the user interface) of the FYI communication, this communication shows up as an element of Robby's (60) All Interactions field (84), but not his Open Items field (80), because no response is required for an FYI type of interaction, as dictated by this configuration of the system.

Referring to FIG. 4W, Robby (60) starts to receive responses to his requests, and these may be viewed together with his main user interface view (86), as shown, wherein the replies to the three questions from Albert (62) and Darren (68) have been returned by these users. In the depicted embodiment, the system may be configured to require that Robby (60) acknowledge each of the responses to complete the action cycle.

Referring to FIG. 4X, Richard (56), the originator of the investigation task, may conveniently receive an update regarding the Acme conflicts investigation matter by simply selecting the participants/feed view (102) of the user interface, and selecting the interaction of interest (here involving participants John 58 and Robby 60). In this interface view, he sees that Albert and Darren have already replied, as well as the content of their replies. Referring to FIG. 4Y, Richard may see in the user interface that Carol has not replied yet to Robby's (60) request, and may decide to directly and efficiently intervene by switching to a user interface view (110) also featuring a New Interaction field (82) so that he may quickly “Ping” Carol (66) directly with a message urging her to complete her response to Robby ASAP. The system may be configured to require an acknowledgement by Carol of a “Ping” type of interaction.

Referring to FIG. 4Z, in John's main interface view (86), he can look to the All Interactions field (84) generated by the system to see his interaction with Richard (56) along with the associated interactions with Robby (60), Albert (62), Bernard (64), Carol (66), and Darren (68).

Referring to FIG. 4Z-1, in one embodiment, the system may be integrated with an electronic voicemail system configured to use voice recognition processing to generate a textual transaction element within the system, as shown in FIG. 4Z-1 as an element in an Items to be Filed field (114) that may be utilized for incoming elements wherein operator input is needed for effective categorization. The system may be configured to provide a best guess categorization that the operator may simply confirm by clicking a software button, or may manually categorize with a manually-typed categorization, a user interface drag over to another appropriate element of the user interface, etc. Referring to FIG. 4Z-2, a voicemail has come in from Bernard (64), and John is shown selecting one of the system-based categorizations with a click (shown as an “X” next to “Request from Robby to Bernard RE Conflicts Check for . . . ”) as a “file under” categorization, and entering related text that results in a reply, as well as a New Interaction (in this case, a new Request for Frances 70 to schedule a meeting).

Referring to FIG. 4Z-3, one embodiment of John's user interface view (86) is depicted with the new Open Item (80) of getting Frances (70) to schedule the meeting. Further progress of this interaction is also shown in the All Interactions field (84) adjacent Bernard, who is involved in the Frances interaction.

Referring to FIG. 4Z-4, a user interface view (86) for Frances (70) is shown, with her Action Required field (78) element related to John (58). Frances is shown creating a New Interaction (82) with Richard and Bernard, which is a meeting request with time selections (108).

Referring to FIG. 4Z-5, after dispatching the meeting request, Frances may go to the participants/feed interface view (102) developed by the system to monitor responses from Richard and Bernard (116).

Referring to FIG. 4Z-6, John (58), the Conflicts Director, decides to speed things up by posting a draft conflicts waiver document, accessible by clicking a link to a remote storage system, to Bernard and Richard so they can reply and/or comment. John can see the status of this interaction by watching the participants/feed view of the user interface (102) generated by the system.

Referring to FIG. 4Z-7, with comments received from Richard and Bernard and an effective conclusion that the firm may take on the Acme acquisition matter if Delta signs the modified waiver document, John may send the waiver document to Fred (72), the CEO of Delta, by way of a New Interaction request interaction including the waiver, as shown in FIG. 4Z-7.

Referring to FIG. 4Z-8, a reply has come in from Fred in the affirmative (“John, this is not a problem. Let's proceed. Signed waiver attached.”) and the system may be configured to automatically match it with the parent interaction, and also import the attached document (the signed waiver) and make it available by a link.

Referring to FIG. 4Z-9, with Robby, the recipient of the handoff from John, on vacation, John intervenes to make sure that Richard receives the final affirmative response from his conflicts analysis team: that the conflict issue is all clear. In the embodiment shown in FIG. 4Z-9, Richard elects to receive and view the message using a conventional email system (i.e., as opposed to the subject system, which also is configured to receive this message); this user interface of the mail client is depicted with a field (90) having the message, and also a field including other valuable information and links (92) that are operatively coupled to the subject system and may be conveniently accessed from the conventional mail client interface (88).

Referring to FIG. 4Z-10, Richard is back at his computer (i.e., desktop, laptop, smartphone, or the like) and using the subject system for communications; his Action Required and Open Items fields (78, 80) are clear with the conflicts analysis done, and he creates a New Interaction (a “request” requiring a response) with Edward and Greg, two lawyer colleagues in the firm, to see if they have availability to work on the new matter for Acme.

Referring to FIG. 4Z-11, Richard (56) may use the participants/feed view of the system-generated user interface (102) to observe responses from Edward (74) and Greg (76), and to use the New Interaction field (82) functionality to send out additional communications, such as a handoff of a task, or a request about checking financials.

Referring to FIG. 4Z-12, in response to Richard's FYI transaction to Edward and Greg, Edward (74) messages with a return question visible in the Feed field (106) by Richard (56). Also visible is the handoff status of various items to Edward.

Referring to FIG. 4Z-13, going forward with the legal representation of Acme in the possible acquisition of Delta, Richard can use the participants/feed view of the user interface (102) to conveniently monitor the status of the work done by the particular participants, such as Edward (74) and Greg (76), and the Binder field (118) may be configured to contain links and/or attachments of pertinent related documents for easy access.

In one embodiment, attempting to establish an initial context for the transaction based upon electronically-mediated interactions to which the initiating party has access may involve scenarios such as one wherein a supervisor initiates a follow-on transaction to be pursued by one or more members of his team.

As briefly noted above, the subject electronic communication transactions may also be denoted as electronic “handshakes”—which, again, represent stateful, goal-oriented interactions such as questions, requests, or notifications requiring acknowledgement. Existing technologies for performing handshakes, including email and telephone, do not capture the structure of the interaction, so tracking and managing handshakes is left to individual workers. Workers waste large amounts of time monitoring and prioritizing pending handshakes, retrieving information about handshakes, and recreating repetitive handshakes. The subject configurations address these challenges with a cloud-based communication platform that organizes worker interactions into discrete handshakes with explicit structure and state. Rather than requiring workers to define interaction structure beforehand, the technology may be configured to allow interactions to unfold naturally and to work in the background to capture structure and state information as it emerges. The technology may be configured to use this information to provide fine-grained insight into how and by whom work is getting done, and where attention is required. The technology may be configured to automatically organize handshake information and provide a shared, consistent view to all participants, helping workers see the big picture and avoid information overload. Handshakes may be reused, increasing efficiency and facilitating standardization. In contrast to other structured communication tools, the subject technology may be configured to capture the microstructure of individual interactions as they occur and aggregate upward to provide high-level visibility and manageability. This contrasts with traditional process management tools such as those available under the tradenames Documentum® or Microsoft SharePoint®, which require detailed process definitions upfront, a costly and time-consuming exercise. The approach of the subject technology also differs from task and project management tools such as those available under the tradenames Microsoft Project®, Basecamp®, or Asana®, which provide a framework for defining the work to be done and reporting when tasks have been completed, but do not capture the interactions through which the work actually takes place. Since communication occurs outside of task and project management tools, these tools cannot help workers track and manage individual handshakes. By capturing handshake structure and content, the subject technology may be configured to deliver the transparency, manageability, and reusability associated with process automation while leaving workers in control and minimizing upfront costs. It may be configured to interoperate with and complement email, minimizing disruption to existing communication patterns. It may be configured to provide basic functionality free of charge to encourage a spread of the technology virally as workers interact with colleagues already using the platform. Additional functionality for managing handshakes across organizational units may be sold to organizations where workers have already adopted certain aspects of the subject technology. Handshakes are a central part of information work. For example, common handshakes include questions; notifications, confirmations, reminders, or handoffs requiring acknowledgement; and requests for comments, meetings, approvals, or decisions. The cost and inflexibility of traditional process automation technologies have limited their application, so many handshakes take place over email or telephone instead of within process management systems. Unfortunately, email and telephone are designed for transmitting one-off messages, not for managing complex interactions from start to finish, so information workers must track and manage large numbers of handshakes manually. The subject technology may be configured to automate handshake tracking and management, saving valuable time and enabling high quality decisions by giving workers and supervisors greater insight into their collaborative work; it may be configured to provide a platform for creating flexible handshakes that expand hierarchically to handle complex interactions between multiple workers. Handshakes capture structured information about an interaction including the roles of the participants (e.g., initiator, responder, observer), the state of the interaction (waiting for a response from a specific participant, overdue, complete, canceled, etc.), related information associated with the interaction (attached files, forms, links, etc.), and subsidiary interactions that must be completed first. By allowing the creation of subsidiary handshakes, the handshake enables emergent organization of arbitrary complexity. Encapsulating all communication within structured handshakes enables automated tracking and aggregation, as well as facilitating reuse of handshakes that occur frequently. Other social media platforms provide structured communication tools for sharing information with friends (Facebook®), sharing professional information with colleagues (LinkedIn®), and assigning clearly-defined tasks to collaborators (Asana®), but no extant technologies provide a platform for creating and managing flexible handshakes of unlimited complexity. To a substantial degree, organizational activity consists of communication patterns that can be modeled naturally and flexibly as hierarchically nested clusters of goal-oriented handshakes. For example, one worker may notify a second worker that a new piece of equipment is needed. The second worker may ask a third to investigate possible vendors for the equipment. The third may ask some clarifying questions of the second before providing the requested information. Then the second worker may ask for comments and/or approval from several other workers before asking yet another worker to purchase the selected equipment. Using email or other conventional project or task management technologies, it is very difficult for a user to maintain a picture of these handshakes as they unfold that is current, concise, and comprehensive. A technology that captures handshakes in the background, without requiring up-front specification of the process or even the specific tasks to be done, such as the subject technology, can provide visibility and manageability without impeding the ability of information workers to get things done through ad hoc communication with coworkers.

The subject technology can be configured to increase the productivity of information workers by streamlining handshake management and facilitating complex interactions. At the same time, the technology can generate detailed data about the content of information work that will enable new technologies and management techniques. For example, managers can utilize the subject technology to visualize and monitor white collar work in real time, evaluate employee performance objectively, spot problems and bottlenecks quickly, and, when necessary, drill down into the details of specific transactions or decisions. By analyzing patterns in handshake data, associated artificial intelligence systems or subsystems may be configured to make suggestions about whom to involve in a decision or what information might be relevant to a question. Such systems may be configured to detect unusual or unexpected activity patterns and report them to workers and managers. If the past few decades are any guide, more effective integration of humans and computers should yield organizations that are more productive and intelligent.

In accordance with aspects of the present invention, an object-oriented database or databases may be used instead of an SQL database or databases to simplify the architecture and increase flexibility. Handshake clusters may be reused in a way that preserves a handshake structure but also maintains flexibility. Worker relationships with other workers and with organizations may be modeled in a manner that enables fine-grained security controls and management of information sharing. An intuitive user interface may be presented to users and utilized to require a minimum of training, and places as little burden on the user as possible, where user interface burden is measured in terms of the amount of information visible and the number of options available at any given point, and the number of interactions required to perform a given action or access given information. Integration configurations may enable interoperation with as little user interface overhead as possible. The system may comprise a highly scalable and evolvable backend architecture based upon information assembly line principles that can handle large numbers of handshakes and users.

The system may comprise (1) a service accessible over a computer network such as the Internet or a corporate intranet, (2) client applications that enable users to interact with the service, and (3) additional interface components that integrate the service with other applications such as email clients, calendars, contact managers, corporate identity servers, enterprise IT systems, and other social media. The service preferably enables users to perform a variety of activities relevant to the initiation and management of handshakes. These functions include user account management, handshake management, coworker relationship management, organization management, and app management. The service may comprise a gateway service that accepts requests from client applications and a cluster of backend services that handle the functions identified above. The Gateway Service may be configured to accept requests from client applications in the form of structured forms encoded electronically using a standard protocol such as JSON. Client applications may communicate with the Gateway Service over a computer network such as the public Internet or a private intranet. The Gateway Service may be implemented as a Django or Pylons application that integrates with a standard web server using the Web Server Gateway Interface.

When the Gateway Service receives a request, it may be configured to create a hierarchical data structure called a “pallet” that is used to encapsulate the request, the (as-yet-incomplete) response to the client application, and routing information that specifies the sequence of services to which the pallet will be routed in order to complete the response. Then, the Gateway Service may be configured to route the pallet to the backend services according to the routing information. Routing to backend services may be serial or parallel depending on the structure of interdependencies among the backend services and latency concerns.

The backend services may be configured to receive pallets from the Gateway Service, modify the contents of the pallets as appropriate, and return the pallets to the Gateway Service for further processing. The backend services may be implemented as servers using a language such as Python and a protocol such as XML-RPC. Pallets may be transmitted to and from the backend servers using a standard encoding such as JSON or XML. The core backend services may be as follows.

A Roles Services module may be configured to handle user account management: registration of new people and roles, and the maintenance of people and roles databases. The databases may be object databases using a technology such as ZODB or standard SQL databases. The Roles Service also may be configured to handle authentication of users who attempt to access the service by checking credentials against those stored in databases and issuing challenges when appropriate. In one embodiment, organizations can, through the Organizations Service (see below) configure the Roles Service to use a corporate identity service such as Open Directory or LDAP for authentication of users attempting to access the service as an agent of the organization.

People may interact with the system in multiple roles (e.g., in a personal capacity and as an employee of an organization), so the system supports multiple roles for each person. Permissions and privileges may be managed for both people and roles. The Roles Service also may be configured to handle modification of account information and account termination. The Roles Service may be configured to maintain indices of the handshakes, apps, coworker relationships, and organization memberships associated with each role.

A Handshake Service may be configured to handle the creation of new handshakes and retrieval or modification of existing handshakes. The service may be configured to support retrieval of single handshakes or groups of handshakes based on some selection criteria (e.g., all handshakes having a given person as a participant or including a given keyword). Handshakes may be retrieved in the form of compact summaries (header form) or retrieved in full. Handshakes may be retrieved together with all child handshakes in full or in header form.

Handshakes may be modeled as data structures that include information about the participants, state, related information and related handshakes. More detailed information about each component of the handshake data structure follows below.

As described above, a handshake may be a structured interaction between two or more participants, who may or may not be registered users. These participants may participate in the handshake in a role (e.g., as an agent of an organization). Participants also have one or more roles relative to the handshake (handshake roles) such as owner, administrator, handler, initiator, observer, or responder. The system may be configured such that permissions of a participant with respect to a handshake may depend on the role of the participant with respect to the handshake. The Handshake Service may be configured to support the additional and removal of participants.

Retrieval and modification of handshakes may be restricted by the service based on the role of the user. The system may be configured such that a person who is the owner or administer of a handshake, or the supervisor of such a person, can retrieve and modify the handshake without limit. Other handshake roles may have more limited privileges.

The system may be configured such that a handshake models a finite state machine that progresses from an initial state to one of two terminal states (complete or canceled). States may model whether the handshake has been viewed, whether a response is required, whether a response has been received, etc. Additionally, a handshake may have a due date and may be overdue. The ownership of a handshake, which may be assigned to a participant or to an organization, may also considered to be part of the handshake's state.

The handshake also may have a type, which may be a generic handshake of one of several built-in types, or it may be a custom type that may be handled by another service with an appropriate API. The service may be configured to keep track of custom types and services used to handle them.

The Handshake Service may be configured to support modification of state parameters such as the due date, and update handshake state as appropriate when a handshake changes (e.g., when a client informs the service that a handshake has been viewed).

Handshakes may include two collections of related information: a log recording actions taken by participants (the Feed) and a hierarchical data structure (the Binder) containing information (links, files, forms, etc.) that participants have added to the handshake.

The Handshake Service may be configured to update the Feed as necessary when users take actions relative to a handshake (e.g., send a message, post information or initiate or modify a child handshake). Certain kinds of child handshakes may provide summaries for inclusion in the Feed, such as questions, FYIs, and pings. The Handshake Service also may update the Binder when users add information or initiate or modify child handshakes that provide summaries for inclusion in the Binder. Users may organize information in the binder by creating sections (which can be nested without limit) and moving information into these sections.

The system may be configured such that a handshake can be initiated within the context of another handshake, creating a parent-child relationship where the new handshake is a child. The child handshake may affect the parent handshake, e.g., by adding participants, changing the due date, or adding content to the Feed or the Binder.

Child handshakes may be represented in the handshake data structure by including references to the handshakes that are the parent or the children of the handshake. When retrieving a handshake, the Handshake Manager may be configured to examine the handshake's child handshakes and incorporate information about these child handshakes as appropriate in the Feed and the Binder.

Several types of handshakes may be defined by the Handshake Manager, and APIs may be configured to allow for definition and custom handling of other handshake types. The system may be configured such that handshake types defined by the Handshake Manager include:
Generic Handshake: A handshake that consists of an unstructured message requiring an unstructured response.
Meeting Request: Schedule a meeting about the parent handshake, inviting participant(s) in the parent handshake and, optionally, other people, where the response to the handshake is a comment, RSVP, or request to reschedule.
Meeting Notes: Record notes about the items covered at a meeting, where the response is a request to modify the notes or approval of the notes. The system may automatically prompt the initiator of a meeting request handshake to initiate a Meeting Notes handshake after the meeting's scheduled completion time.
Collect structured information: collect information using a customizable, hierarchically structured form, from participants in the parent handshake or other people.
FYI: Enter a message that allows other participants to acknowledge receipt of the message and display a list of participants who have acknowledged receipt.
Ping: Enter a message that calls attention of participants to an existing handshake or an element (information or child handshake) within it and require acknowledgement of receipt, and display a list of participants who have not yet acknowledged receipt.
Approval Request: Send a message, in one embodiment referring to a child handshake or other element, asking for explicit approval, which requires responder(s) to answer yes, no, or request changes, and displays the result.
Comment Request: Ask for comments, in one embodiment referring to a child handshake or other element.
Selection Request: Ask for a selection from multiple choices and include the results in the handshake.
Question: Ask question about handshake or elements in it and associate answer with handshake
Handoff: Transfer one's own role in handshake to another person fully or leaving self as an observer, temporarily or permanently (handoff)

The system may be configured to allow users to establish relationships with coworkers in order to streamline the initiation and management of handshakes with them. A Coworkers Service may be configured to handle creation of new relationships, retrieval of relationships, and modification or deletion of relationships. A relationship may be modeled as a data structure that stores the two parties to the relationship, the roles, if any, in which they are engaging in the relationship, and meta data about the relationship such as its creation date, the type of relationship (e.g., coworker, client, supervisor-subordinate) and its context (e.g., the organization where the people are coworkers).

The system may be configured such that initiating a relationship requires that one person request the relationship with a second person and that the second person approve the relationship. This may be handled as a handshake using APIs exposed by the Handshake Service for creating, representing, and modifying handshakes.

An Organizations Service may allow representatives of organizations to register the organization, specify which users are members of the organization, and define the roles of these people with respect to the organization. Subsequently, organization membership may be used to determine permissions and privileges of users with respect to handshakes associated with the organization. Organizations may be modeled as data structures that include information about the organization's registration with the service, its representatives, and the set of organization members.

The system may be configured such that the Organizations Service handles registration of organizations and modification of account information. In some cases, modifications may be handshakes requiring approval by other organization representatives; these may be handled using custom handshake types through the Handshakes Service APIs.

The Organizations Service also may allow the registration of sub-organizations such as divisions, business units, committees, or teams within other organizations. This may be modeled using parent-child references in the organization records. An existing organization may become a child of an existing organization through a custom handshake between representatives of the two organizations.

An Apps Service may be configured to handle Apps (applications) that allow users to create handshakes of specified types. An App may be internal or external. Internal Apps may comprise a data structure containing a template defining the structure of the handshakes created from the app and meta data defining who can use the app, characteristics of handshakes created by the app such as service level guarantees, and information (or references to information) about past use of the app including feedback on the performance of the app from users. The app may also specify the ownership of handshakes that it creates, participants in the handshake, and constraints on transfers or ownership or addition of participants (e.g., only participants belonging to a specified organization can be added to the handshake.

External apps may comprise a data structure similar to the data structure for an internal handshake except that, instead of a handshake template, the data structure may specify the interface to a service that will provide, on demand, a handshake data structure. The Apps Service may implement APIs that allow providers of external apps to access and modify, subject to constraints, the meta data associated with the app.

The system may be configured such that client applications (clients) enable users to access the Service and perform the activities handled by the various system components described above. Clients may include HTML-based web sites, JavaScript applications that run in a web browser, applications for personal computers running operating systems such as Microsoft Windows® or Mac OS®, or apps for mobile devices running operating systems such as iOS or Android. A client may enable a person to log in and modify account settings; initiate, view and manipulate handshakes; form coworker relationships and view information about coworkers; establish and modify organization memberships; and create or configure apps.

The client may be configured to issue requests to the service using a protocol such as HTML. The requests may be structured as forms encoded using a standard such as JSON and containing the information necessary to handle the request.

In order to make the initiation and management of handshakes as efficient as possible, the system may comprise interface components that connect the system to individual and enterprise applications.

Interface components that connect the system to individual applications may include email connectors, calendar connectors, address book connectors, and cloud-based document connectors.

The system may be configured such that email connectors allow users to initiate handshakes or child handshakes from incoming or outgoing email messages or associate incoming or outgoing email messages with existing transactions.

An email connector may be a server-side component that receives emails copied to an address specific to the user and creates a new handshake with the email body in the feed, attachments to the message (if any) in the binder, and the sender and recipients as the handshake participants.

A more sophisticated email connector may comprise a component that plugs in to an email client (an email plug-in). The email plug-in may allow a user to select an incoming or outgoing email message and turn it into a handshake. The plug-in may allow the user to select the type of handshake to create (e.g., a Question, Meeting request, or Ping) and to enter additional information associated with the handshake such as target completion date, other participants, or parameters specific to the handshake type (e.g., possible meeting times or a specific question). The plug-in may allow a user to create handshakes from recently sent messages.

The plug-in also may allow a user to initiate the handshake as a child of an existing handshake or simply associate the message with an existing handshake as a piece of relevant information.

The service may comprise a server-side component that inserts meetings scheduled using a meeting request handshake into a user's calendar. A plug-in for a calendar application may also be included that allows users to view information about a handshake (and its child handshakes) associated with a meeting or to associate a calendar appointment with a meeting.

The service may comprise a server-side component that imports data from a users contact manager or a corporate directory server in order to identify possible coworkers or transaction participants.

The service may comprise one or more server-side components that enable posting into handshake documents stored in the cloud in services with externally accessible APIs. If these APIs permit accessing metadata about or content of the documents, the components may generate summaries describing the documents and provide them to the Handshakes Manager for incorporation into the Binder.

One target market for the subject technology is the information worker who currently uses email intensively for handshakes with coworkers, and the companies that employ these workers. One customer may be a professional who collaborates with several groups of coworkers on a number of projects at any given time. Examples include lawyers, consultants, investment bankers, project managers, mid-level executives, and financial advisors. The continuing trend toward project-oriented organizations means that traditional white-color jobs increasingly fit one or more customer profiles.

These workers often struggle with several serious problems arising from the limitations of traditional communication tools:

Fragmented communication. In a conventional paradigm, information regarding a given interaction may be spread across multiple messages in email accounts belonging to different people, attachments, shared files, etc. There may be nowhere to go for a comprehensive record of the interaction. This decreases the quality of decision-making, which depends on access to current, complete, well-organized information.

Lack of visibility. With conventional technologies, workers generally cannot see the state of pending interactions with coworkers, or of related interactions between coworkers and other people. As a result, workers generally must try to keep track of pending interactions themselves using task lists or email flags, and then send follow-up messages or schedule meetings to receive updates on the state of pending interactions. Managers may struggle to monitor process performance, detect bottlenecks, and evaluate workers objectively.

Time wasted onboarding coworkers. With conventional tools, when a coworker is brought into an existing interaction, he or she must be provided with the relevant context: background information, other participants, related activities and pending interactions, etc. This often requires time-consuming meetings and considerable effort on the part of the new coworker.

Inability to store and reuse interaction patterns. In a conventional paradigm, although worker interactions are highly varied, there tend to be patterns. Using email or telephone, however, these patterns are difficult to capture and reuse. Thus, workers end up wasting time reinventing the wheel, or searching for and copying and pasting from old emails.

In one embodiment, centralized management functionalities may comprise:
automated management of organization membership, roles, and access to self-service modules
automated maintenance of aspects of organizational control over handshakes, interaction templates, and data
automated summarizing of activity by group or process, with configurations facilitating drill down to specific handshakes
capabilities for assignment of staff to handle handshakes originating from self-service modules

Referring to FIG. 5, one embodiment of a system implementation is depicted, wherein a plurality of computing systems (120, 122, 124, 126) local to one or more operators are used to operate web browser sessions (128, 130, 132, 134) to access a remote server (138) through the internet (136) and/or other networks, to provide a local user with a web service or web-based application configured to provide the functionality as described above. The server (138) preferably is operatively coupled to a database or information repository. The computing systems may be personal computers of various types (i.e., desktop computers, laptop computers), tablet computers, mobile computing devices such as smartphones, and the like, each of which generally comprises a local processor, controller, or microcontroller that may be configured to operate web browser software, such as that available under the tradenames Internet Explorer®, Google Chrome®, and FireFox®, to remotely interact with the server (138) via the web browser sessions (128, 130, 132, 134). In other embodiments, one local computing system may be utilized to operate multiple browser sessions to connect with the server (138). In one embodiment the web service may comprise JavaScript® built using a JavaScript application framework such as AngularJS®. It may be configured to be a one-page application in the browser session (128, 130, 132, 134) that is configured to exchange JSON (JavaScript Object Notation—a lightweight text-based open standard designed for human-readable data interchange) objects with the server (138) using, for example, a Restful API configuration (representational state transfer, or “REST”, is a style of software architecture for distributed media systems such as the Internet; conforming to “REST” constraints is referred to in computer science as being “restful”), so that packets of information in the form of JSON objects may be passed and interpreted (i.e., as opposed to transferring fully-rendered HTML pages from the server) by the application in the browser. The server-based back end may be built using Python (a general purpose high-level programming language), and a web framework such as Django®, Flask®, or Ruby on Rails®. Thus requests for a given URL from a browser session may be received by a web server (such as Apache®), then passed through a WSGI (web server gateway interface) interface to the application, where the URL may be parsed and routed to an appropriate controller.

In one embodiment, to support “offline” use (i.e., when connectivity to the remote server 138 has been interrupted), the application may be set up to have some caching in the browser (with HTML 5, “local data store” may be utilized). In another embodiment, a plug in for a mail client, such as Microsoft Outlook® may be installed locally on an operator's computing system to assist with seamless back and forth between such mail client and the subject web service configuration (i.e., in one embodiment, it is the intention to have the web service completely in sync with an email system such as Outlook, such that a request in the web service will be seen (or optionally not seen) as an email message in the mail client). As graphical user interface “sidebar” may be created with the mail client plug in to show the content of the interaction, links to jump to one or more related email messages, related calendar items, and the like.

In one embodiment, the data repository operatively coupled to the server (138) may comprise one or multiple databases configured to store different subsets of the information. For example, key recent interaction data may be stored in a more readily-available configuration than older data, wherein it may be perfectly acceptable to have higher latency in retrieval. The server and associated data repository may be located on the other side of a firewall from a corporate computing infrastructure, or may be within the firewall, such as in a “virtual machine” configuration that runs on any kind of server (Windows®, Linux®, etc) that encapsulates the entire corporate communication system behind the corporate firewall for security or other purposes.

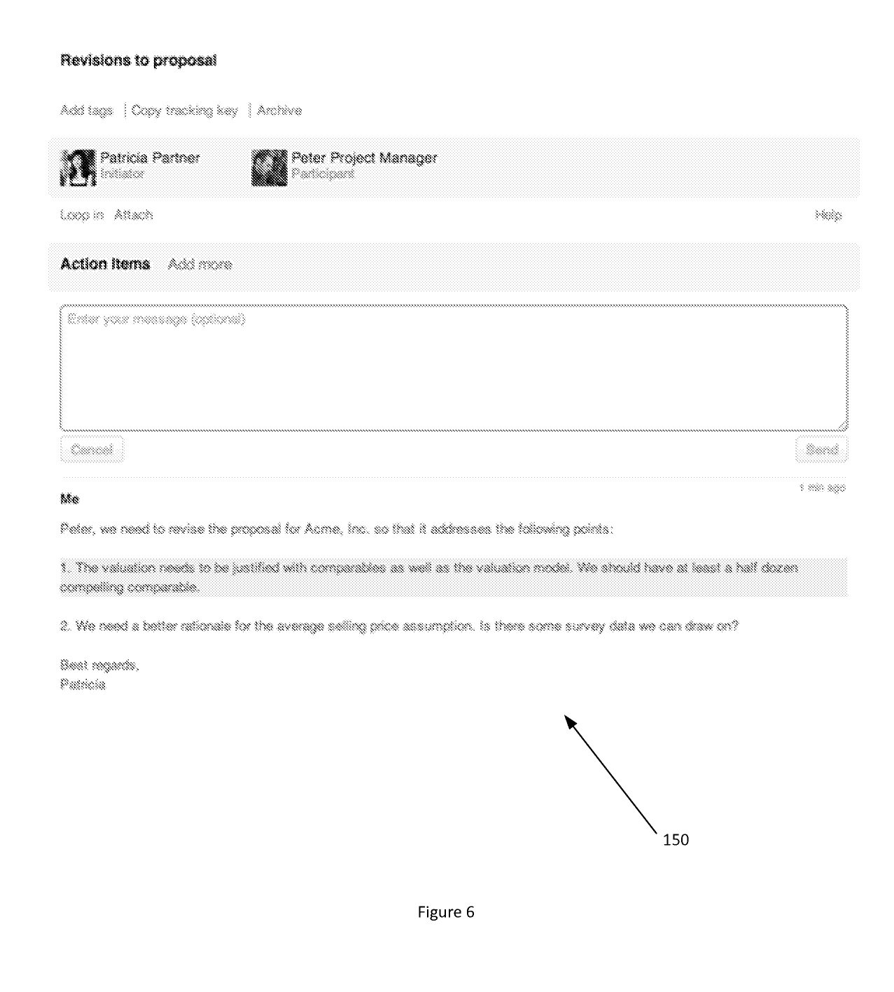

Referring to FIGS. 6-12, standalone embodiments comprise messaging tools capable of operating independently of other messaging tools, such as an application program installed on a personal computer running an operating system such as Microsoft Windows®, Mac OS®, or Linux®; an app installed on a smartphone or tablet computer running an operating system such as iOS®, Microsoft Windows®, or Android®; or Internet content accessed using a web browser such as Google Chrome®, Apple Safari®, Mozilla Firefox®, or Microsoft Internet Explorer®.

In one embodiment, a person uses the messaging tool to view a message. FIG. 6 illustrates a user interface depiction (150) of a message without any associated Action Items.

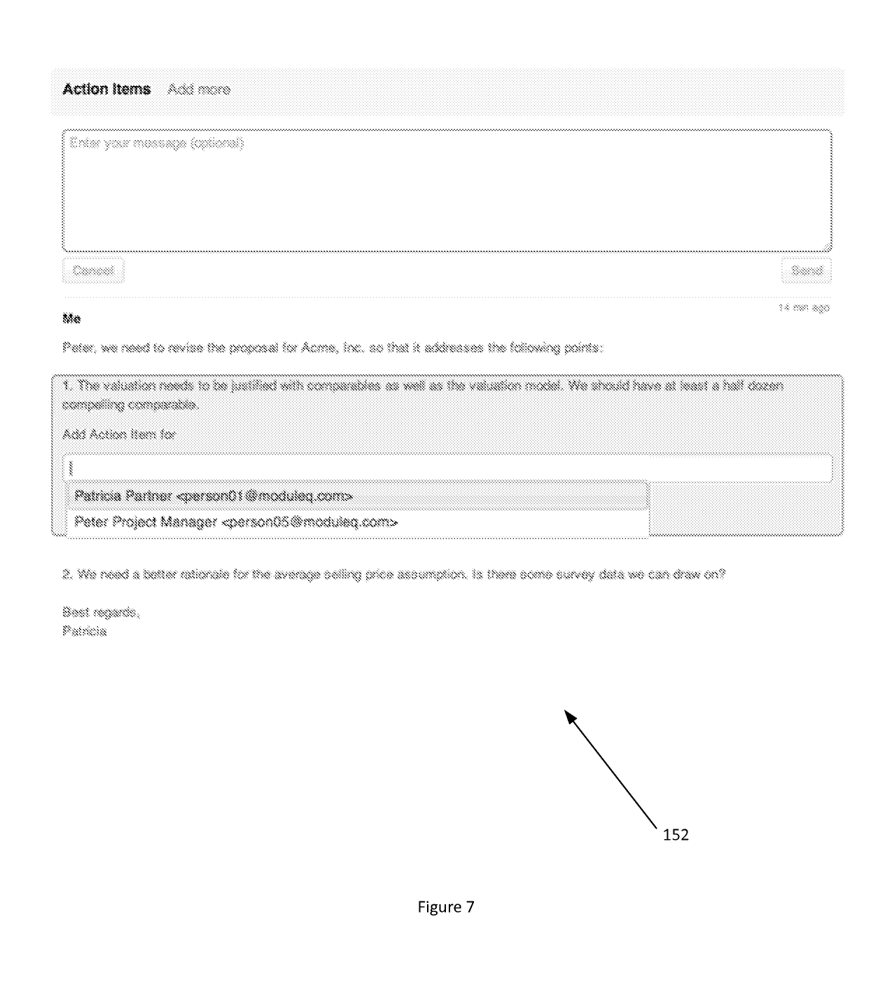

As shown in FIG. 7, user selects a part of the message (FIG. 2 depicts message 152 with a paragraph selected), illustrating the case when the part of the message is a single paragraph, but the part of the message may comprise one or more subsets of the message content. In this embodiment, the user is presented with an input area where the Action Item recipients can be specified, and with a list of possible recipients including the sender and recipient of the message.

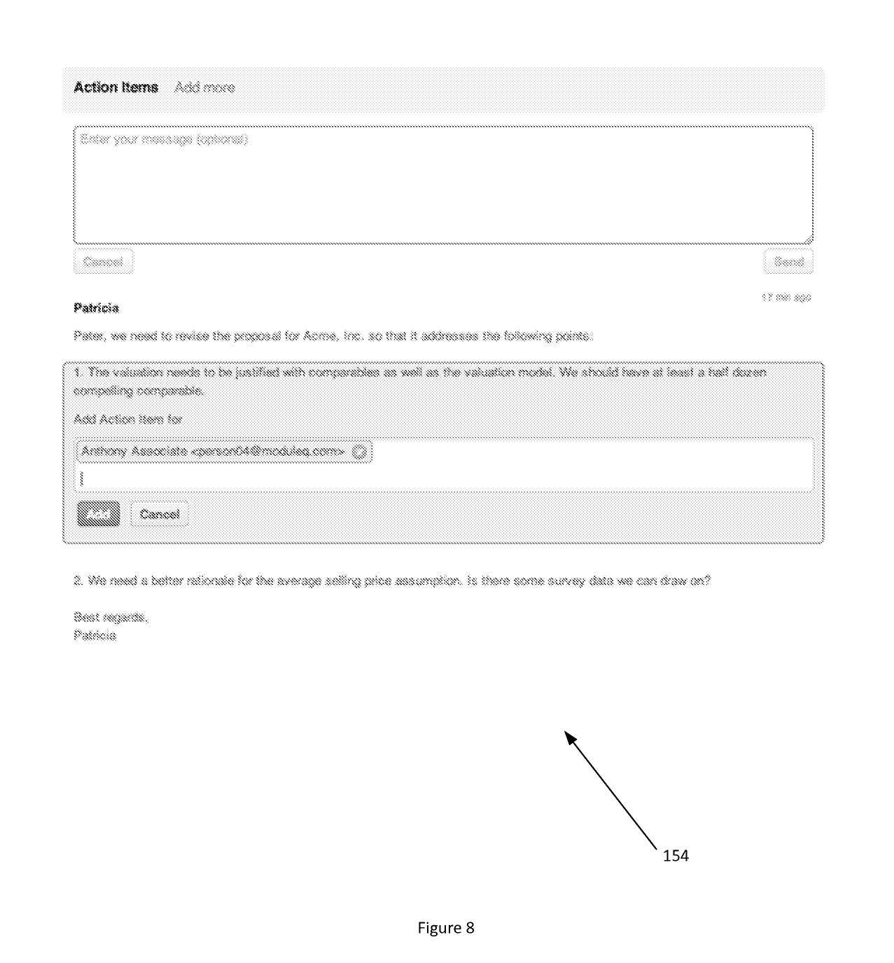

The user may specify a recipient for the Action Item. FIG. 8 illustrates a user interface depiction (154) wherein a message with a paragraph selected and an Action Item recipient specified. In this embodiment, clicking the Add button begins the process of creating the Action Item.

The user may be presented with a draft Action Item and an area where a custom notification message for the recipient can be entered. FIG. 9 illustrates a user interface depiction (156) wherein the draft Action Item is displayed, including the creator (me), the recipient (Anthony Associate), a link to specify a complete by date, a checkbox to specify that the creator should be prompted for confirmation, an excerpt of the message part referenced by the item, and quick comments that may be specified as the notification content.

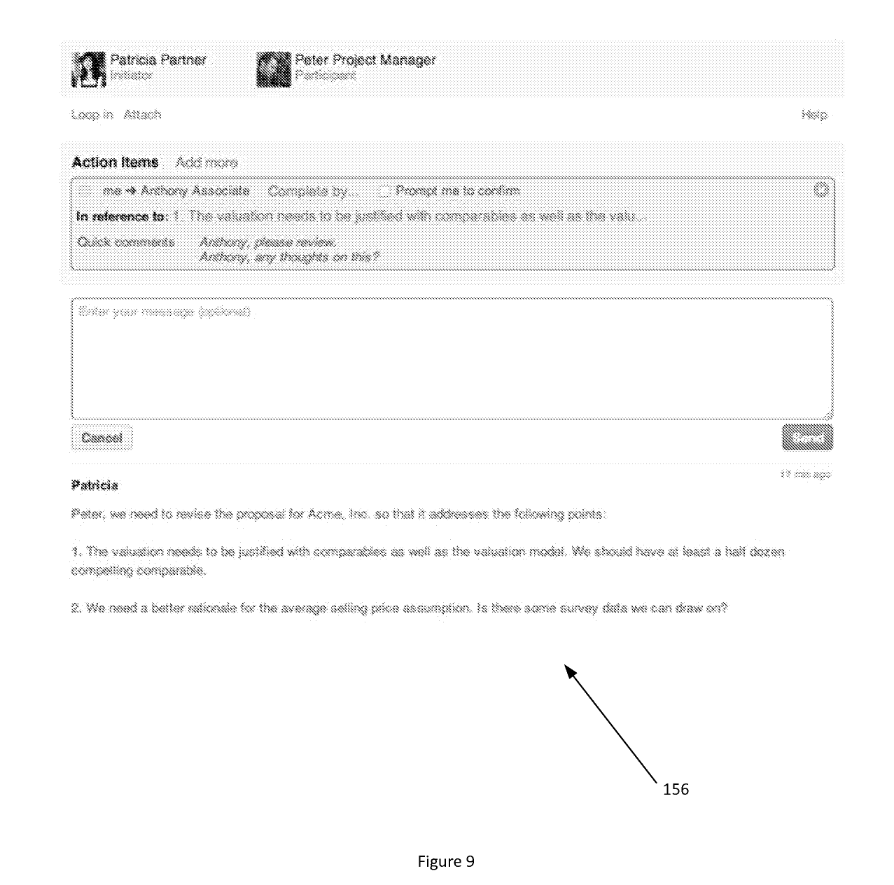

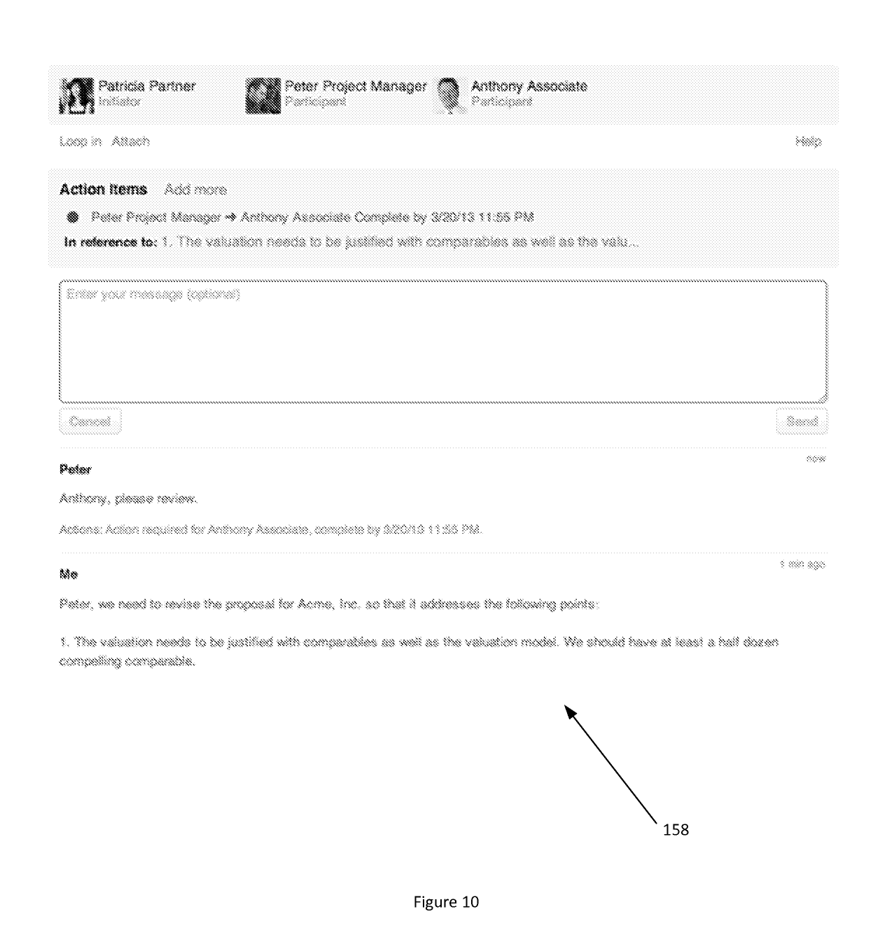

A user who views the message is presented with a representation of the Action Item indicating the referenced message part, the recipient, and the Action Item state. FIG. 10 illustrates a user interface depiction (158) wherein user who views the message is presented with a representation of the Action Item. In this embodiment, the recipient (Anthony Associate) is automatically granted access to the message and a notification message is grouped with the original message. In this embodiment, the incomplete state of the Action Item is indicated by a dark/shaded circle.

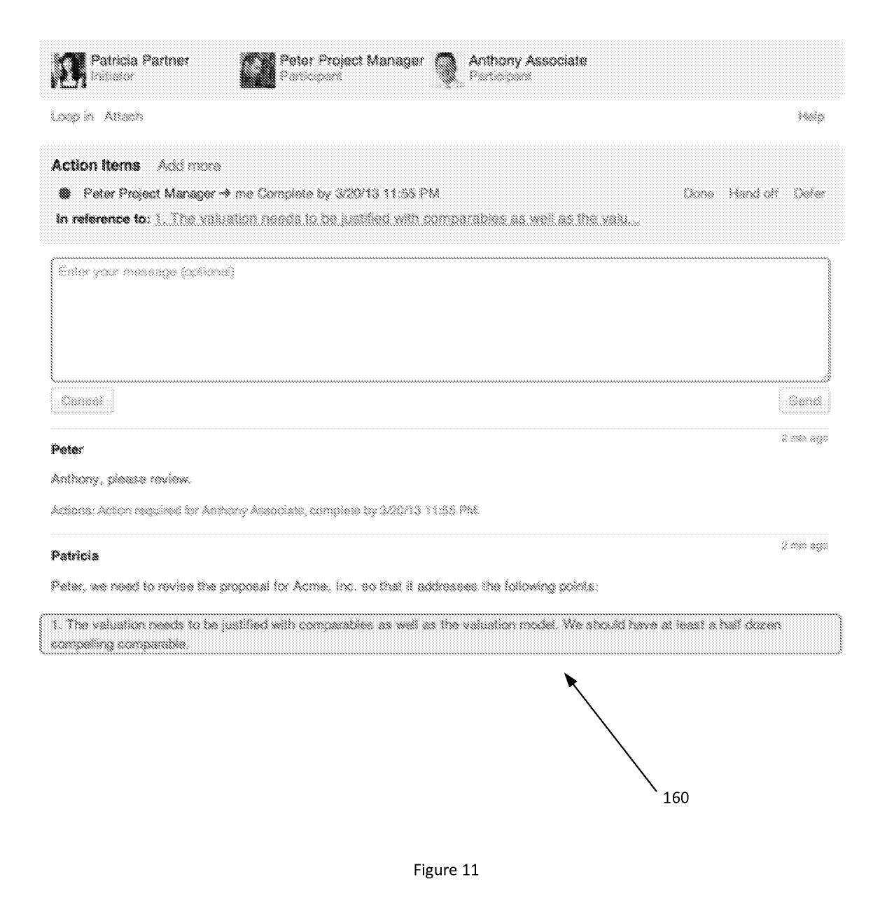

In some embodiments, visual indicators may be used to indicate the message part referenced by an Action Item. FIG. 11 illustrates a user interface depiction (160) wherein the referenced message part may be indicated visually. In this embodiment, hovering over or clicking the text following “In reference to:” causes the referenced message part to be highlighted.

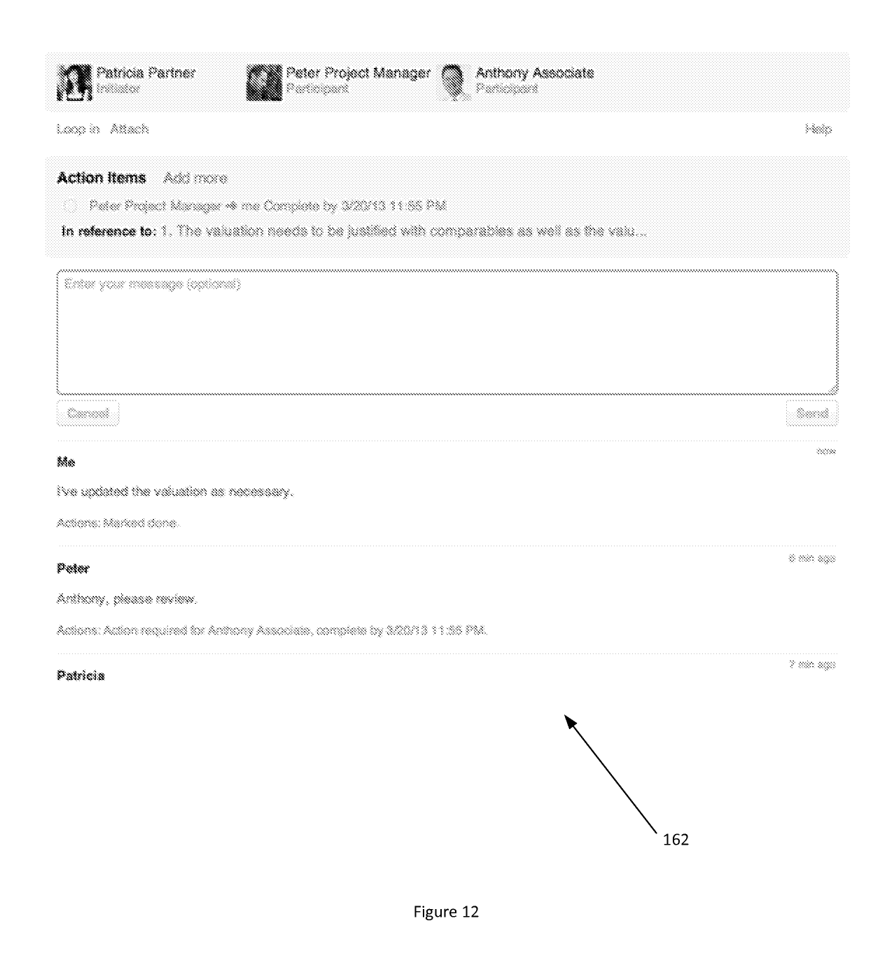

The recipient responds by completing the action and marking the Action Item done. All users who view the message see that the Action Item was done. FIG. 12 illustrates a user interface depiction (162) wherein the Action Item has been marked done. This change in the state information of the Action Item is displayed to any user who accesses the message. In this embodiment, the completion is indicated by the empty, light-gray circle and the gray text. Also, in this embodiment, a customizable notification is sent to the users with access to the message and is grouped with the original message.

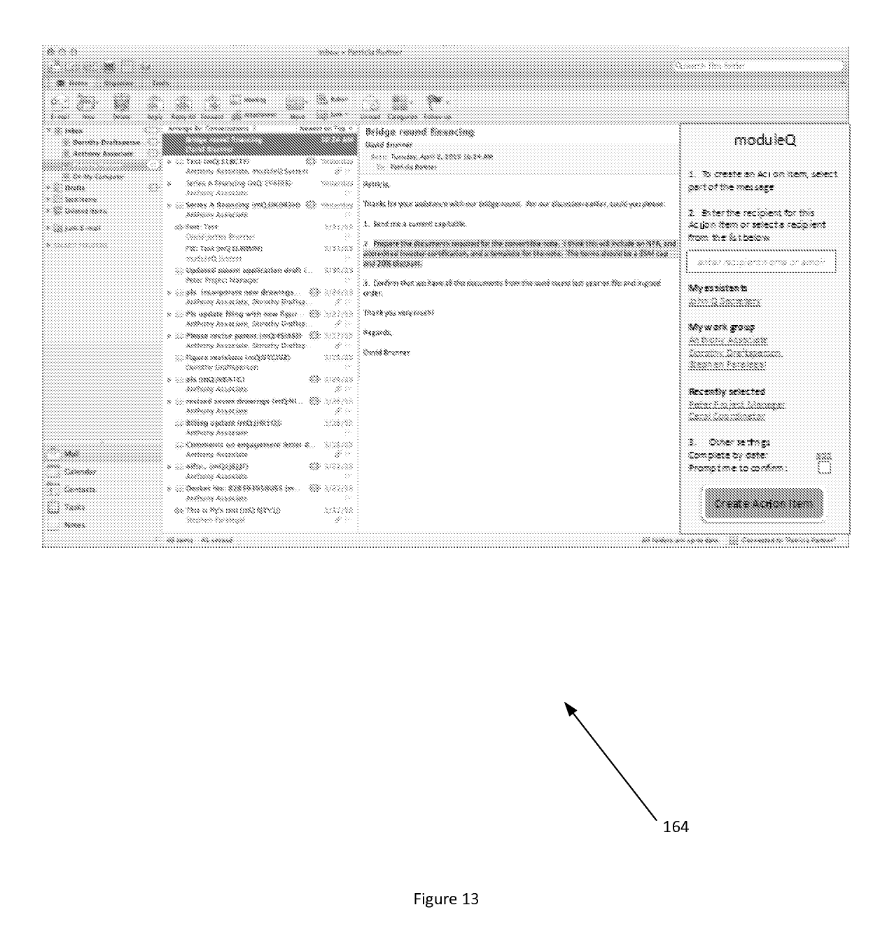

Referring to FIG. 13, a messaging application plug-in embodiment is described. This embodiment comprises a software component, referred to below as the Plug-in, that connects to a messaging tool such as an email client (e.g., Microsoft Outlook®, Apple Mail®, Google Gmail®, the email app on Apple iOS®, the email app on Google Android®, the email app on BlackBerry® devices, other email applications such as Mailbox®), an online messaging tool (e.g., Salesforce.com Chatter®, Microsoft Lync®, Yammer®, Jive®, LinkedIn®, Facebook®, Google+®), a project management tool (e.g., 37 Signals Basecamp®, Asana®), a document management tool with messaging functionality (e.g., DropBox®, Google Drive®).

In this embodiment, a person views a message or message thread in the connected messaging tool and selects a part of the text with an input device such as a pointing device, keyboard, or touchscreen. The Plug-in allows the user to specify the recipient of the Action Item by performing an action such as typing the name in a text input or selecting from a list of possible recipients. Possible recipients may be automatically suggested based on prior actions of the user, characteristics of the message (e.g., people copied on the message), and the users relationships with other people (e.g., assistants, work groups, managers, subordinates). The Plug-in may also allow the user to specify additional parameters about the Action Item, such as a complete-by date and whether to confirm completion with the creator of the Action Item. FIG. 13 illustrates a user interface depiction (164) featuring a Plug-in embodiment connected to Microsoft Outlook.

When the Action Item has been created, the Plug-in communicates the Action Item to the recipient. This may occur by sending a message through the connected messaging tool. This message may include content provided by the user before, during, or after the creation of the Action Item. This message may include information about how to view and update the Action Item by installing a Plug-in or accessing a web site.

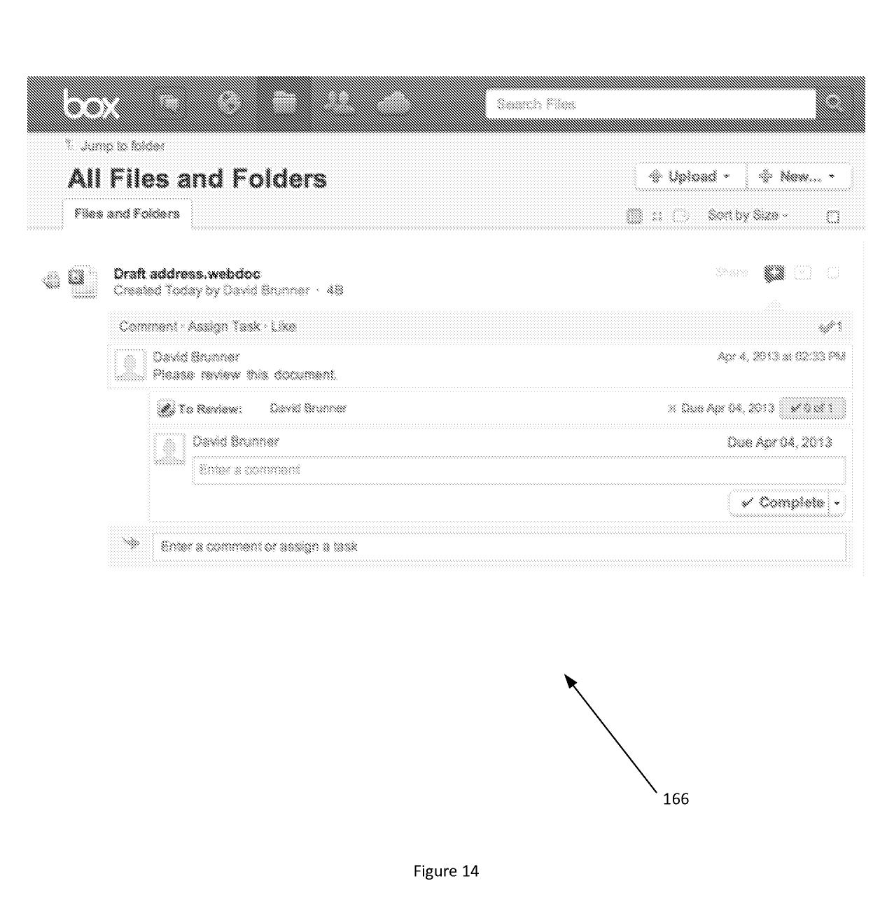

Referring to FIGS. 14-18, embodiments are described that are pertinent to extension for online document repositories.

In one such embodiment, the invention is integrated into a document management application such as Box®, Google Drive®, or Microsoft Office 365® that allow users to send messages about documents or post comments and replies in documents.

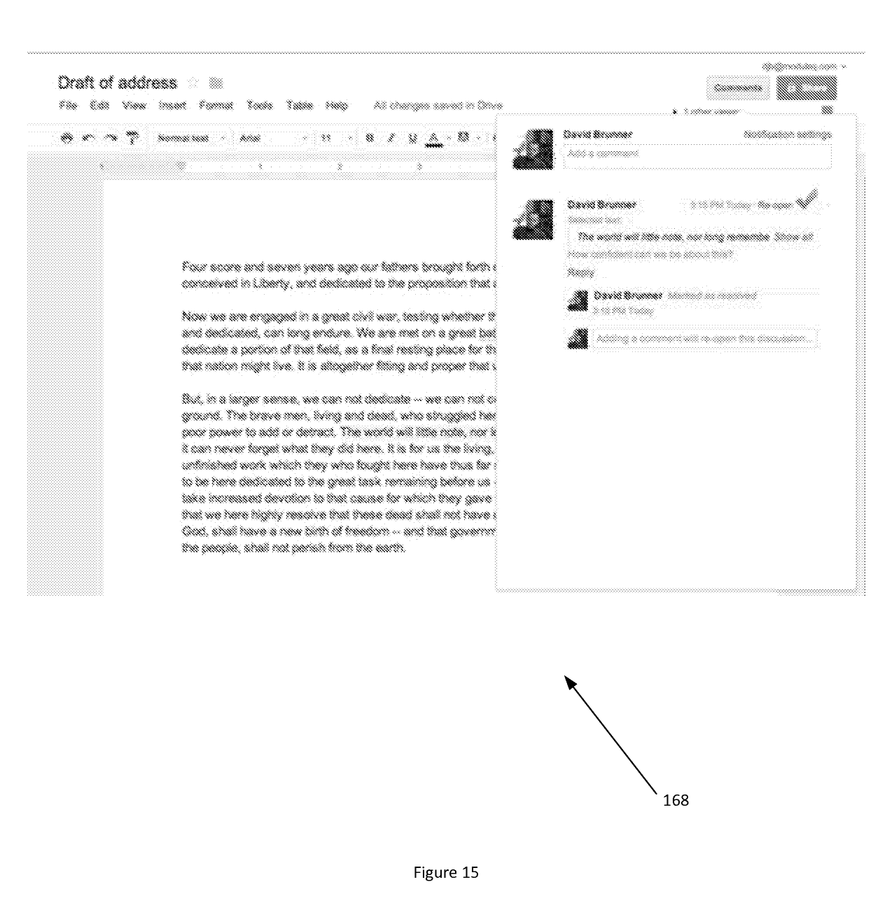

The current state of the art is illustrated by Box®(FIG. 14 illustrates a user interface depiction 166 regarding messages about a document in Box®) and Google Drive®(FIG. 15 illustrates a user interface depiction 168 regarding messages about a document in Google Drive®). Box® allows the creation of tasks that reference a document and specify a person to complete the task. Google Drive® allows the creation of tasks that reference a particular part of a document. The current state of the art does not allow for creation of Action Items that reference a part of a message associated with the document.

By integrating the invention into an online document repository, it becomes possible for a person who accesses the document and those messages referencing the document to create an Action Item that references a part of a message. This is often desirable for collaborative work on complex documents which may involve extensive discussion, because often the work that must be performed is related to comments in the discussion about the document.

For example, consider how this embodiment of the invention can be used in the preparation of a quarterly report by an asset management firm. Patricia Partner drafts the outline of the report in an online document repository such as Box and send a message describing three tasks related to preparation of the report: obtaining input from experts, preparing section drafts, and preparing final section drafts. Using the invention, Patricia creates Action Items for members of her team that reference the parts of the message describing these tasks. FIG. 16 illustrates a user interface depiction 170 wherein Patricia creates Action Items referencing parts of a message related to a document in Box®.

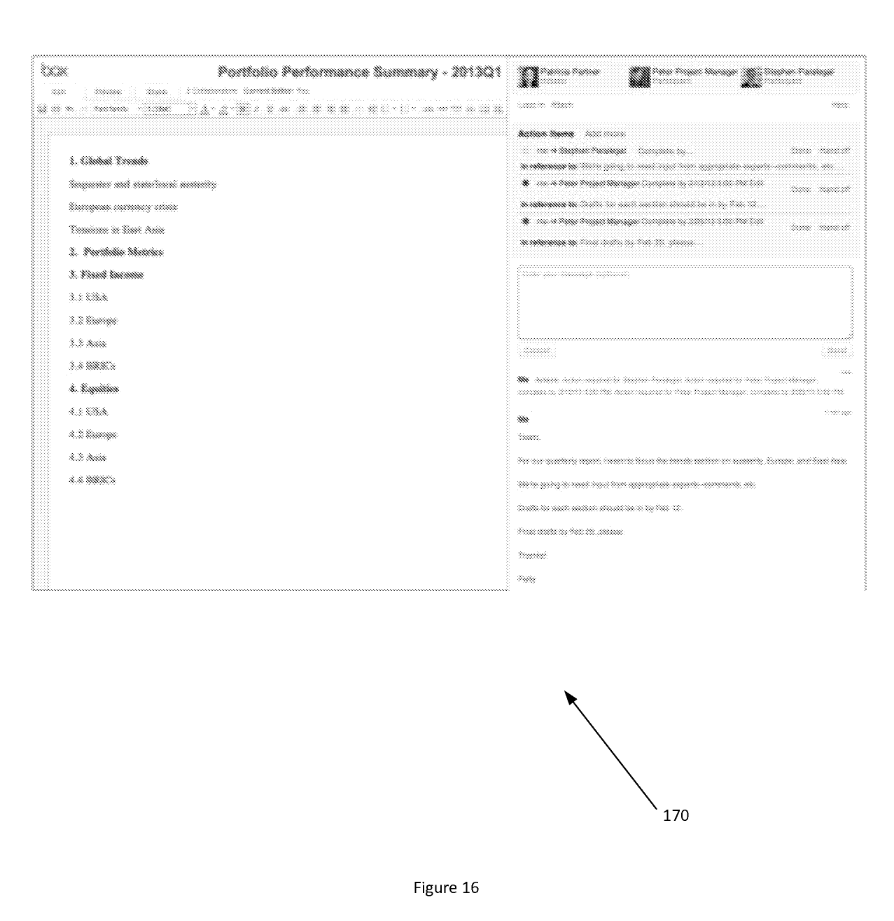

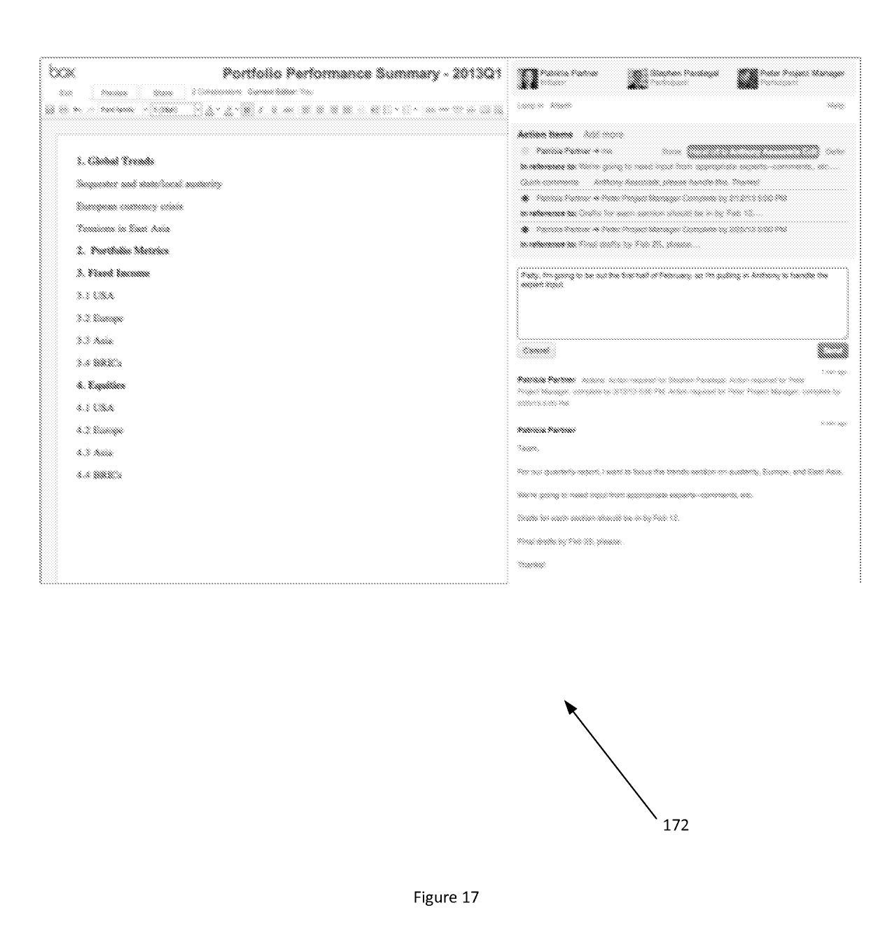

When Stephen Paralegal views the document in the repository, he sees the message and associated Action Items, including the Action Item for him, and realizes that he will not be able to perform the work due to his vacation plans. He enters a reply message stating that he will ask Anthony to handle the task and manipulates the interface to specifies Anthony Associate as the new recipient of the Action Item. FIG. 17 illustrates a user interface depiction 172 wherein Stephen prepares to hand off Action Item to Anthony.

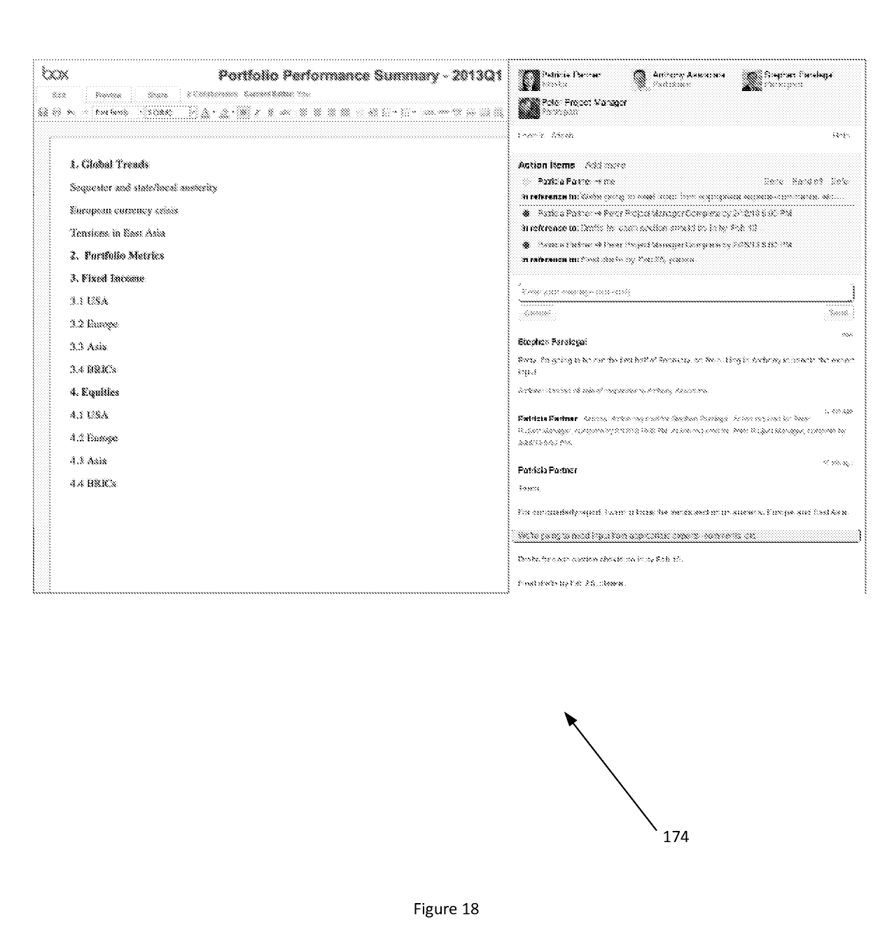

When Stephen hands off the Action Item to Anthony, Anthony is automatically granted access to the document and associated messages and Action Items. When Anthony views the document, he sees the associated messages and Action Items. When he clicks the “In reference to” link, the part of the message referenced by the action item is highlighted, making it easy for Anthony to understand the action that he needs to perform with respect to the report preparation process. FIG. 18 illustrates a user interface depiction 174 wherein Anthony views the document and associated Action Item, as well as the message part it references.

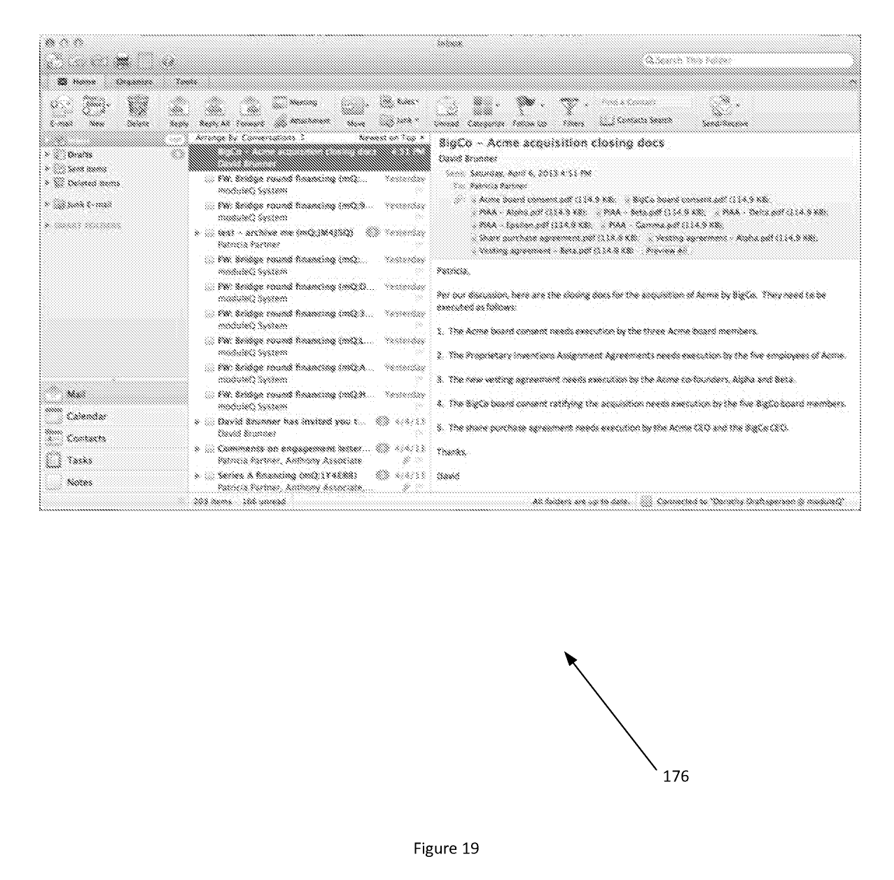

FIGS. 19-25 illustrate embodiments pertinent to an extension for document signing software, such as DocuSign®, which enables users to attach electronic signatures to documents. In complex transactions, it may be necessary to request that multiple persons sign multiple documents, possibly in multiple places. This embodiment integrates with document signing software to facilitate the creation and tracking of request for signatures.

For example, consider the case of a hypothetical acquisition of Acme by BigCo. Patricia Partner, the lawyer for BigCo, receives the closing documents from David Brunner, a paralegal. In this example, David provides the documents to Patricia by email. FIG. 19 illustrates a user interface depiction (176) wherein Patricia receives closing documents from David by email.

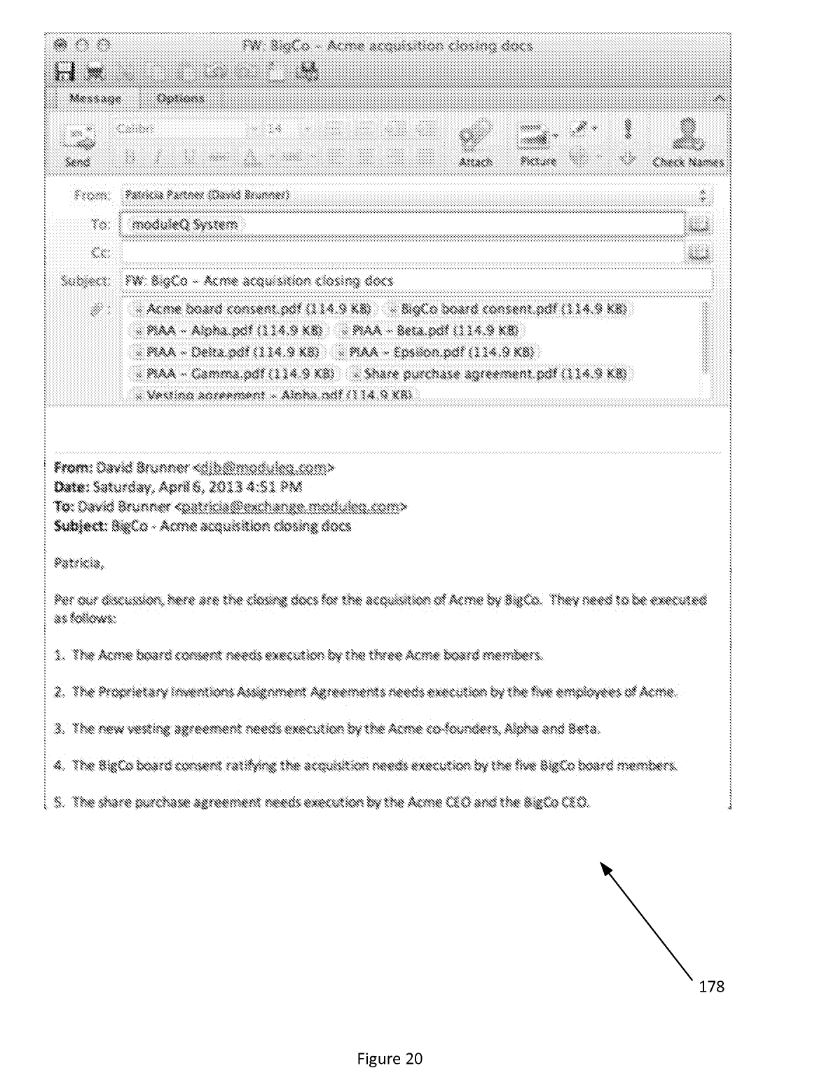

David's email describes the signatures required for closing. In this example, 10 documents require one or more signatures from 12 people. Patricia decides to handle this process using the invention, so she imports the email into the system embodying the invention by forwarding it to a specific mailbox. The mailbox is labeled “moduleQ System in this example. FIG. 20 illustrates a user interface depiction (178) wherein Patricia forwards the email to a mailbox managed by the embodiment of the invention, labeled the “moduleQ System”.

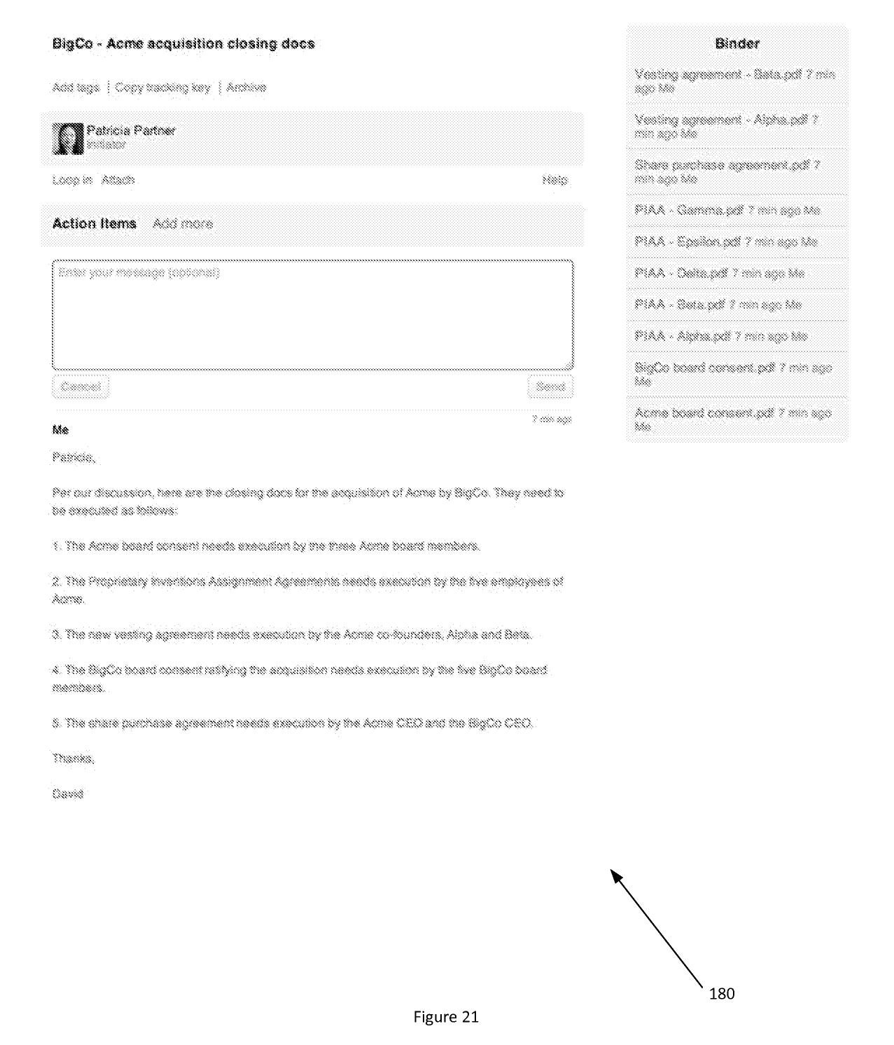

The system may be configured to import the forwarded message and attached files and makes them accessible to Patricia online. FIG. 21 illustrates a user interface depiction (180) wherein Patricia accesses the message and documents imported from email into the embodiment.

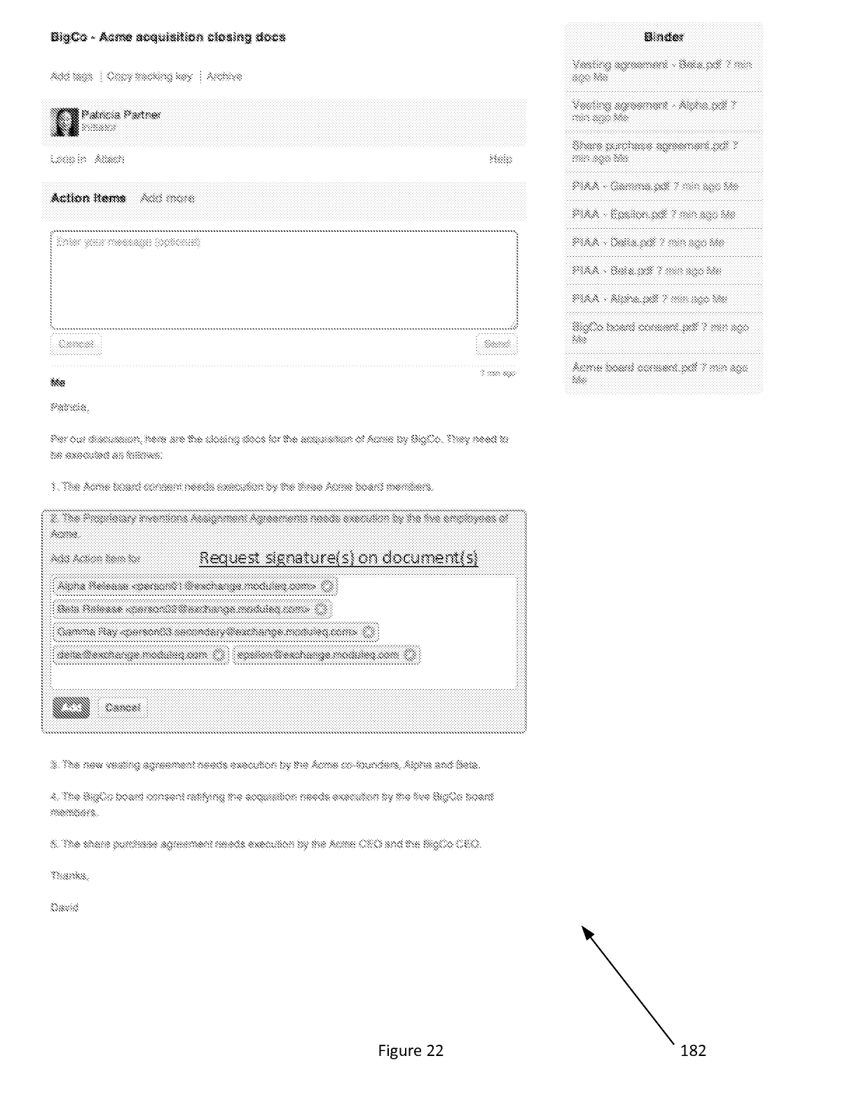

Patricia selects a paragraph describing a required set of signatures and is prompted to enter the people for whom Action Items are to be created. A link labeled “Request signature(s) on document(s)” allows Patricia to indicate whether the Action Items require signature(s) on document(s). Patricia enters the names or email addresses of the people whose signatures are required. FIG. 22 illustrates a user interface depiction (182) wherein Patricia enters the people whose signatures are required.

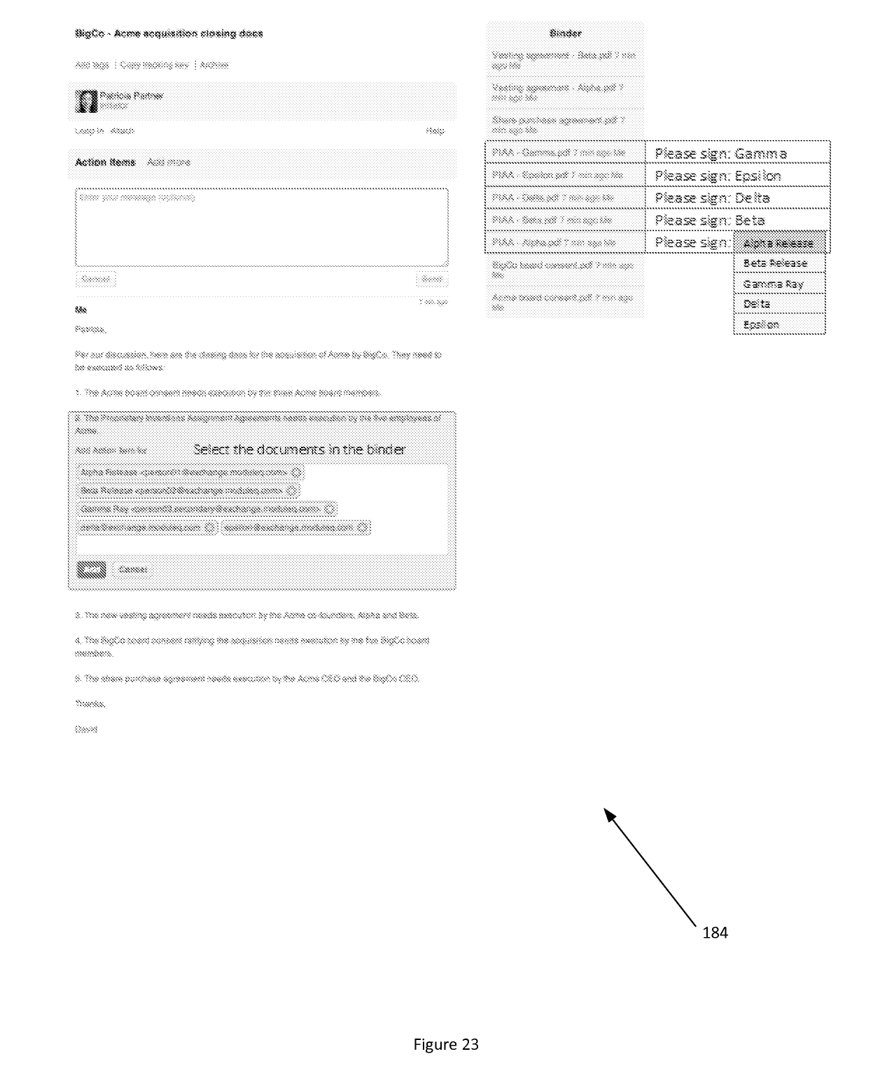

Patricia clicks the “Request signature(s) on document(s)” link and then selects the documents requiring signatures by the specified people. FIG. 23 illustrates a user interface depiction (184) wherein for each Action Item recipient, Patricia specifies the document requiring a signature.

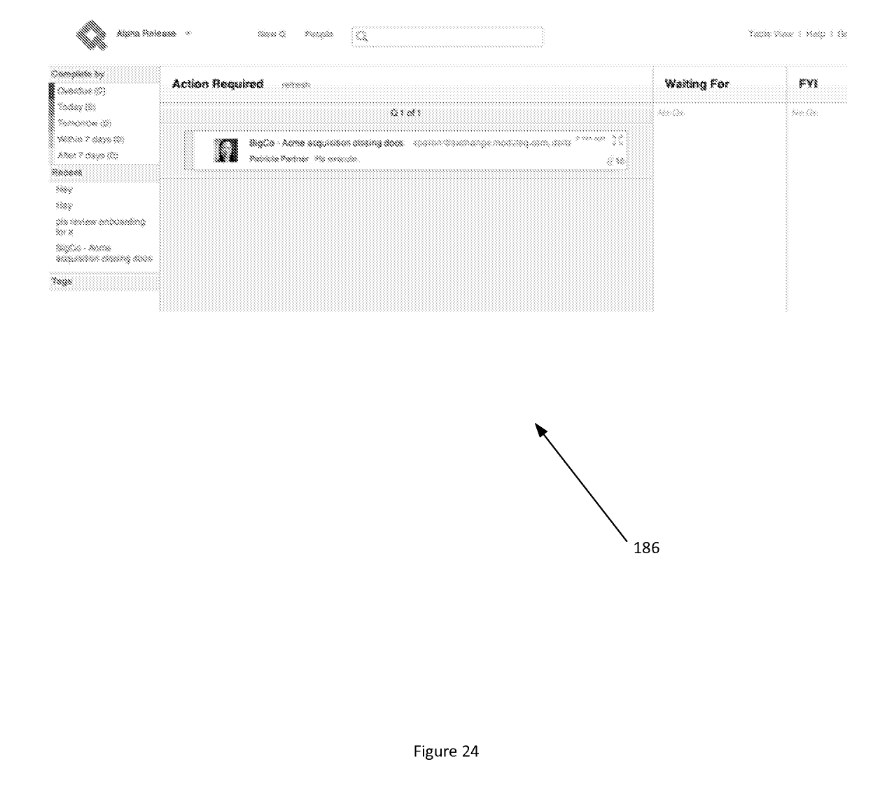

For Alpha, the Action Item from Patricia causes the message thread to be displayed in an Action Required area, indicating to Alpha that he needs to take action on the message thread. FIG. 24 illustrates a user interface depiction (186) wherein the message thread with the Action Item for Alpha appears to Alpha in an area labeled “Action Required”.

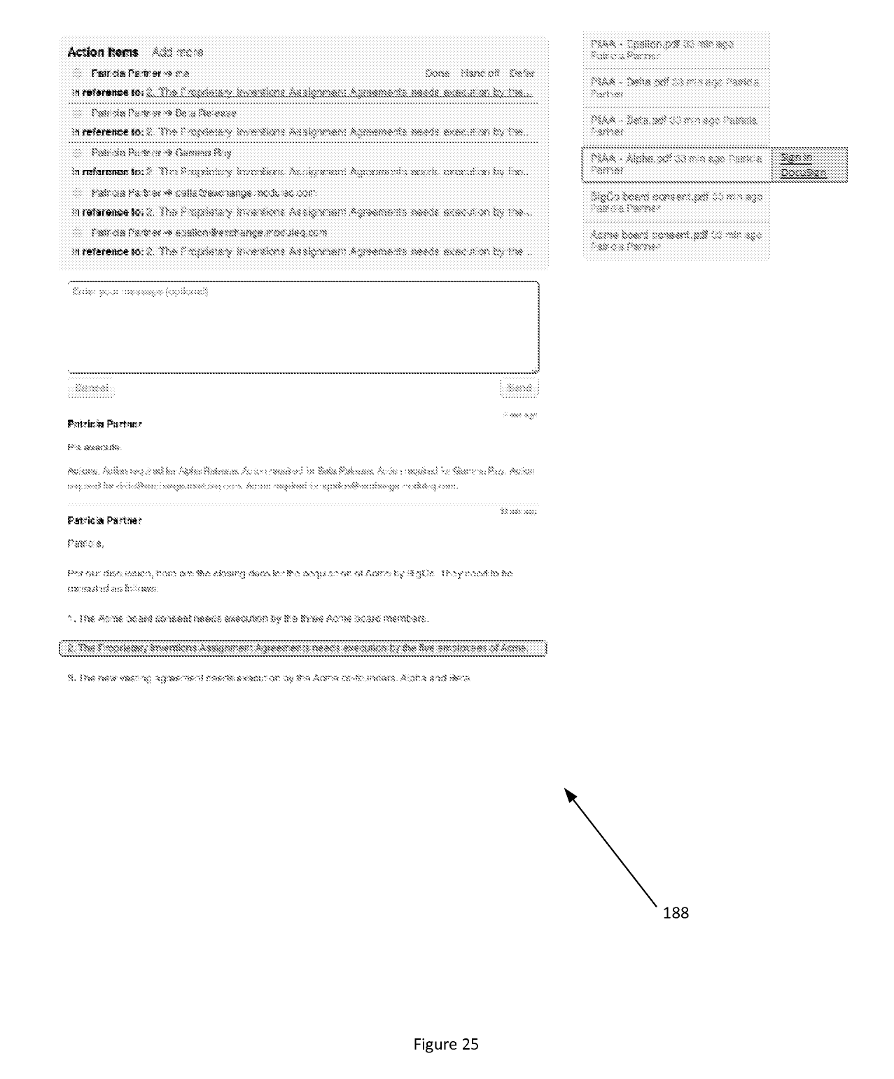

When Alpha accesses the message thread, he sees the Action Item, the message with the part referenced by the Action Item highlighted, and the documents with the document requiring a signature highlighted. A link next to the document requiring a signature enables Alpha to open the document in DocuSign® for signing. FIG. 25 illustrates a user interface depiction (188) wherein the recipient of the Action Item can view the part of the message referenced by the action item and the document to be signed. A link next to the document opens the document for signing in DocuSign®.

Other standalone and plug-in embodiments may integrate with other software tools, including but not limited to the following. In each case below where the embodiment modifies an Action Item or causes a modification to be made to a record in another software system, the invention includes the alternative embodiment where the embodiment presents a description of the modifications to the user before performing the modifications and allows the user to determine which of the modifications will be performed.

Calendar applications. When an Action Item is created with a complete by date, the embodiment may communicate information about the Action Item to a calendar tool such as the calendar function in Microsoft Outlook®, or a calendar app on a smartphone or table computer such as an Apple iOS®, Google Android® or BlackBerry® device. This information may cause the calendar tool to create or modify calendar items, such as creating a corresponding calendar item on a particular date corresponding to the complete-by date of the Action Item. The calendar item may include information about how to access the corresponding Action Item in the embodiment such as a hyperlink. When the Action Item is modified in a manner such as being marked done, deferred, handed off, or having the associated complete by date changed, the embodiment may communicate information about the modification(s) to the calendar tool, causing the calendar tool to modify the corresponding calendar item.

Task tracking tools. When an Action Item is created, the embodiment communicates information related to the task to a task tracking tool such as the task list function in Microsoft Outlook®, to-do list apps on a smartphone or table computer such as an Apple iOS®, Google Android® or BlackBerry® device, or customer-relationship management software with task tracking functionality such as Salesforce.com. This information may cause the task tracking tool to create a task item corresponding to the Action Item. The task item may include information about how to access the corresponding Action Item in the embodiment such as a hyperlink. The embodiment may detect modifications to the Action Item or the corresponding task item. These modifications may comprise changes in the task item or Action Item's completion status, descriptive text, associated comments, complete-by date, recipient, or other state information. When the embodiment detects a modification to the task item in the task tracking tool, the embodiment may retrieve information about these modifications, and the embodiment may modify the corresponding Action Item based on this information. When the Action Item is modified in the embodiment, the embodiment may communicate information about the modifications to the task tracking tool, causing the task tracking tool to modify the corresponding task item in a manner determined at least in part by the information.

Document management system (DMS). When an Action Item is created or modified, the embodiment communicates information about the creation or modification of the Action Item to a DMS such as Autonomy iManage® or OpenText®. If the Action Item references one or more documents in the document management system, the information may be communicated so as to cause the DMS to associate a tag, comment, or other data with the referenced documents. The other data may include information about how to access the corresponding Action Item in the embodiment, such as a hyperlink. If a reference to one more documents in the DMS is added to an Action Item when the Action Item is created or subsequently, the embodiment may obtain information about the document(s) from the DMS. The embodiment may use this information to determine tags, comments, descriptive text, images, or other data that may be relevant to the Action Item. The embodiment may associate these tags, comments, descriptive text, images or other data with the Action Item. The other data may include information about how to access the referenced documents in the DMS, such as a hyperlink. The embodiment may allow a user to determine which of these tags, comments, descriptive text, images or other data to associate with the Action Item. When documents in the DMS are created or modified, the embodiment may retrieve information about the documents modified or created in the DMS. The embodiment may modify Action Items based on this information.

Ethical wall management tools such as IntApp Wall Builder®. When a user attempts to create an Action Item for a specified recipient, the tool may communicate with an ethical wall management tool to determine whether the specified recipient is permitted to view the content in the Action Item and its associated message. This may comprise determining the client or matter with which the message is associated, if any.

Legal matter management tools such as Thomson Reuters MatterSphere® or LexisNexis CounselLink®. When a user creates or updates an Action Item, the tool may communicate information about the Action Item with a matter management tool. The matter management tool may use this information to associate information about the Action Item with a particular matter.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with any above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A system for structured communication between specified parties, comprising:
a. a remotely-accessible controller configured to present a communication user interface to one or more of the parties;
b. a state information repository comprising state information to be updated throughout a transaction, wherein changes in the state information are constrained at least in part based upon a transaction type determined from a predetermined set of transaction types;
wherein the controller is configured to initiate an electronically mediated interaction pertinent to a communication transaction between the parties, attempt to establish an initial context for the transaction based upon previous electronically-mediated interactions that include the initiating party, establish a defined role for each of the parties, each role defining bounds upon the activity of each party within the transaction, and, upon advancement of the state information from a first state to a second state, engage associated parties through the user interface.
